(19) United States
(12) Patent Application Publication
(10) Pub. No.: US 2025/0300402 A1
(43) Pub. Date: Sep. 25, 2025

(54) FLAT CONNECTOR SYSTEM, FLAT CONNECTOR WITH SECURING ELEMENT, SECURING ELEMENT AND METHOD FOR SECURING

(71) Applicant: Yamaichi Electronics Deutschland GmbH, Aschheim (DE)

(72) Inventors: Alexander Ramonat, München (DE); David Ngan, Hallbergmoos (DE)

(21) Appl. No.: 19/086,539

(22) Filed: Mar. 21, 2025

(30) Foreign Application Priority Data
Mar. 22, 2024 (DE) 10 2024 202 737.5

(51) Int. Cl. H01R 13/639; H01R 13/627; H01R 43/26

(52) U.S. Cl. CPC H01R 13/639; H01R 13/6271; H01R 43/26; H01R 2201/26

(57) ABSTRACT

The present invention relates to a flat plug connector system (1), a flat plug connector (10) with a securing element (5), a securing element (5) and a method for securing a coupling between a flat plug connector (10) and a complementary flat plug connector (50), wherein the flat plug connector system (1) comprises: a flat plug connector (10) having a coupling portion (14), a complementary flat plug connector (50) having a coupling portion (54) complementary to the coupling portion (14) of the flat plug connector (10), and a securing element (5), wherein one of the coupling portion (14) and the complementary coupling portion (54) has a receptacle (12) at which the securing element (5) is arranged at least in sections, wherein the coupling portion (14) and the complementary coupling portion (54) are couplable in a form-fit manner, wherein the securing element (5) prevents detachment of the form-fit coupling between the coupling portion (14) and the complementary coupling portion (54) in a secured state of the flat plug connector system (1), wherein the securing element (5) allows detachment of the form-fit coupling between the coupling portion (14) and the complementary coupling portion (54) in an unsecured state of the flat plug connector system (1), wherein the securing element (5) has a securing position in the secured state of the flat plug connector system (1), and has a non-securing position in the unsecured state, and wherein the coupling portion (14), the complementary coupling portion (54) and the securing element (5) are configured to be complementary to each other such that in a decoupled state in which the coupling portion (14) and the complementary coupling portion (54) are not coupled to each other, the securing element (5) is retained in the non-securing position.

The present invention relates to a flat plug connector system, a flat plug connector with a securing element, a securing element and a method for securing a coupling between a flat plug connector and a complementary flat plug connector.

In electrical and electronic devices, ribbon cables are used in particular for bus lines. In such a cable, a large number of conductors are embedded in an insulating film, each encased by an insulation or applied to an insulating film, wherein the individual conductors have a small cross-section and a small spacing from one another. In order to connect such a cable to a circuit board or an electrical or electronic device, for example, a plug of the cable is usually connected to a corresponding socket. In case of a tensile load to the cable, it can break off at the plug and render the cable unusable. Alternatively, so-called “zero insertion force” (“ZIF”) connectors may also be used, by means of which one end of a cable is inserted into the “ZIF” connector using only minimal force, so that an electrical contact is established. Since the connection between the cable and the “ZIF” connector is established with application of very little force, the force required to detach the connection is also low, so that the electrical connection may be unintentionally interrupted.

At the same time, in certain technical fields, such as automotive engineering, for example, electrical connections between electronic components are often exposed to high stresses which may impair the electrical connections.

It is therefore an object of the present invention to provide a flat plug connector system, a flat plug connector with a securing element, a securing element for a flat plug connector system, and a method, to enable detachable electrical connections which exhibit improved assembly, in particular with comparatively little installation space, while at the same time ensuring a predetermined connection security.

In other words, it is in particular an object of the present invention to provide in particular a flat plug arrangement and a method which exhibits improved assembly for ensuring a predetermined connection security.

This object is achieved by the independent patent claims. Specific embodiments result from the dependent patent claims.

One aspect of the invention relates to a flat plug connector system comprising:
a flat plug connector having a coupling portion,
a complementary flat plug connector having a coupling portion complementary to the coupling portion of the flat plug connector, and
a securing element,
   wherein one of the coupling portion and the complementary coupling portion has a receptacle at which the securing element is arranged at least in sections,
   wherein the coupling portion and the complementary coupling portion are couplable in a form-fit manner,
   wherein the securing element prevents detachment of the form-fit coupling between the coupling portion and the complementary coupling portion in a secured state of the flat plug connector system,
   wherein the securing element allows detachment of the form-fit coupling between the coupling portion and the complementary coupling portion in an unsecured state of the flat plug connector system,
   wherein the securing element has a securing position in the secured state of the flat plug connector system, and has a non-securing position in the unsecured state, and
      wherein the coupling portion, the complementary coupling portion and the securing element are configured to be complementary to each other such that in a decoupled state in which the coupling portion and the complementary coupling portion are not coupled to each other, the securing element is retained in the non-securing position.

By the coupling portion, the complementary coupling portion and the securing element being configured to be complementary to each other such that in the decoupled state, the securing element is retained in the non-securing position, improved assembly for the flat plug connector and the complementary flat plug connector can advantageously be provided.

In particular, an obstruction or impairment of the coupling operation or the coupling between the coupling portion and the complementary coupling portion can advantageously be prevented by the securing element, in particular by the securing element being retained, e.g. held, clamped, etc., in the non-securing position.

Furthermore, in particular incorrect or unsecured assembly of the flat plug connector system can be prevented when the securing element is in the securing position or reaches the securing position without or before the flat plug and the complementary flat plug being or are coupled to each other.

Assembly can be improved in particular such that it is simplified, since the retention of the securing element in the non-securing position advantageously prevents it from being transferred too early into the securing position before coupling the flat plug to the complementary flat plug. This also allows to facilitate assembly such that it is ensured that the securing element remains in the non-securing position even, for example, upon accidental application of force to the securing element, in particular in the plugging direction of the flat plug connector system. As a result, in turn, coupling of the flat plug connector to the complementary flat plug connector can be ensured without the coupling being disrupted by the securing element. Furthermore, the securing element may, for example, be pre-assembled to the flat plug connector or the complementary flat plug connector, which facilitates the further assembly, in particular since the number of parts to be carried and/or actuated during assembly is reduced. Also, the securing element advantageous does not have to be brought to the assembly point afterwards, after coupling. This advantageously improves the repeat accuracy and correspondingly the quality of the coupling of the present flat plug connector system.

Furthermore, the assembly can be improved in particular such that, for example, haptic and/or visual feedback is ensured after coupling. In other words, it can be ensured in particular that an operator and/or an operating unit receives, for example, haptic and/or visual feedback after coupling due to the securing element only being transferable into the securing position after coupling.

The non-securing position may be a single geometrically defined position, but is not limited thereto. Rather, the non-securing position may comprise multiple positions. The single non-securing position or the multiple non-securing positions may in particular define a position in which the form-fit coupling between the coupling portion and the complementary coupling portion is not secured and/or securable by the securing element.

This can be achieved, for example, by the securing element not having a function that secures the form-fit coupling in the non-securing position. A corresponding securing function by the securing element, i.e. in particular in the securing position, may, for example, be configured such that elastic deformation, in particular elastically restoring deformation, of at least one of the coupling portion and the complementary coupling portion is impaired or prevented. The elastic deformation of at least one of the coupling portion and the complementary coupling portion may in particular be prevented or impaired such that the coupling portion and the complementary coupling portion are not detachably coupled to each other. This applies in particular as long as the securing element is not or has not been removed from the securing position, for example by transferring the securing element into the non-securing position.

The securing position may in particular be a position at the receptacle that deviates from the non-securing position.

In exemplary embodiments, the coupling portion, the complementary coupling portion and the securing element may be configured to be complementary to each other such that in the coupled state in which the coupling portion and the complementary coupling portion are coupled to each other, the securing element is transferable from the non-securing position into the securing position.

In exemplary embodiments, the securing element is reversibly transferable into the securing position in the coupled state. In other words, the securing element may, for example, be reversibly arrangeable in the securing position. In this case, the securing element may be transferred back into the non-securing position in a damage-free manner, in particular in a non-destructive manner and/or without damaging or even destroying the coupling portion and/or the complementary coupling portion. In alternative embodiments, the securing element may be irreversibly transferable into the securing position in the coupled state. In other words, the securing element may, for example, be irreversibly arrangeable in the securing position. The irreversible transferability or irreversible arrangement may in particular be a transfer or arrangement that is non-damage-free, in particular non-destructively detachable, for the securing element and/or for at least one of the coupling portion and the complementary coupling portion.

The reversible transferability into the securing position or the reversible arrangement in the securing position advantageously enables the coupling portions and the securing element to be reused, for example after maintenance, repair and/or removal and installation of the flat plug connector system, for example in another vehicle, in particular a car.

The irreversible transferability into the securing position or the irreversible arrangement in the securing position advantageously enables a particularly stable securing of the coupled state.

Advantageously, the securing element retained in the non-securing position is easily transferable into the securing position after coupling the coupling portion and the complementary coupling portion.

For example, the securing element may be pre-assembled to the receptacle, in particular pre-assembled to the receptacle in the non-securing position. In particular, the securing element may be pre-assembled to the receptacle, in particular in the non-securing position, before the form-fit coupling of the flat plug connector and the complementary flat plug connector.

As a result, the assembly of the flat plug connector system can further advantageously be facilitated without hindering or impairing coupling of the coupling portion to the complementary coupling portion.

The securing position of the securing element may in particular be a first relative position of the securing element relative to the coupling portion or complementary coupling portion which has the receptacle. Furthermore, the non-securing position of the securing element may be a second relative position of the securing element relative to the coupling portion or complementary coupling portion which has the receptacle.

The second relative position may in particular deviate from the first relative position or, in other words, may be different from the first relative position.

As a result, visual and/or haptic feedback can advantageously be ensured when the flat plug connector system is in the secured state or reaches the secured state, and/or when the flat plug connector system is in the unsecured state or reaches the unsecured state.

In exemplary embodiments, the flat plug connector system having the securing element may have a substantially same height or thickness in the first relative position and in the second relative position. Here, height or thickness is to be understood in particular as a dimension of the flat plug connector system having the securing element in which the flat plug connector system is referred to as flat.

The flat plug connector system comprising or consisting of the flat plug connector, the complementary flat plug connector and the securing element may, for example, have a height or thickness in the range from about 3.0 mm to about 7.0 mm, in particular in the range from about 4.5 mm to about 6.5 mm, in particular of about 6 mm, in particular in the secured state and/or in the unsecured state.

The flat plug connector system comprising or consisting of the flat plug connector, the complementary flat plug connector and the securing element may, for example, have a height or thickness of less than about 7.5 mm, in particular less than about 6.5 mm, preferably of at most about 6.0 mm, in particular of about 6 mm, in particular in the secured state and/or in the unsecured state.

As a result, a particularly space-saving flat plug connector system can advantageously be provided, which can be assembled in a simple manner, in particular even with little available installation space or free space for assembly, in particular while ensuring a predetermined connection security.

Furthermore, by virtue of the aforementioned heights or thicknesses, the flat plug connector system is advantageously suitable for vehicles, in particular for use in motor vehicles, such as cars, for example, since in particular the installation space or free space is very limited in height in this case. For example, the aforementioned heights or thicknesses advantageously allow air channels, such as for the air conditioner, for example, to be assembled above and/or below the flat plug connector system, while at the same time ensuring a predetermined connection security of the flat plug connector system.

In exemplary embodiments, the coupling portion, the complementary coupling portion and the securing element may be configured to be complementary to each other such that, in the decoupled state, the securing element is retained in the non-securing position such that the securing element is captively arranged at the receptacle in the securing position, or in other words is captively retained to the receptacle.

As a result, the assembly can further advantageously be simplified, since on the one hand, simple pre-assembly of the securing element to the receptacle is advantageously enabled, which on the other hand facilitates assembly of the flat plug connector and the complementary flat plug connector subsequent to the pre-assembly.

Furthermore, in particular securing of the coupling of the coupling portion to the complementary coupling portion or the flat plug connector having the complementary flat plug connector can be facilitated, wherein the securing element only is to be transferred from the captive arrangement in the non-securing position into the securing position. By virtue of the pre-assembly of the securing element to the receptacle, it is no longer necessary in particular to arrange the securing element at the receptacle when connecting the flat plug connectors, so that the number and spatial scope of the steps to bring, or in other words to transfer, the flat plug connector system to the secured state is advantageously reduced.

In exemplary embodiments, the coupling portion, the complementary coupling portion and the securing element may be configured to be complementary to each other such that in the decoupled state in which the coupling portion and the complementary coupling portion are not coupled to each other, the securing element is retained in the non-securing position such that transfer of the securing element into the securing position is blocked, or in other words prevented.

As a result, the assembly can further advantageously be simplified, since a secure coupling of the coupling portion to the complementary coupling portion or of the flat plug connector to the complementary flat plug connector is advantageously simplified, in particular by the securing element only being to be transferred from a precisely definable or defined non-securing position into the securing position. In other words, the assembly of the flat plug connector system, and therefore the transfer of the securing element into the securing position, can advantageously be precisely predefined.

In exemplary embodiments, the secured state of the flat plug connector system may be a detachable secured state of the flat plug connector system. However, the secured state is in particular not detachable as long as or when the securing element is in the securing position.

For example, the flat plug connector system may be reversibly transferable between the secured state and the unsecured state. In particular, the securing element may be transferable, in particular be reversibly transferable, between the secured state and the unsecured state in the coupled state of the flat plug connector system, in particular exclusively in the coupled state of the flat plug connector system. The coupled state constitutes the state in which the coupling portion and the complementary coupling portion are coupled in a form-fit manner.

In particular, the securing element may be transferable, in particular reversibly, between the secured state and the unsecured state along the receptacle. The transfer of the securing element between the secured state and the unsecured state (or between the securing position and the non-securing position) may in particular comprise a movement which is substantially parallel or parallel to the plugging direction of the flat plug connector. Alternatively or additionally, the transfer of the securing element between the secured state and the unsecured state (or between the securing position and the non-securing position) may in particular comprise a movement which is substantially perpendicular or perpendicular to the height direction or thickness direction of the flat plug connector system.

As a result, the flat plug connector system can advantageously be easily assembled, or in other words coupled, even with comparatively small installation spaces, and in particular cannot be detachably coupled. In particular, the flat plug connector system can thus be configured to be easy to assemble, i.e. easy for an operator or an operating device to assemble.

In the following, various terms are used repeatedly, the understanding of which is to be facilitated by the following definitions.

The secured state of the flat plug connector system describes in particular a state in which the coupling portion and the complementary coupling portion or the flat plug connector and the complementary flat plug connector are not detachably coupled to each other, in particular are not detachably coupled to each other in a damage-free or non-destructive manner. In other words, the secured state is a state in which the flat plug connector and the complementary flat plug connector are non-detachably coupled to each other, in particular not detachably coupled to each other in a non-destructive manner, without prior removal of the securing element from the securing position.

The unsecured state of the flat plug connector system, which is also described here as a non-secured state, describes in particular a state in which the coupling portion and the complementary coupling portion or the flat plug connector and the complementary flat plug connector are detachably coupled to each other, in particular are detachably coupled to each other in a damage-free or non-destructive manner, for example reversibly detachably coupled to each other.

The coupled state of the flat plug connector system describes in particular a state in which the coupling portion and the complementary coupling portion or the flat plug connector and the complementary flat plug connector are coupled to each other, in particular coupled to each other in a form-fit manner. In exemplary embodiments, the coupling portion and the complementary coupling portion or the flat plug connector and the complementary flat plug connector may additionally or alternatively be coupled to each other in a friction-fit and/or material-fit manner in the coupled state. In the coupled state of the flat plug connector system, the coupling portion and the complementary coupling portion or the flat plug connector and the complementary flat plug connector may touch each other (mutually), in particular at least in sections, in particular touch each other (mutually) with a bias.

In the coupled state, the flat plug connector and the complementary flat plug connector may in particular be electrically conductively connected to each other.

In the coupled state of the flat plug connector system, the flat plug connector system may in particular have the secured state or the unsecured state.

The decoupled state of the flat plug connector system, which is also described here as an uncoupled state, describes in particular a state in which the coupling portion and the complementary coupling portion or the flat plug connector and the complementary flat plug connector are not coupled to each other, in particular not coupled to each other in a form-fit manner. In exemplary embodiments, the coupling portion and the complementary coupling portion or the flat plug connector and the complementary flat plug connector may be coupled to each other neither in a form-fit nor friction-fit and/or material-fit manner in the decoupled state. In the decoupled state of the flat plug connector system, the coupling portion and the complementary coupling portion or the flat plug connector and the complementary flat plug connector in particular do not touch each other or touch each other without a (mutual) bias.

In the decoupled state of the flat plug connector system, the coupling portion and the complementary coupling portion or the flat plug connector and the complementary flat plug connector may alternatively or additionally be non-electrically conductively connected to each other.

In an exemplary decoupled state, the coupling portion and the complementary coupling portion or the flat plug connector and the complementary flat plug connector may be opposite each other or arranged opposite each other in the plugging direction.

Plugging direction: The plugging direction describes in particular a direction in which the coupling portion and the complementary coupling portion or the flat plug connector and the complementary flat plug connector are movable relative to each other to be transferred to the coupled state and/or to the decoupled state.

The plugging direction of the flat plug connector may be substantially parallel to the plugging direction of the complementary flat plug connector. The plugging direction of the flat plug connector may, additionally or alternatively, be a direction substantially opposite to the plugging direction of the complementary flat plug connector.

It is to be understood that the plugging direction may deviate from the plugging direction defined herein during assembly as long as it leads to a coupling, in particular a damage-free coupling, of the flat plug connector with the complementary flat plug connector.

Height direction or also thickness direction: The height direction, which is also described here as a thickness direction, describes in particular a direction in which the flat plug connector system or the flat plug connector, or the complementary flat plug connector, is usually described as flat. Here, the height direction or also thickness direction refers to the flat plug connector system or the flat plug connector, or the complementary flat plug connector, in a usual position of use of the flat plug connector system or the flat plug connector, or complementary flat plug connector.

The height direction or thickness direction may in particular be substantially perpendicular or perpendicular to the plugging direction. The position of use of the flat plug connector system, for example during assembly in a motor vehicle, may be in different spatial directions in relation to the vehicle, so that the height direction as used here does not have to correspond to a height direction of a vehicle.

Width direction: The width direction may in particular correspond to a main extension direction of the flat plug connector and/or the complementary flat plug connector. The width direction may in particular substantially correspond to a direction in which a plurality of contacts and/or conductor elements of the flat plug connector and/or of the complementary flat plug connector are arranged next to each other, in particular to come into electrically conductive contact with the contacts or conductor elements of the respective other one of the flat plug connector and of the complementary flat plug connector. The width direction may in particular be substantially perpendicular or perpendicular to the thickness direction.

Longitudinal direction: The longitudinal direction may in particular correspond to a main extension direction of a ribbon and/or a flexible printed circuit board which is connected to at least one of the flat plug connector and/or the complementary flat plug connector.

It is to be understood that in a position of use, for example in a vehicle, the ribbon and/or the flexible printed circuit board does not have to have an even contour, but may, for example, be corrugated, stepped or run according to other conditions. In this respect, the longitudinal direction of the ribbon and/or the flexible printed circuit board may in particular correspond to a manufacturing state of the ribbon and/or the flexible printed circuit board, with a substantially longitudinal extension.

The longitudinal direction may in particular substantially correspond to a direction in which a plurality of contacts and/or conductor elements of the flat plug connector and/or the complementary flat plug connector extend at least in sections, in particular to come into electrically conductive contact with the contacts or conductor elements of the respective other one of the flat plug connector and the complementary flat plug connector. The longitudinal direction may be substantially parallel to the plugging direction. The longitudinal direction may in particular point substantially in the same direction as the plugging direction.

Furthermore, the longitudinal direction may in particular be substantially perpendicular or perpendicular to the thickness direction and/or the width direction.

The thickness or height direction, the width direction and the longitudinal direction may together form in particular a right-hand system.

The plugging direction may be substantially parallel to the longitudinal direction.

Alternatively or additionally, the plugging direction may be substantially perpendicular to the width direction and/or to the height direction or thickness direction.

Ribbon: A ribbon as used here describes a multi-core cable in which the cores are arranged and/or guided substantially in parallel next to each other, in particular arranged and/or guided substantially next to each other in the width direction. The ribbon cable may have up to 96 cores, for example. The spacing between directly adjacent cores may, for example, be about 0.5 mm to about 2.54 mm, wherein the spacing between the cores does not have to be constant across the width of the ribbon, but may in particular be substantially constant.

Multi-core ribbon cables have the advantage that a large number of cores can be connected to a post plug connector, a soldering adapter or another plug connector with little effort using insulation displacement technology, instead of having to strip and then solder them individually. In particular, crosstalk of signals in the ribbon cable is advantageously lower than in a round cable and can be better controlled by the arrangement of the signals and the use of ground lines between critical signals.

The ribbon may, for example, have a shield such as an aluminum or copper foil wrapped around the ribbon, for example.

Flexible printed circuit board (FPC): Flexible printed circuit boards are flexible and in particular comparatively thin printed circuit boards. Flexible printed circuit boards may, for example, comprise or consist of conductor foils, and in particular comprise or consist of polyimide foils. Although assemblies constructed with these are more expensive, they enable high data transmission in a space-saving manner. However, flexible printed circuit boards usually have an increased manufacturing tolerance as compared to ribbon cables.

Both the ribbon and the flexible printed circuit board advantageously have a significantly smaller extension in the thickness direction than in the width direction and/or than in the longitudinal direction. In particular, the ribbon and/or the flexible printed circuit board may have an extension in the thickness direction that is approximately or at least an order of magnitude smaller than in the width direction and/or than in the longitudinal direction.

The ribbon and especially the flexible printed circuit board advantageously enable a space-saving arrangement and conduction of electrical signals in a motor vehicle, such as a car, for example, in particular for the conduction of high-frequency electrical signals to or from a multimedia unit of a motor vehicle, such as a car, for example.

If a direction or an angle is stated with the addition “substantially” or “approximately” or “about”, this addition means or should be understood to mean in particular a deviation from the relevant direction or the relevant angle in the range from 0° to 5°.

If a spatial dimension, a spatial ratio or any other ratio is stated with the addition “substantially” or “approximately” or “about”, this addition means or should be understood to mean in particular a deviation from the relevant dimension or the relevant ratio in the range from 0% to 10%.

In preferred embodiments of the flat plug connector system, the receptacle may have a latch which interacts with a latch protrusion of the securing element such that in the decoupled state in which the coupling portion and the complementary coupling portion are not coupled to each other, in particular are not coupled to each other in a form-fit manner, the latch protrusion is engaged with the latch such that the securing element is retained in the non-securing position.

In other words, in exemplary embodiments, the receptacle may have a latch and the securing element may have at least one latch protrusion complementary to the latch.

The latch may, for example, comprise at least one opening in the receptacle and/or a stop at the receptacle with which the at least one latch protrusion can engage or come into abutment.

The flat plug connector system may in particular be configured such that, in the decoupled state, the latch is engaged with the at least one latch protrusion or, upon movement of the securing element towards the securing position, the at least one latch protrusion engages with the latch.

The engagement and/or abutment between the latch and the at least one latch protrusion may in particular be a form-fit engagement.

The engagement and/or abutment between the latch and the at least one latch protrusion may in particular cause retention of the securing element in the non-securing position. In other words, the engagement between the latch and the at least one latch protrusion may block, or in other words prevent, a transfer and in particular movement of the securing element into the securing position.

The latch and the at least one latch protrusion advantageously passively and therefore particularly reliably enable the securing element to be or remain in the non-securing position in the decoupled state.

As a result, coupling of the flat plug connector to the complementary flat plug connector can advantageously be separated from securing the coupling of the flat plug connector to the complementary flat plug connector, and in particular be predefined independently of one another.

In particular, the forces to be applied for coupling the flat plug connector may be separated or predefined independently from the forces to be applied for securing the coupling. The separation or the mutually independent predefinition may refer to the direction in which the respective forces are to be applied and/or to the amount of the forces to be applied in each case.

It is to be understood that in exemplary embodiments, the receptacle may have at least one latch protrusion, and the securing element may have a latch having, for example, at least one opening and/or a stop which can be brought into engagement or into abutment with one another, in particular when the flat plug connector system is in the non-coupled state.

In exemplary embodiments, the at least one opening and/or stop of the latch and/or the at least one latch protrusion may extend substantially perpendicular to the plugging direction. For example, the at least one opening and/or stop of the latch and/or the at least one latch protrusion may extend substantially in the height direction. Alternatively or additionally, the at least one opening and/or stop of the latch and/or the at least one latch protrusion may extend substantially in the width direction, at least in sections.

By virtue of the extension of the engagement or the stop substantially perpendicular to the plugging direction, incorrect assembly in which, for example, the securing element is moved into the securing position during coupling before reaching the coupled state, can advantageously be impeded or prevented.

Furthermore, the assembly can advantageously be facilitated such that even when applying a force to the securing element in the plugging direction, e.g. when pushing the securing element in the plugging direction, only the flat plug connector or the alternative flat plug connector, which has the receptacle for the securing element, is moved in the plugging direction, but in particular the securing element does not reach or move into the securing position.

In preferred embodiments of the flat plug connector system, one of the coupling portion and the complementary coupling portion may comprise a rear-engageable portion and the other one of the coupling portion and the complementary coupling portion may comprise a restorably rear-engaging element which engages with the rear-engageable portion in the coupled state of the flat plug connector system, i.e. in the coupled state between the plug connector and the complementary plug connector or between the coupling portion and the complementary coupling portion. In the secured state of the flat plug connector system, the securing element may hinder restoring of the restorably rear-engaging element such that the coupling portion and the complementary coupling portion are coupled to each other in a non-damage-free detachable or not non-destructively detachable manner.

The restorably rear-engaging element may in particular be elastically restorable.

The rear-engageable portion may be a restorably rear-engaging element complementary to the restorably rear-engaging element, in particular a complementary elastically restorably rear-engaging element.

As a result, coupling can advantageously be facilitated. Furthermore, wear and tear can be reduced with repeated coupling and decoupling.

In exemplary embodiments, the rear-engageable portion may be a substantially rigid rear-engageable portion.

The substantially rigid rear-engageable portion may in particular be rigid such that substantially only the restorable rear-engaging element deforms, and the rear-engageable portion substantially does not deform or does not deform during coupling.

As a result, the installation space required for coupling is advantageously precisely predeterminable. Furthermore, predetermined breaking points and/or predetermined breaking parts can advantageously be defined so that, for example, only one of the flat plug connector and the complementary flat plug connector is defined as being susceptible to wear and replaceable, and the other is defined as being comparatively durable.

The restorably rear-engaging element may in particular comprise one or more prongs. One prong of the one or more prongs may comprise one or more protrusions for rear-engaging the rear-engageable portion in the coupled state.

The prong(s) may extend substantially in the plugging direction. In other words, the prong(s) of the restorably rear-engaging element may in particular have a main extension which is substantially parallel to the plugging direction.

The rear-engageable portion may comprise one or more protrusions and/or one or more setbacks behind or with which the restorably rear-engaging element can engage.

The protrusion(s) and/or the setback(s) of the rear-engageable portion and/or the rear-engaging element may extend substantially perpendicular to the plugging direction, and may, for example, extend substantially in the height direction. Alternatively or additionally, the protrusion(s) and/or the setback(s) of the rear-engageable portion and/or the rear-engaging element may extend in the width direction, at least in sections.

An extension the protrusion or protrusions and/or the setback or setbacks of the rear-engageable portion and/or the rear-engaging element substantially in the height direction advantageously prevents jamming in the width direction.

One of the flat plug connector and the complementary flat plug connector may in particular comprise one or more guide elements which may, for example, comprise guide prongs. Preferably, one of the flat plug connector and the complementary flat plug connector may comprise one or more pairs of guide prongs opposite each other in the width direction.

The other one of the flat plug connector and the complementary flat plug connector may in particular comprise one or more guide receptacles which is/are configured to be complementary to the guide element(s), in particular to the guide prongs. In preferred embodiments, the other one of the flat plug connector and the complementary flat plug connector may in particular comprise one or more pairs of guide receptacles opposite each other in the width direction.

A guide receptacle of the one or more guide receptacles may comprise a guide protrusion, a guide groove and/or a guide opening. The guide protrusion, the guide groove and/or the guide opening may in particular comprise an abutment surface, a slidingly guiding groove and/or a rear-engageable portion for one or more guide elements, in particular guide prongs.

The guide element(s), in particular the guide prong(s), may be restorable, in particular elastically restorable.

The guide prong(s) may in particular have a greater extension in the plugging direction than the restorably rear-engaging element and/or than the restorably rear-engaging portion.

In particular, the guide prong(s) may be configured to come into contact with a guide receptacle during coupling, in particular to come into contact in a biased manner before the coupling portion comes into contact with the complementary coupling portion.

As a result, the coupling between the flat plug connector and the complementary flat plug connector can advantageously be guided. This further advantageously allows to prevent jamming during the coupling.

Furthermore, a particularly precise guide for the coupling of the coupling portion to the complementary coupling portion can be ensured, in particular in case of a guide by guide prongs opposite in the width direction and guide receptacles configured to be complementary thereto, in particular under bias.

The one of the flat plug connector and the complementary flat plug connector which does not have the receptacle may have one or more release elements which are configured to enable transfer of the securing element from the non-securing position into the securing position in the coupled state.

The release element(s) may, for example, have a main extension in the plugging direction. The release element(s) may have a rounding and/or chamfer at a distal end of the release element or release elements. The distal end of a release element is in particular an end of the release element facing the receptacle.

The release element(s) may in particular be configured to provide a bypass or deactivation of the latch in the coupled state of the flat plug connector to the complementary flat plug connector, such that the latch protrusion(s) do not engage with the latch, or such that the engagement between the latch protrusion or latch protrusions and the latch is detached.

For example, the release element(s) may provide a block for the latch protrusion(s) to engage with the latch. Here, the release element(s) may, for example, have or provide a cover or ramp for the latch, which blocks engagement with the latch in the coupled state.

Alternatively or additionally, the release element(s) may be configured to restorably deform, in particular elastically restorably deform, at least one of the receptacle and the latch protrusion(s) in the coupled state. The restorable or elastically restorable deformation may in particular be such that the latch and the latch protrusion(s) do not engage or are not engaged due to the elastic deformation. The restorable or elastically restorable deformation may already occur in the non-securing position of the securing element in the coupled state, or may only occur upon transfer of the securing element from the non-securing position into the securing position.

The securing element may in particular be transferred from the non-securing position into the securing position substantially in the plugging direction by means of a movement in a main movement direction. In exemplary embodiments, preferably aside from elastically restorable deformations or deflections, the movement may comprise or be a translational movement. The translational movement may in particular be substantially parallel to the plugging direction.

Transfer of the securing element from the securing position into the non-securing position may comprise a corresponding reverse movement and in particular translation.

By virtue of the release element(s), it can advantageously be ensured that the securing element only reaches or is transferable into the securing position only in the coupled state of the flat plug connector to the complementary flat plug connector. As a result, in turn, the assembly can advantageously be facilitated. Namely, simple coupling may first be ensured, for example with a securing element pre-assembled to the receptacle. And subsequently, simple securing may be ensured by the securing element. As a result, in particular haptic and/or visual feedback can be ensured when transferring the securing element from the non-securing position into the securing position, and accordingly simple verification of the securing quality of the flat plug connector system can be ensured.

In preferred embodiments of the flat plug connector system, the securing element may have a securing surface which, in the secured state of the flat plug connector system, abuts against a side of the restorably rear-engaging element facing away from the rear-engageable portion.

The securing element may in particular have a securing surface which, in the secured state of the flat plug connector, abuts against a side of the restorably rear-engaging element facing away from the rear-engageable portion, in a manner flush at least in sections, or in other words planarly adjacent at least in sections.

By virtue of the securing surface, a particularly safe securing against detachment of the coupling between the flat plug connector and the complementary flat plug connector can advantageously be provided. In particular, a planar distribution of the load upon detachment without prior transfer of the securing element into the non-securing position can advantageously be ensured. As a result, the service life of the securing element as well as the rear-engageable portion and the restorably rear-engaging element can advantageously be improved.

Further, by virtue of the securing surface and the associated planar securing against detachment when the securing element is in the securing position, a particularly high destructive force can be ensured, which is to be applied in order to destructively detach the secured coupling.

Furthermore, by virtue of the design of the securing surface, a predetermined breaking point which is the first to fail upon detachment of the secured coupling, i.e. without prior transfer of the securing element into the non-securing position, can advantageously be predetermined. For example, at least one or more of the securing surface, the rear-engageable portion and the rear-engaging element may have one or more tapers and/or grooves as (a) predetermined breaking point(s).

The securing element, and in particular the securing surface of the securing element, may be configured to block or at least impede a restoring deformation of the restorably rear-engaging element and/or the rear-engageable portion in the securing position.

For example, when the securing element is in the secured position, the restorably rear-engaging element may be substantially arranged in a sandwich-like manner between the rear-engageable portion and the securing element or the securing surface of the securing element. In particular, when the securing element is in the secured position, the restorably rear-engaging element may be substantially clamped in a sandwich-like manner between the rear-engageable portion and the securing element or the securing surface of the securing element. The sandwich-like arrangement or clamping may in particular be such that the restorably rear-engaging element is secured against detachment, in particular non-destructive detachment.

The securing surface may, for example, extend approximately in parallel to the plugging direction.

In further exemplary embodiments, the securing surface may be inclined with respect to the plugging direction. For example, the securing surface may have an inclination relative to the plugging direction which is in the range from about 5° to about 30°, preferably in the range from about 8° to about 25°, particularly preferably from about 10° to about 20°. The inclination of the securing surface relative to the plugging direction may in particular be an inclination of the securing surface which is detectable in a (sectional) plane which spans substantially in the longitudinal direction and in the height direction. The inclination is in particular the angle enclosed by the securing surface and the plugging direction.

The inclined securing surface advantageously enables detachment of the coupling in the secured state to cause a force component in the height direction which can advantageously be well distributed and dissipated by the flatly configured, inclined securing surface. As a result, in turn, a safe securing against the detachment of the coupling in the secured state can advantageously be provided.

In exemplary embodiments, the securing surface, in the securing position of the securing element, may be biased with a securing bias force against the restorably rear-engaging element and/or the rear-engageable portion.

In exemplary embodiments, the securing element may slide at least partially into the securing position during the transfer into the securing position.

In exemplary embodiments, the securing element and one of the coupling portion and the complementary coupling portion may have complementary sliding surfaces. The securing element may be configured to elastically restore a restorable deflection during the transfer into the securing position, such that the transfer towards the securing position causes an increasingly smaller elastic deflection of the securing element. In the securing position, the securing element may still have a residual elastic deflection or no elastic deflection. As an example, the securing element in exemplary embodiments may thus be biased with a bias against the restorably rear-engaging element and/or the rear-engageable portion, or be arranged in the securing position without any bias. The mutually complementary sliding surfaces may be provided, for example, by a securing protrusion of the one of the coupling portion and the complementary coupling portion, and a protrusion of the securing element complementary to the securing protrusion.

In further exemplary embodiments, the securing element may be biased with an increasing bias against the restorably rear-engaging element and/or the rear-engageable portion during a detaching operation substantially opposite to the plugging direction, due to the movement opposite to the plugging direction. For example, during a detaching operation with a movement opposite to the plugging direction, the securing element may have an again increasing elastic deflection, which causes an increasing bias of the securing element or the securing surface thereof against the restorably rear-engaging element and/or the rear-engageable portion.

By virtue of the complementary sliding surfaces and the elastic restoring of a deflection of the securing element when transferring into the securing position, the transfer of the securing element from the non-securing position into the securing position can advantageously be passivated at least in sections.

As a result, the assembly can further advantageously be simplified. Furthermore, in particular haptic and/or visual feedback of the transfer of the securing element into the securing position can be improved, in particular by the securing element executing part of the movement into the securing position by itself for the operator or the operating device, i.e. with reduced or no effort, and in particular in a visually observable manner.

In preferred embodiments of the flat plug connector system, the securing element may be arrangeable or be arranged at the receptacle in a form-fit manner such that the securing element is transferable between the securing position of the securing element and the non-securing position of the securing element without detaching the form-fit arrangement at the receptacle.

The securing element may in particular have one or more counterholds. The one or more counterholds may be configured to engage with one or more counterhold abutments in a form-fit manner.

The one or more counterholds may be configured, for example, as a protrusion or as an opening at the securing element, which in particular extend substantially perpendicular to the plugging direction, for example extend substantially in the width direction. The one or more counterhold abutments may in particular be configured as openings, stops or protrusions complementary to the one or more counterholds, which in particular extend substantially perpendicular to the plugging direction, for example extend substantially in the width direction.

The engagement between the one or more counterholds with the one or more counterhold abutments may in particular be configured further back in the plugging direction than the engagement between the latch and the one or more latch protrusions.

The counterhold(s) may in particular form a form-fit opposite to the plugging direction with the counterhold abutments.

As a result, the securing element can advantageously be secured against detachment from the receptacle.

In particular, in the decoupled state of the flat plug connector from the complementary flat plug connector, the securing element may advantageously be held in a position between an engagement of the counterhold and the counterhold abutment or a plurality thereof and an engagement of the latch and the one or more latch protrusions. Here, the engagement of the counterhold and the counterhold abutment or the plurality thereof limits the position substantially opposite to the plugging direction. The engagement of the latch and the one or more latch protrusions limits the position substantially in the plugging direction.

In order to limit the position of the securing element at the receptacle, the securing element and the receptacle may have abutment surfaces adjacent to each other at least in sections which are in particular configured to limit a position in and/or opposite to the height direction and/or to limit a position in and/or opposite to the width direction.

The limitation of the position of the securing element advantageously ensures a predeterminable elastic deflection of the securing element and/or the receptacle, for example by a release element.

The counterhold(s) may in particular form a restorable form-fit engagement with the counterhold abutment(s).

The counterhold(s) may, for example, be arranged on one or more elastically restorable prongs of the securing element.

The restorable engagement between the counterhold(s) and the counterhold abutment(s) may in particular define a predetermined pull-off force to detach the securing element from the receptacle, in particular to detach the securing element from the receptacle substantially opposite to the plugging direction.

In the coupled state of the flat plug connector to the complementary flat plug connector, a position of the securing element at the receptacle may in particular be limited by the flat plug connector or the complementary flat plug connector which does not have the receptacle.

The securing element may therefore be advantageously and in particular passively limited in its position, both in the decoupled state and in the coupled state. In particular, the position of the securing element in the non-securing position may advantageously be predetermined by means of the engagements of the counterhold with the counterhold abutment or the plurality thereof as well as of the latch and the one or more latch protrusions.

Furthermore, assembly with repeat accuracy and in particular actuation with repeat accuracy of the securing element can therefore advantageously be ensured, whereby the quality of the securing of the flat plug connector system and the verifiability thereof is advantageously improved.

In preferred embodiments of the flat plug connector system, one of the coupling portion and the complementary coupling portion may have a securing protrusion, and the securing element may have a protrusion complementary to the securing protrusion,
wherein the securing protrusion and the complementary protrusion of the securing element may define a detaching force to transfer the securing element from the secured state of the flat plug connector system into the unsecured state of the flat plug connector system.

Alternatively or in addition to the detaching force, the protrusion of the securing element, i.e. the complementary protrusion of the securing element and the securing protrusion, may define a predetermined securing force for transferring the securing element from the non-securing position into the securing position.

In exemplary embodiments, in particular the receptacle of the one of the coupling portion and the complementary coupling portion may have the securing protrusion, wherein the securing protrusion and the complementary protrusion of the securing element may define the detaching force to transfer the securing element from the secured state of the flat plug connector system into the unsecured state of the flat plug connector system.

In further exemplary embodiments, in particular the one of the coupling portion and the complementary coupling portion which does not have the receptacle may have the securing protrusion, wherein the securing protrusion and the complementary protrusion of the securing element may define the detaching force to transfer the securing element from the secured state of the flat plug connector system into the unsecured state of the flat plug connector system.

The securing protrusion and the complementary protrusion of the securing element may in particular be configured to define a predetermined detaching force in a substantially predetermined detaching direction. The detaching direction may correspond approximately to a direction opposite to the plugging direction. However, the detaching direction is not limited to a single direction. Rather, it is sufficient for a main part of the detaching force to be applied in the detaching direction.

The securing protrusion may, for example, have an inclination and/or a rounding. The rounding may, for example, be spherical, for example hemispherical, at least in sections, and/or may, for example, be arc-shaped, or in other words, semi-circular in cross-section, at least in sections, without, however, being limited to an exact circular shape.

The protrusion of the securing element may have a contour corresponding to the securing protrusion, but is not limited thereto. For example, the protrusion of the securing element may have an inclination which corresponds to the inclination of the securing protrusion, but may also have an inclination deviating therefrom.

The securing protrusion and/or the protrusion of the securing element complementary to the securing protrusion may in particular have a section-wise contour.

For example, the securing protrusion and/or the protrusion of the securing element complementary to the securing protrusion may have a first contour portion which the securing protrusion and/or the protrusion have on a side on which the securing protrusion and the protrusion face each other when the securing element is in the non-securing position.

Additionally or alternatively, the securing protrusion and/or the protrusion of the securing element complementary to the securing protrusion may have a second contour portion which the securing protrusion and/or the protrusion have on a side on which the securing protrusion and the protrusion face each other when the securing element is in the securing position.

The first contour portion or the first pairing of first contour portions of the securing protrusion and the complementary protrusion of the securing element may in particular be different from the second contour portion or the second pairing of second contour portions of the securing protrusion and the complementary protrusion of the securing element.

The securing protrusion and the protrusion of the securing element complementary to the securing protrusion advantageously allow to ensure a predetermined detaching force, and in particular a predetermined securing force, with which the securing element is transferable into the non-securing position or into the securing position.

Furthermore, the predetermined securing force and the predetermined detaching force are advantageously definable independently of one another, in particular by means of the section-wise contour.

As a result, advantageously both the assembly and disassembly of the flat plug connector system can advantageously be simplified and predefined.

In particular, by means of the second contour portion or the second pairing of second contour portions of the securing protrusion and the complementary protrusion, passive transfer of the securing element into the securing position, at least in sections, may be caused.

In particular, the protrusion of the securing element may be arranged on a restorable prong, in particular an elastically restorable securing prong of the securing element. The elastically restorable securing prong may in particular be configured to be deflected elastically, at least in sections, during the transfer into the securing position.

The securing prong, which is elastically deflected after overcoming the securing force, may in particular be configured to restore the elastic deflection. Upon restoring of the elastic deflection of the securing prong, the protrusion of the securing prong is configured in particular to slide off the securing protrusion driven by the reduction of the elastic bias.

As a result, the securing element can advantageously be moved passively into the securing position, at least in sections, which is advantageously haptically and/or visually detectable for the operator or the operating device. As a result, the assembly can advantageously be improved.

A further aspect of the present invention relates to a flat plug connector with a securing element, comprising
a coupling portion for form-fit coupling to a complementary coupling portion of a complementary flat plug connector, wherein the coupling portion has a receptacle at which the securing element is arranged at least in sections,
   wherein the coupling portion and the securing element are configured to be complementary to each other such that in a decoupled state of the flat plug connector in which the coupling portion and the complementary coupling portion are not coupled to each other, the securing element is retained in the non-securing position.

The present flat plug connector may in particular correspond to the flat plug connector of the aspect relating to the flat plug connector system described herein.

Exemplary, preferred and alternative embodiments of the aspect relating to the flat plug connector, as well as the effects thereof, may in particular correspond to those as explained with regard to the aspect relating to the flat plug connector system, and vice versa.

A further aspect of the present invention relates to a securing element for a flat plug connector system or for a flat plug connector, in particular for a flat plug connector system according to the aspect relating to the flat plug connector system or for a flat plug connector according to the aspect relating to the flat plug connector, wherein the securing element comprises:
one or more protrusions for form-fit fastening of the securing element to a receptacle of a coupling portion or a complementary coupling portion of the flat plug connector system;
a securing portion which is configured to secure a form-fit coupling of the coupling portion and the complementary coupling portion; and
one or more latch protrusions which are configured to engage with a latch of the receptacle to block transfer of the securing element into a securing position at the receptacle.

Exemplary, preferred and alternative embodiments of the aspect relating to the securing element, as well as the effects thereof, may in particular correspond to those as explained with regard to the aspect relating to the flat plug connector system described herein and/or to the aspect relating to the flat plug connector described herein, and vice versa.

The securing portion may in particular have one or more securing surfaces.

The securing surface is in particular configured to engage with a restorably rear-engaging element in a planar manner, at least in sections. The securing surface is in particular configured to engage with a rear side, or in other words a side of the restorably rear-engaging element facing away from a rear-engageable portion, in a planar manner, at least in sections.

This advantageously enables effective force distribution and force transmission in a securing position. As a result, a particularly stable securing of a coupling of the flat plug connector system can advantageously be ensured.

The securing element may in particular have one or more prongs. The one or more prongs may in particular extend substantially in the longitudinal direction or substantially in the plugging direction.

In a non-securing position and/or in a securing position which the securing element can assume at the flat plug connector system, the longitudinal direction of the securing element may substantially correspond to the plugging direction of the coupling portion at the receptacle of which the securing element is arranged.

In preferred embodiments, the securing element has multiple prongs. The prongs may in particular be configured to be restorable, in particular configured to be elastically restorable. The multiple prongs may in particular have a main extension direction in the longitudinal direction or in the plugging direction.

Additionally or alternatively, the multiple prongs may in particular be separated from one another substantially in the width direction, and furthermore may in particular be spaced apart from one another substantially in the width direction.

By virtue of the multiple prongs, which may in particular be spaced apart from one another in the width direction, multiple elastically restorable portions whose respective elastic deflection is not coupled to each other can advantageously be provided.

As a result, possible damage or fatigue caused, for example, by restorable engagements on individual prongs, can advantageously be prevented from causing damage to another functional restorable engagement which is formed on a prong separated therefrom.

In other words, by virtue of the multiple prongs, a functional separation or division of functionally distinct engagements on individual prongs can advantageously be provided. This division advantageously has the effect that possible damage to individual prongs does not have a direct negative impact on prongs functionally separated therefrom. As a result, the repeat accuracy of assembly and disassembly is advantageously improved.

A further aspect of the present invention relates to a method for securing a form-fit coupling between a flat plug connector and a complementary flat plug connector, wherein the flat plug connector has a coupling portion and the complementary flat plug connector has a complementary coupling portion which is couplable to the coupling portion in a form-fit manner, wherein the method comprises the steps of:
arranging a securing element on a receptacle of one of the coupling portion and the complementary coupling portion; and
transferring the securing element from a non-securing position towards a securing position at the receptacle, wherein the securing element is configured, in the securing position, to provide a secured state of the coupling between the coupling portion and the complementary coupling portion, in which detachment, in particular non-destructive detachment, of the form-fit coupling between the coupling portion and the complementary coupling portion is prevented,
   wherein the coupling portion, the complementary coupling portion and the securing element are configured to be complementary to each other such that in a decoupled state in which the coupling portion and the complementary coupling portion are not coupled to each other, the securing element is retained in the non-securing position.

Transfer of the securing element from the non-securing position towards the securing position does not necessarily result in the securing element reaching the securing position. In particular, the securing element is retained in the non-securing position in the decoupled state and therefore cannot reach the securing position. Only the coupled state in which the coupling portion and the complementary coupling portion are coupled to each other allows the securing element to reach the securing position when the securing element is transferred into the securing position.

Accordingly, in other words, the coupling portion, the complementary coupling portion and the securing element are configured to be complementary to each other such that in an operating state in which the coupling portion and the complementary coupling portion are not coupled to each other, in particular are not coupled to each other in a form-fit manner, transfer of the securing element into the securing position at the receptacle is blocked.

As a result, the assembly can advantageously be facilitated, whereby in particular an unintentional transfer of the securing element into the securing position can be prevented, especially before reaching the coupled state between the coupling portion and complementary coupling portion.

As a result, the securing element can advantageously be pre-assembled to the receptacle, whereby the assembly can be further facilitated. Furthermore, in particular the occurrence of visual and/or haptic feedback can be ensured when the securing element passes into the securing position.

This allows to further advantageously improve the assembly in a passive manner, and in particular to improve the verifiability of the assembly success.

Exemplary, preferred and alternative embodiments of the aspect relating to the method for securing a form-fit coupling between a flat plug connector and a complementary flat plug connector, as well as the effects thereof, may in particular correspond to those as explained with regard to the aspect relating to the flat plug connector system and/or with regard to the aspect relating to the flat plug connector and/or with regard to the aspect relating to the securing element, and vice versa.

In preferred embodiments of the method, the step of arranging the securing element may comprise arranging the securing element at the receptacle in a form-fit manner; and/or
the step of transferring the securing element into the securing position may comprise applying a predetermined securing force to transfer the securing element into the securing position.

Arranging the securing element at the receptacle in a form-fit manner may in particular comprise arranging the securing element at the receptacle in which the securing element is restorably deformed at least in sections, in particular is elastically restorably deformed at least in sections.

For example, one or more prongs of the securing element may be elastically deformed when arranging the securing element at the receptacle. In particular, one or more prongs, each of which has at least one counterhold, may be elastically deformed when arranging the securing element at the receptacle.

In preferred embodiments, the restorable deformation of the securing element may be limited to the prongs of the securing element which comprise at least one counterhold when arranging the securing element at the receptacle.

Additionally or alternatively, the restorable deformation of the securing element when arranging the securing element at the receptacle, in particular starting from a separate position of the securing element from the receptacle, may not relate to a prong which co-defines a detaching force and/or a securing force of the securing element. In other words, the restorable deformation of the securing element when arranging the securing element at the receptacle, in particular starting from a separate position of the securing element from the receptacle, may not relate to a prong which is involved in retaining the securing element in the non-securing position.

In particular, the one or more prongs at which the one or more counterholds and/or the one or more latch protrusions are arranged or formed are involved in retaining the securing element in the non-securing position.

Arranging the securing element at the receptacle may in particular comprise transferring the securing element from a position separate from the receptacle to a position at the receptacle which may in particular be the non-securing position.

By virtue of the functional separation of the multiple prongs of the securing element, damage to a prong caused by a deformation which is not (being) caused by the intended function of the prong can advantageously be prevented.

Accordingly, it is advantageously made possible to improve the service life of the securing element and furthermore in particular the service life of the flat plug connector system. Furthermore, it is advantageously made possible for predetermined securing and/or detaching forces to be maintained for a particularly long time. As a result, the repeat accuracy of the assembly, which is performed by an operator or an operating unit, for example, and accordingly the assembly quality is advantageously improved.

In preferred embodiments of the method, the receptacle may comprise a latch and the securing element may comprise a latch protrusion,
wherein, when a step of coupling the coupling portion to the complementary coupling portion in a form-fit manner is performed prior to transferring the securing element into the securing position, the securing element is transferable into the securing position, and
when a step of coupling the coupling portion to the complementary coupling portion in a form-fit manner is not performed prior to transferring the securing element into the securing position, the latch protrusion is engaged or engages with the latch such that the securing element is retained in the non-securing position.

In other words, the securing element may in particular have one or more latch protrusions which, in a decoupled state of the flat plug connector system, is or are configured to engage with the latch upon movement of the securing element towards the securing position, so that transfer of the securing element into the securing position is (being) blocked.

As a result, the assembly can advantageously be simplified and improved, in particular in a passive manner.

In preferred embodiments of the method, the step of transferring the securing element into the securing position may comprise moving the securing element substantially in a plugging direction, and/or
one of the coupling portion and the complementary coupling portion may comprise a securing protrusion and the securing element may comprise a protrusion complementary to the protrusion, wherein the protrusion and the complementary protrusion of the securing element define a predetermined detaching force in the secured state, which is to be applied to transfer the securing element from the securing position into a non-securing position.

By the securing element to be moved substantially in the plugging direction to transfer it into the securing position, by virtue of the rectified direction for coupling the coupling portion, accidental decoupling of the coupling portion from the complementary coupling portion can advantageously be prevented when transferring the securing element into the securing position.

The protrusion complementary to the securing protrusion may in particular be arranged or formed on a securing prong of the securing element. The securing prong may be configured to be restorable, in particular elastically restorable. The securing prong may be arranged separately in the width direction, in particular spaced apart in the width direction, from one or more further prongs of the securing element. In particular, elements for retaining the securing element in the non-securing position may be arranged or formed at the one or more further prongs of the securing element.

By virtue of the protrusion complementary to the securing protrusion, and in particular the separation of the securing prong from one or more further prongs, a predetermined detaching and/or securing force for transferring the securing element from the non-securing position into the securing position or vice versa can advantageously be defined. Furthermore, the predetermined detaching and/or securing force can advantageously be maintained over a long service life.

As a result, the repeat accuracy of the assembly, for example by an operator and/or an operating unit, is advantageously improved, which in turn advantageously improves the assembly quality.

In the following, embodiments of the invention are described in more detail with reference to the appended figures. It is to be understood that the present invention is not limited to these embodiments, and that individual features of the embodiments can be combined to form further embodiments within the scope of the appended claims.

Shown are:

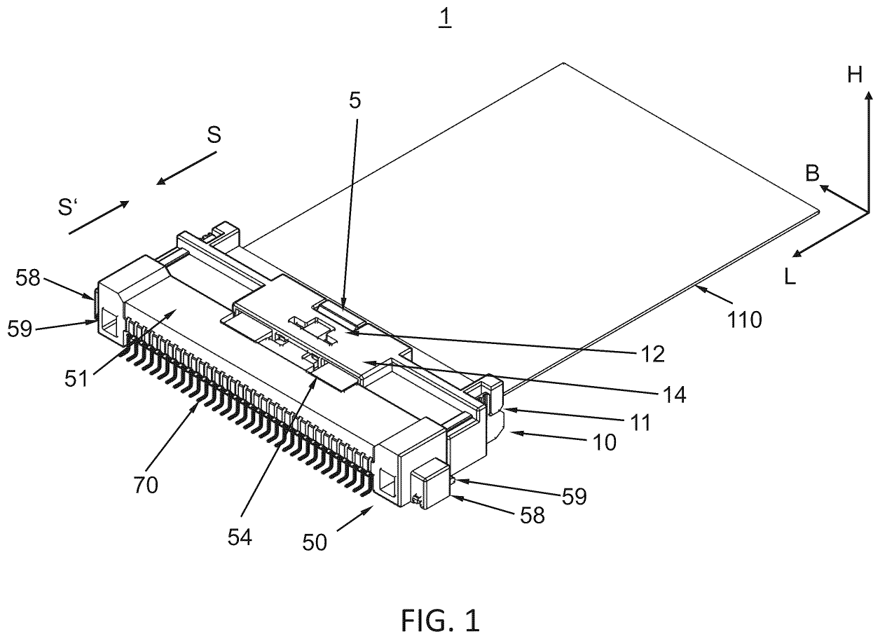

FIG. 1 an oblique view of a flat plug connector system, according to one embodiment of the present invention;

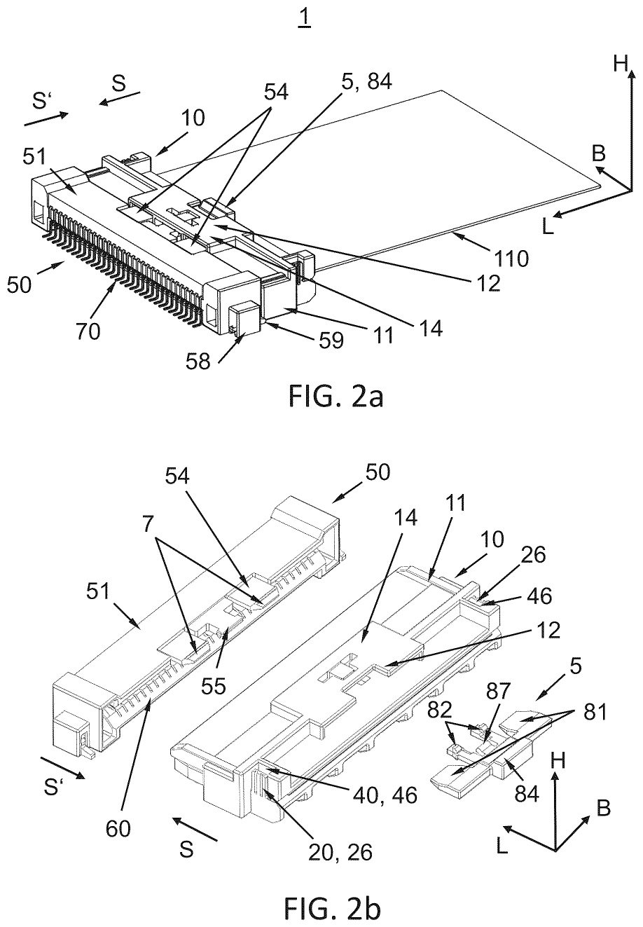

FIG. 2a an oblique view of a flat plug connector system, according to one embodiment of the present invention;

FIG. 2b an oblique view of a flat plug connector system, according to one embodiment of the present invention;

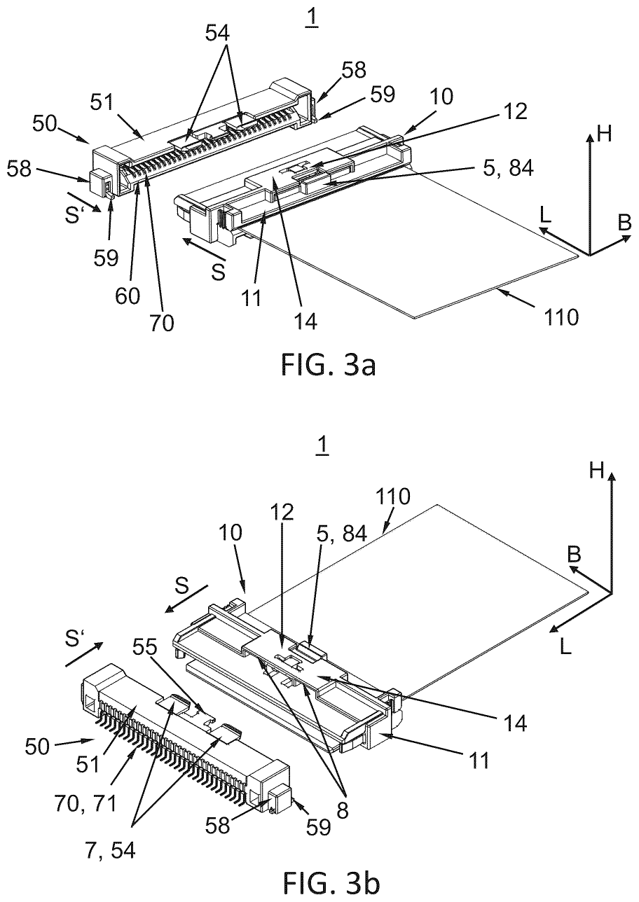

FIGS. 3a and 3b each an oblique view of a flat plug connector system, according to one embodiment of the present invention;

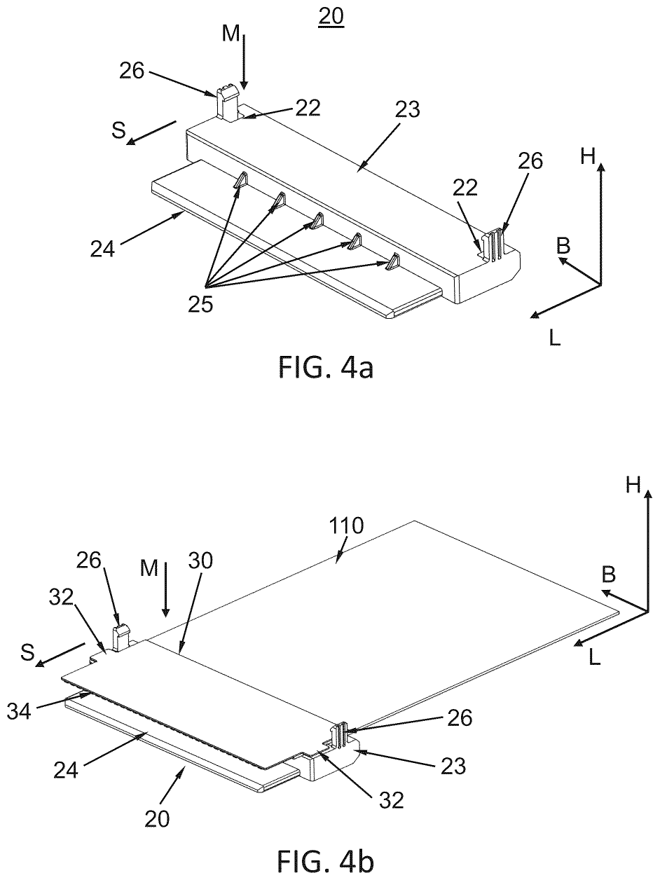

FIG. 4a an oblique view of a plug connector housing part, according to one embodiment of the present invention;

FIG. 4b an oblique view of a plug connector housing part of a flat plug connector with a conductor portion, according to one embodiment of the present invention;

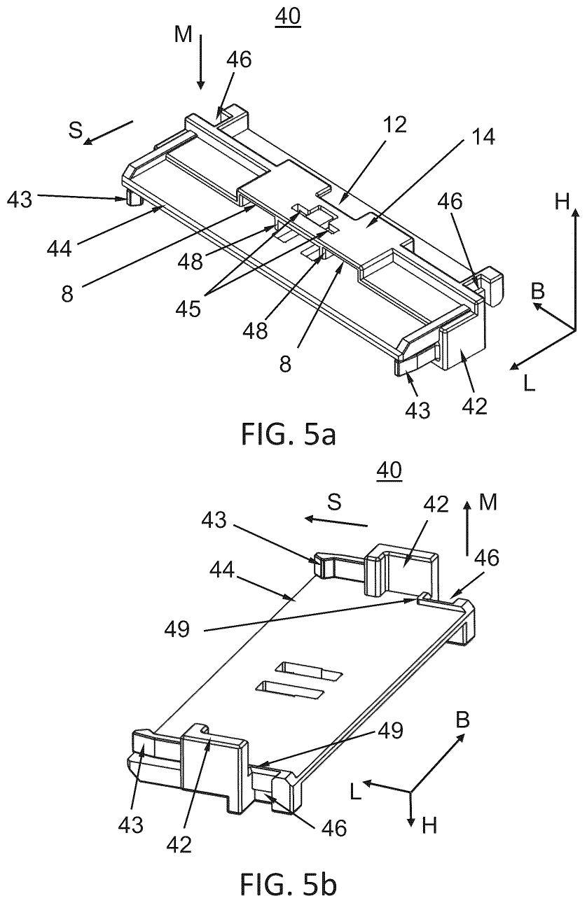

FIG. 5a an oblique view from above of a plug connector housing part of a flat plug connector, according to one embodiment of the present invention;

FIG. 5b an oblique view from below of a plug connector housing part of a flat plug connector, according to one embodiment of the present invention;

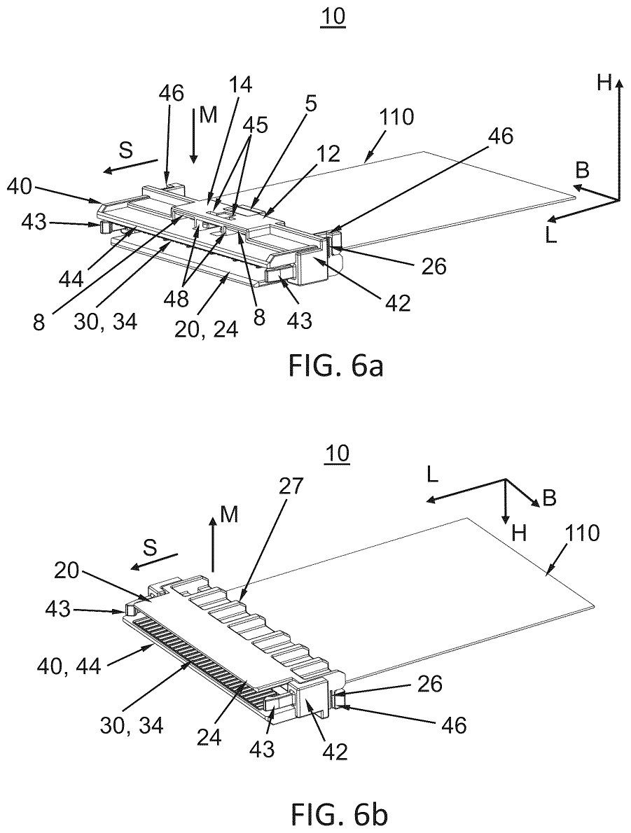

FIG. 6a an oblique view from above of a flat plug connector system, according to one embodiment of the present invention;

FIG. 6b an oblique view from below of a flat plug connector system, according to one embodiment of the present invention;

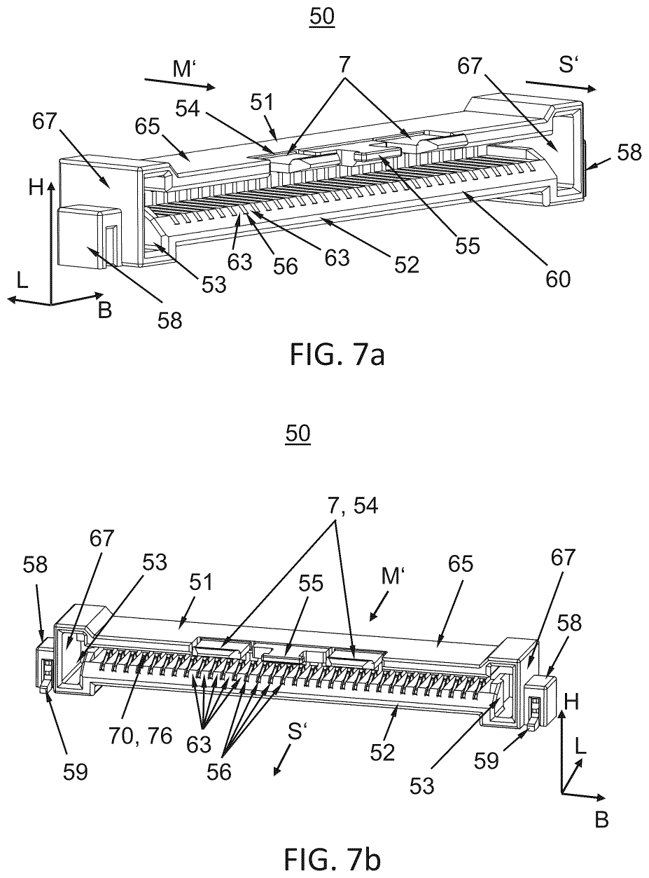

FIGS. 7a and 7b each an oblique view of a complementary flat plug connector, according to one embodiment of the present invention;

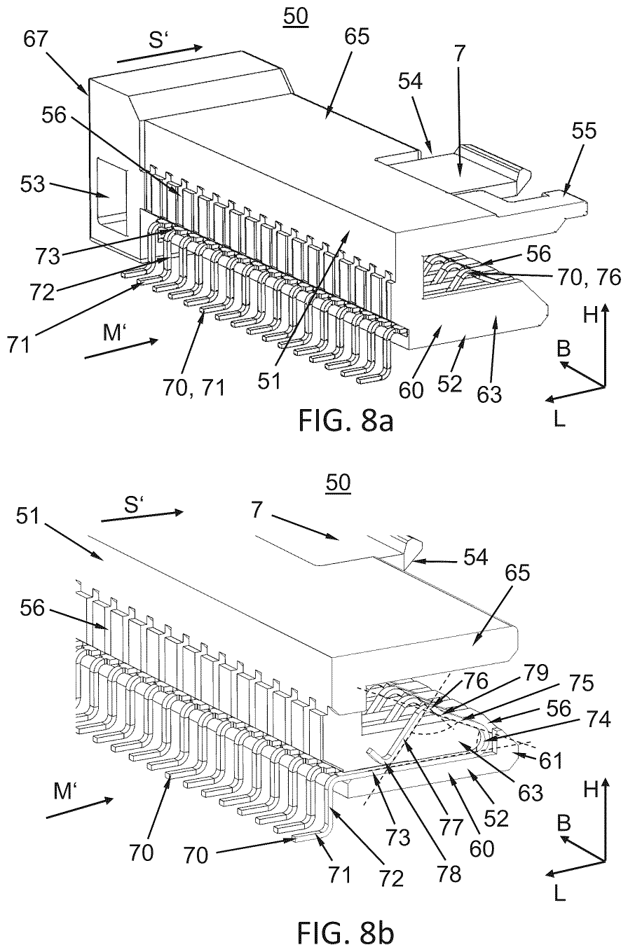

FIGS. 8a and 8b each a sectional illustration of a complementary flat plug connector, according to one embodiment of the present invention;

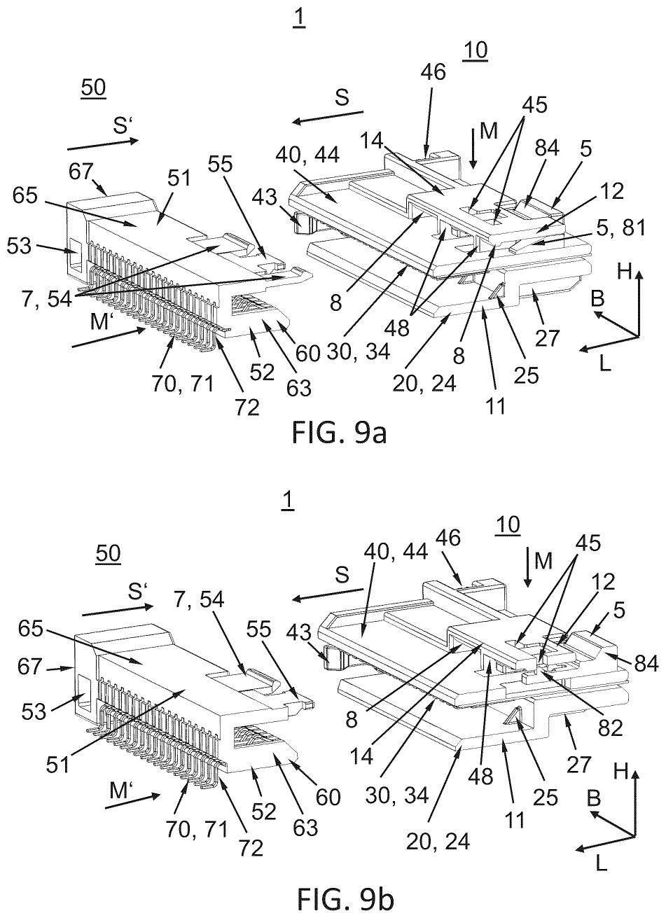

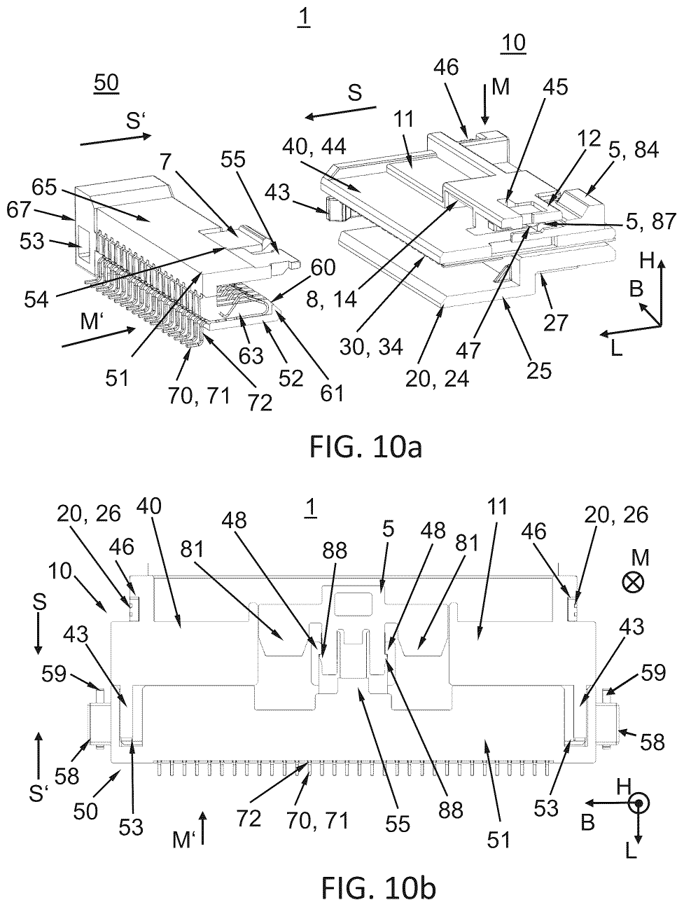

FIGS. 9a to 10a each a sectional illustration of a flat plug connector system, according to one embodiment of the present invention;

FIG. 10b a plan view of a sectional illustration of a flat plug connector system, according to one embodiment of the present invention;

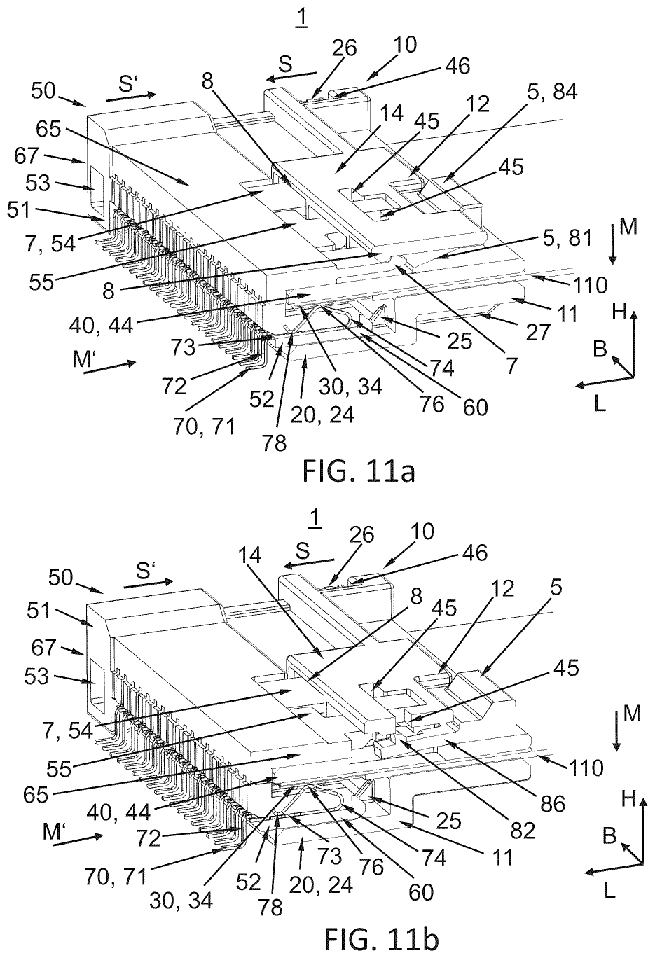

FIGS. 11a to 14b each a sectional illustration of a flat plug connector system, according to one embodiment of the present invention;

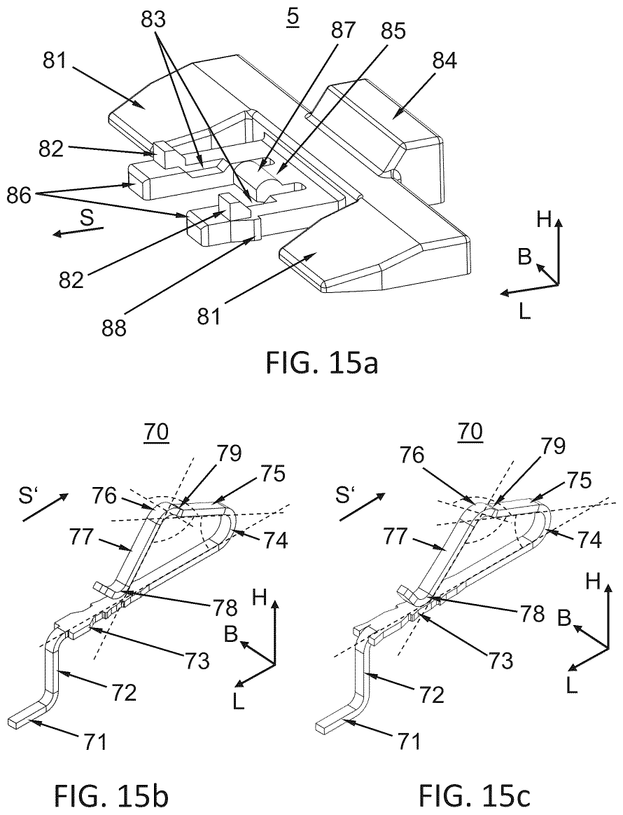

FIG. 15a a securing element, according to one embodiment of the present invention,

FIGS. 15b and 15c each a contact for a flat plug connector, according to one embodiment of the present invention;

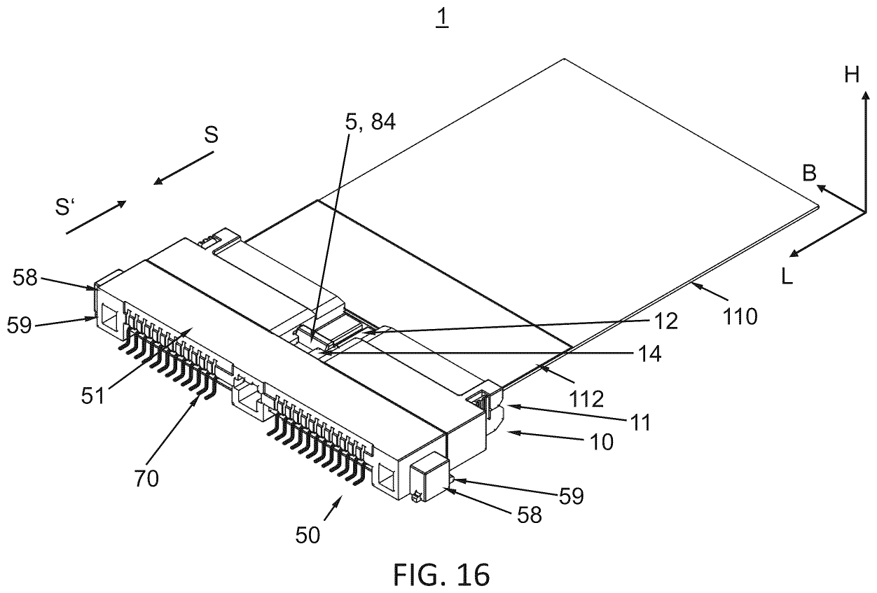

FIG. 16 an oblique view of a flat plug connector system, according to one embodiment of the present invention;

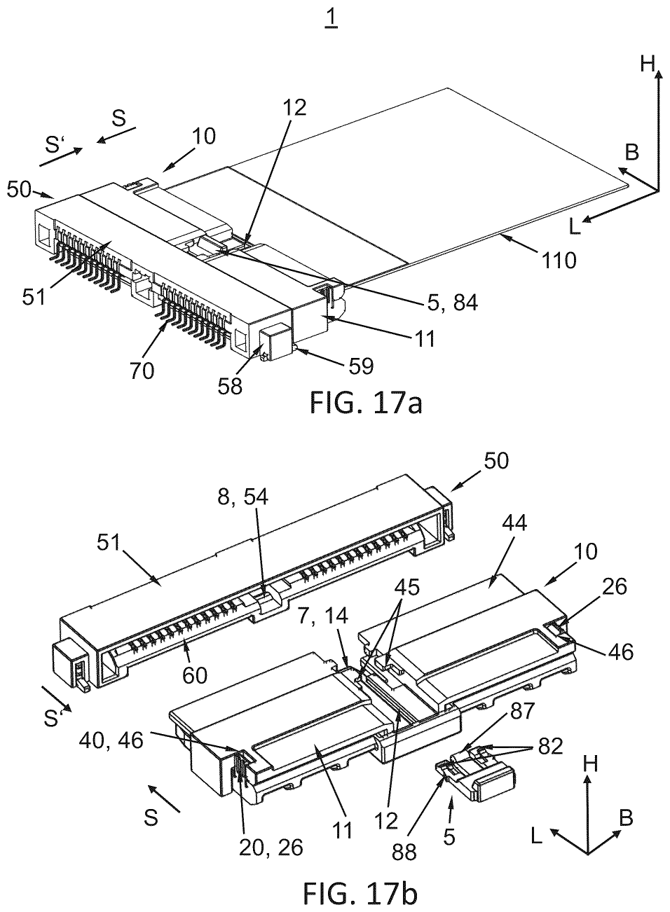

FIG. 17a an oblique view of a flat plug connector system, according to one embodiment of the present invention;

FIG. 17b an oblique view of a flat plug connector system, according to one embodiment of the present invention;

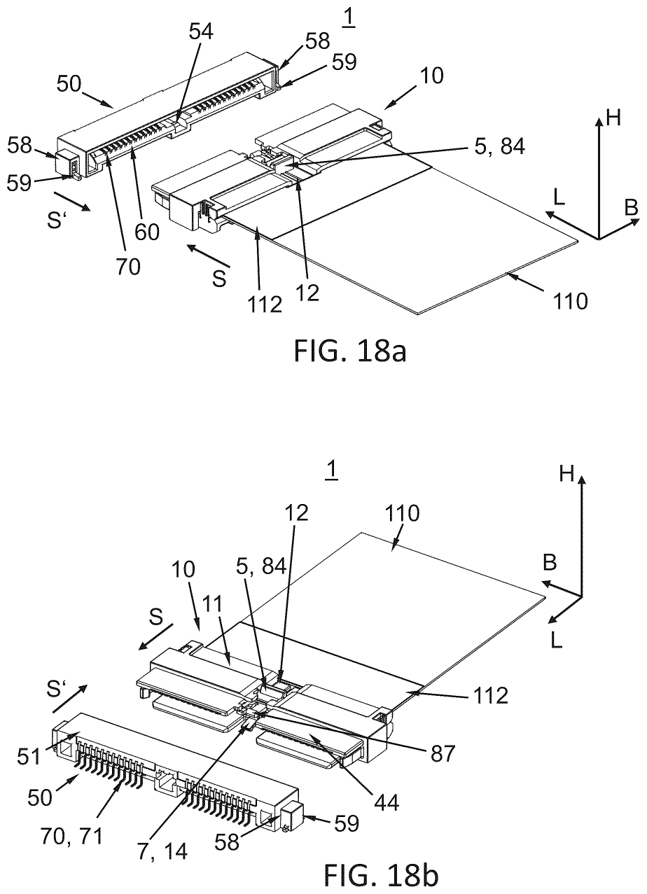

FIGS. 18a and 18b each an oblique view of a flat plug connector system, according to one embodiment of the present invention;

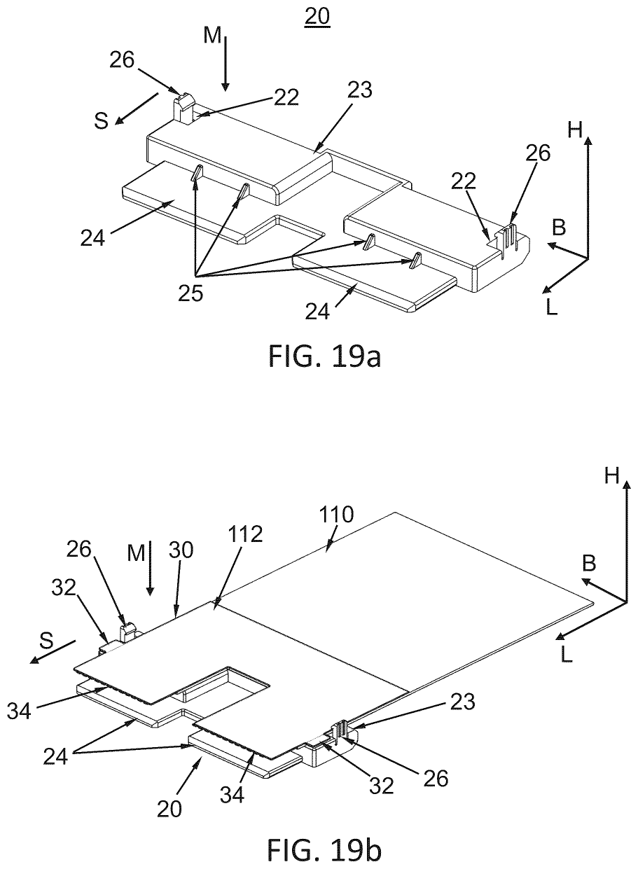

FIG. 19a an oblique view of a plug connector housing part, according to one embodiment of the present invention;

FIG. 19b an oblique view of a plug connector housing part of a flat plug connector with a conductor portion, according to one embodiment of the present invention;

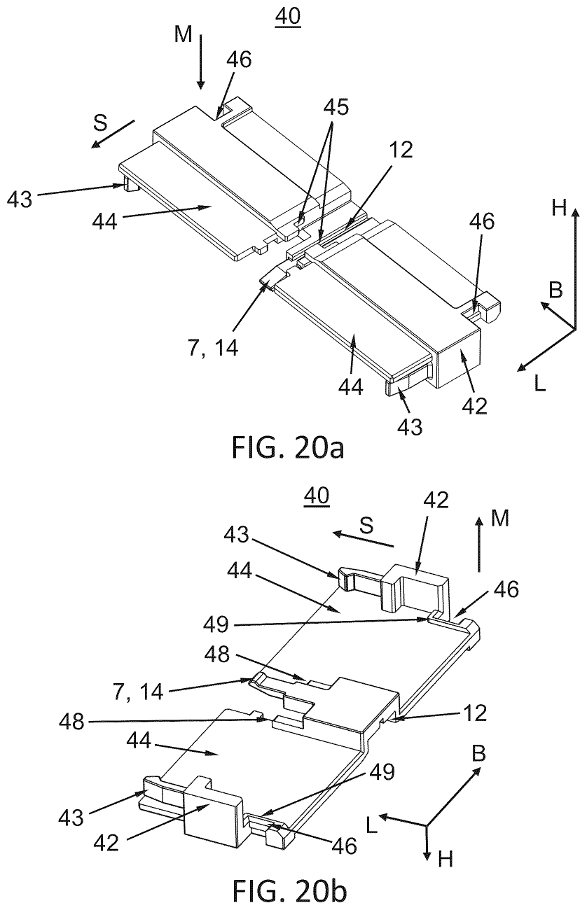

FIG. 20a an oblique view from above of a plug connector housing part of a flat plug connector, according to one embodiment of the present invention;

FIG. 20b an oblique view from below of a plug connector housing part of a flat plug connector, according to one embodiment of the present invention;

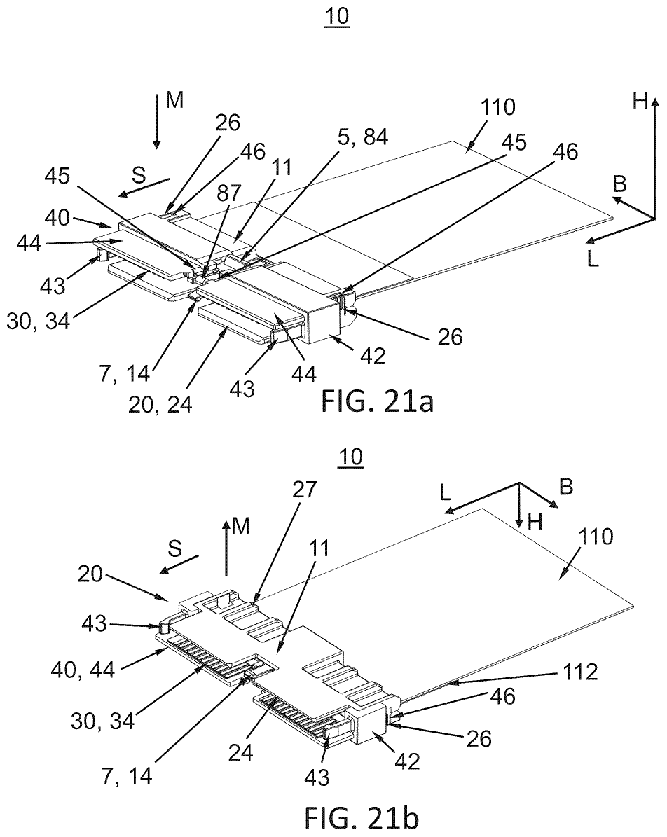

FIG. 21a an oblique view from above of a flat plug connector system, according to one embodiment of the present invention;

FIG. 21b an oblique view from below of a flat plug connector system, according to one embodiment of the present invention;

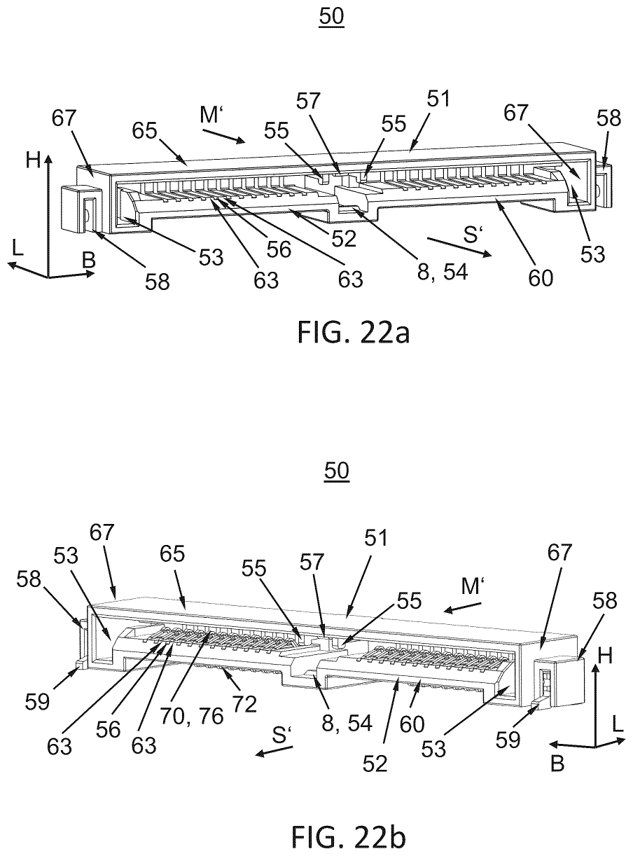

FIGS. 22a and 22b each an oblique view of a complementary flat plug connector, according to one embodiment of the present invention;

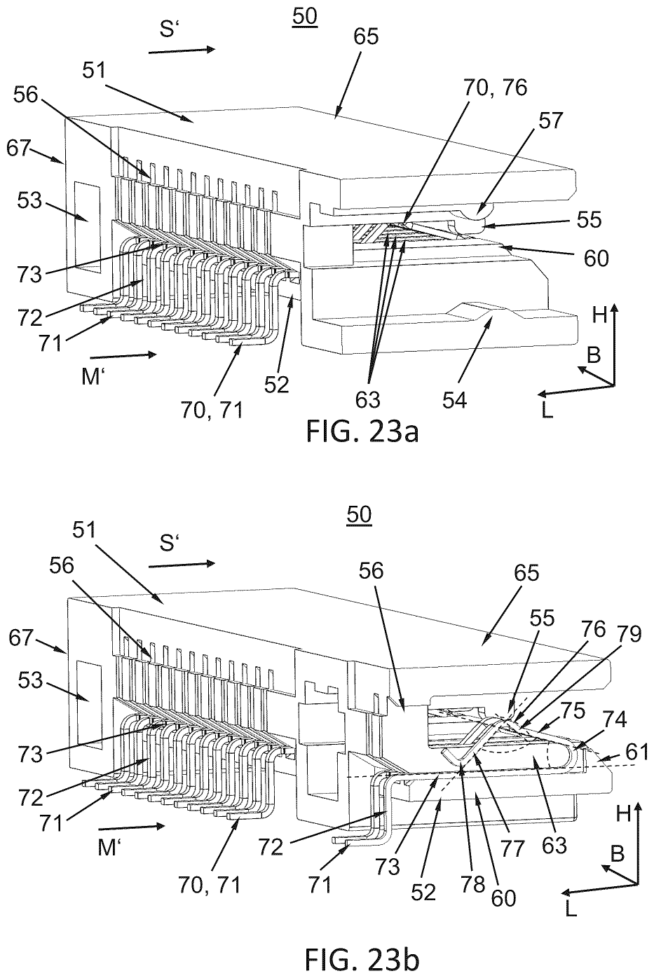

FIGS. 23a and 23b each a sectional illustration of a complementary flat plug connector, according to one embodiment of the present invention;

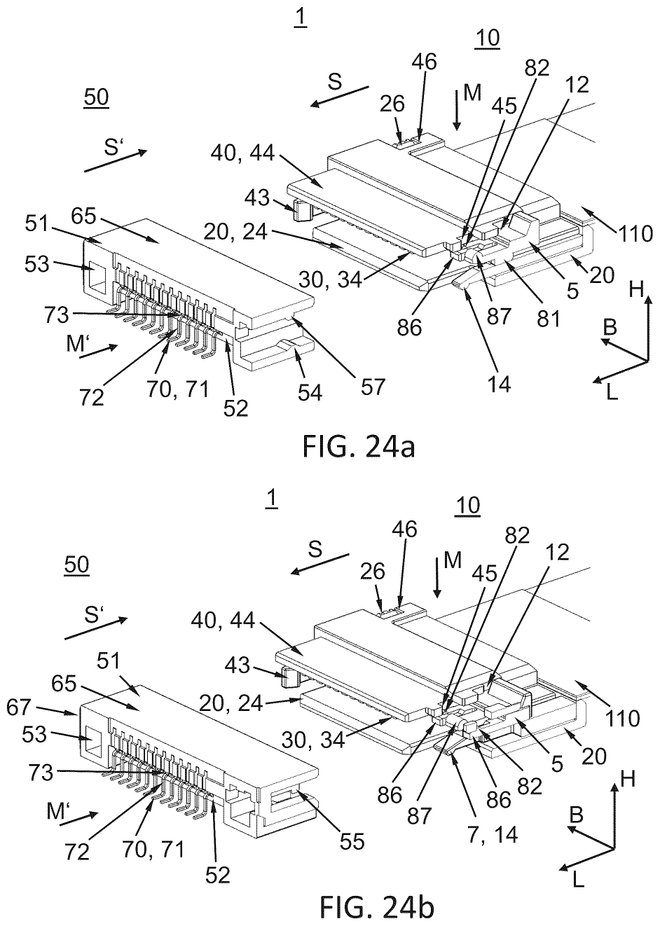

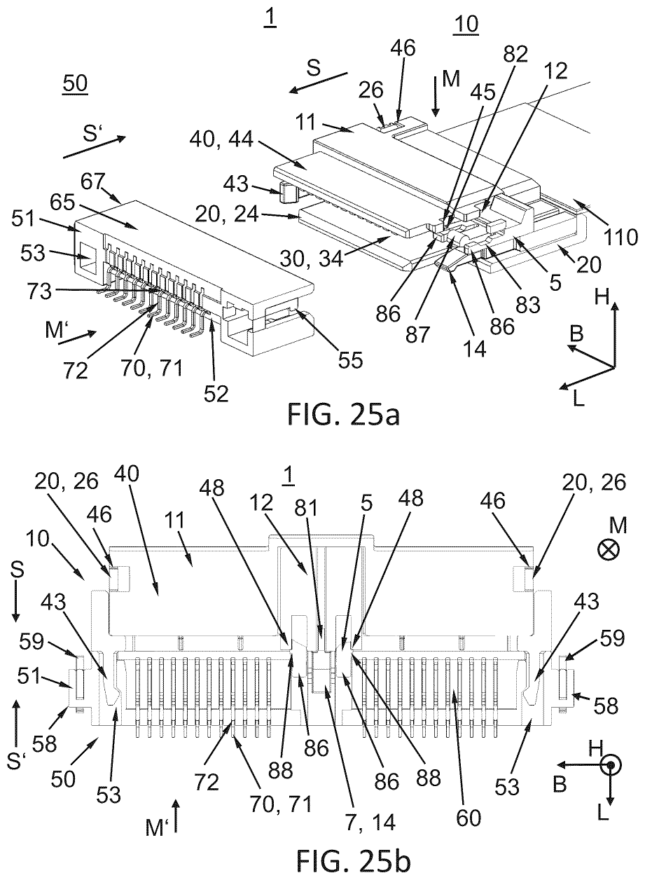

FIGS. 24a to 25a each a sectional illustration of a flat plug connector system, according to one embodiment of the present invention;

FIG. 25b a plan view of a sectional illustration of a flat plug connector system, according to one embodiment of the present invention;

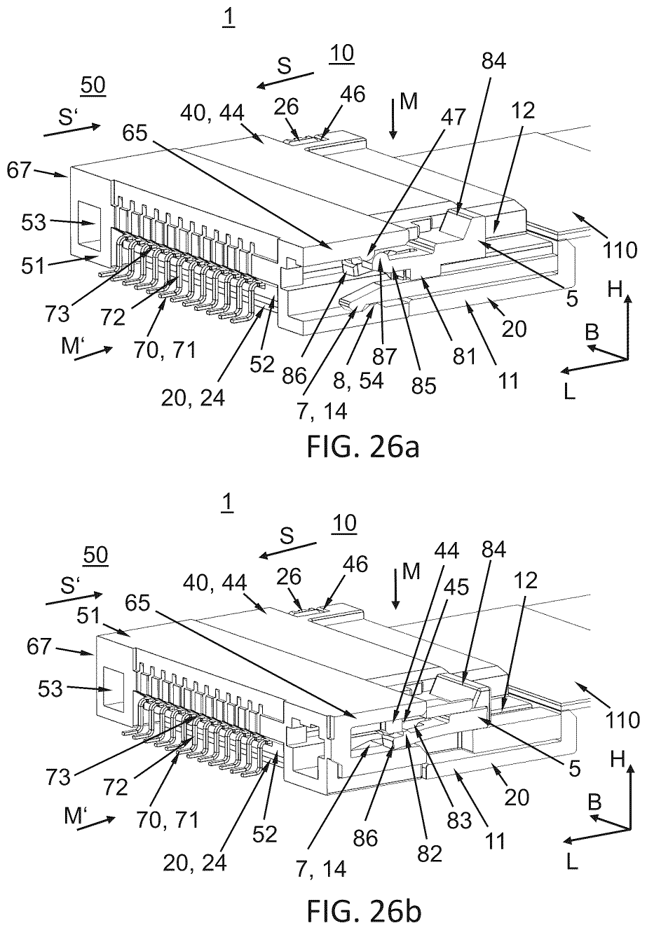

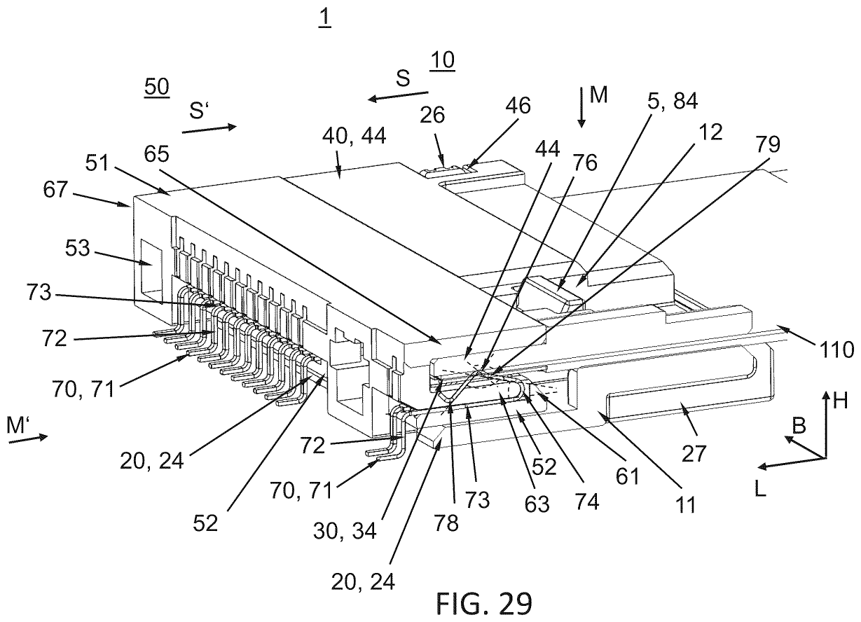

FIGS. 26a to 29 each a sectional illustration of a flat plug connector system, according to one embodiment of the present invention;

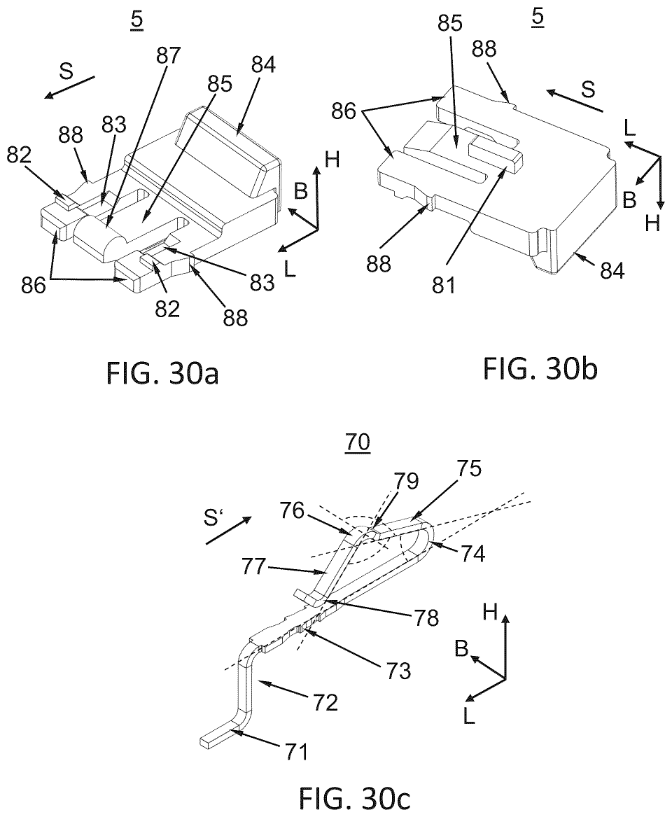

FIGS. 30a and 30b a securing element, according to one embodiment of the present invention, from above and from below;

FIG. 30c a contact for a flat plug connector, according to one embodiment of the present invention;

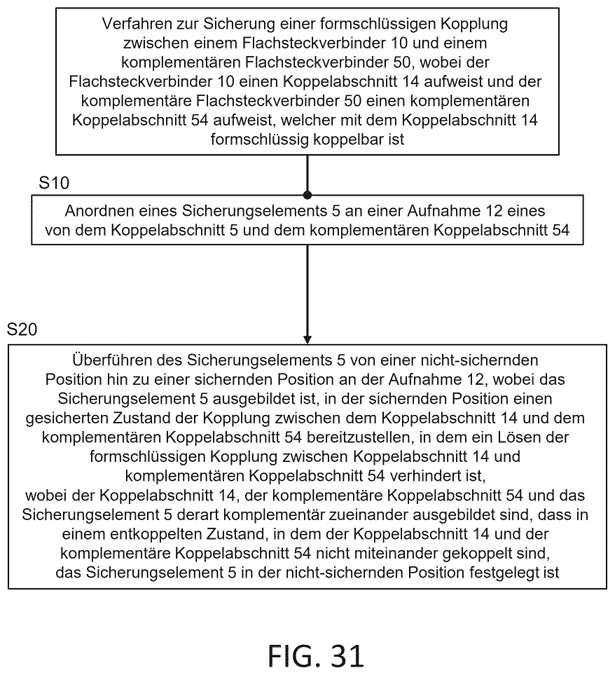

FIG. 31 a flowchart of a method for securing a form-fit coupling between a flat plug connector and a complementary flat plug connector, according to the present invention; and

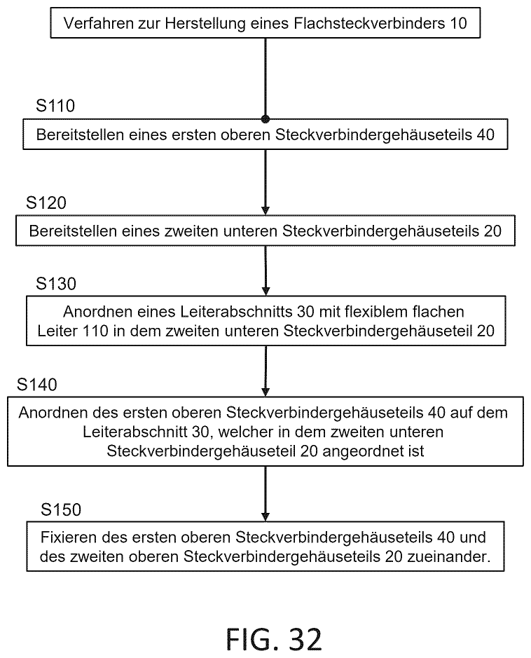

FIG. 32 a flowchart of a method for manufacturing a flat plug connector, according to the present invention.

FIGS. 1, 2a, 2b, 3a, 3b, 4a, 4b, 5a, 5b, 6a, 6b, 7a, 7b, 8a, 8b, 9a, 9b, 10a, 10b, 11a, 11b, 12a, 12b, 13a, 13b, 14a, 14b and 15a refer in particular to a first embodiment of a flat plug connector system 1.

FIGS. 16, 17a, 17b, 18a, 18b, 19a, 19b, 20a, 20b, 21a, 21b, 22a, 22b, 23a, 23b, 24a, 24b, 25a, 25b, 26a, 26b, 27a, 27b, 28a, 28b, 29, 30a and 30b refer in particular to a second embodiment of a flat plug connector system 1. The second embodiment of the flat plug connector system 1 has in particular a different coupling portion 14 and a different complementary coupling portion 54 than the first embodiment of the flat plug connector system 1. The second embodiment thereby advantageously enables a lower overall height of the flat plug connector system 1, while at the same time in particular secure assembly and securing of a coupled state can be ensured.

The flat plug connector system 1 of the first and second embodiments may, for example, have a height in the height direction H of less than about 7.5 mm, in particular less than about 6.5 mm, preferably less than about 6.0 mm, more preferably less than about 5.0 mm, particularly preferably less than about 4.5 mm, in particular in the secured state and/or in the unsecured state.

In particular, the flat plug connector system 1 of the second embodiment enables a height in the height direction H of less than 4.5 mm by virtue of the arrangement or formation of the coupling portion 14 and the complementary coupling portion 54 substantially in the width direction B between two groups of contacts 70 and between two portions of the conductor portion 30, as shown by way of example in FIG. 18b.

Unless explicitly emphasized otherwise, elements, their functions, relationships and method steps, which are explained with reference to the first embodiment of the flat plug connector system 1, refer equally to the second embodiment of the flat plug connector system 1, and vice versa.

FIGS. 15b and 15c refer in particular to a first embodiment of a contact 70. The contact 70, as shown in FIGS. 15b and 15c, may be used both in the first embodiment of the flat plug connector system 1 and in the second embodiment of the flat plug connector system 1, but is preferably used in the first embodiment of the flat plug connector system 1.

FIG. 30c refers in particular to a second embodiment of a contact 70. The contact 70, as shown in FIG. 30c, may be used both in the first embodiment of the flat plug connector system 1 and in the second embodiment of the flat plug connector system 1, but is preferably used in the second embodiment of the flat plug connector system 1.

The flowcharts in FIGS. 31 and 32 refer to all of the embodiments of the present flat plug connector systems 1.

FIGS. 1, 13a, 13b, 14a, 14b, 16, 27b, 28a, 28b and 29 refer in particular to a coupled state of the flat plug connector system 1, wherein the securing element 5 is arranged in the securing position in each case.

FIGS. 2a, 10b, 11a, 11b, 12a, 12b, 17a, 25b, 26a, 26b and 27a refer in particular to a coupled state of the flat plug connector system 1, wherein the securing element 5 is arranged in the non-securing position in each case.

FIGS. 3a, 3b, 6a, 6b, 9a, 9b, 10a, 18a, 18b, 21a, 21b, 24a, 24b and 25a refer in particular to a non-coupled or decoupled state of the flat plug connector system 1, wherein the securing element 5 is arranged in the non-securing position in each case.

The coupled state of the flat plug connector system 1, as shown in particular in FIGS. 1, 9a, 9b, 10a, 13a, 13b, 14a, 14b, 16, 18a, 18b, 21a, 24a, 24b, 25a, 27b, 28a, 28b and 29, refers to a state in which the coupling portion 14 of the flat plug connector 10 is engaged, in particular engaged in a form-fit manner, with the complementary coupling portion 54 of the complementary flat plug connector 50. The form-fit may in particular be formed substantially in parallel to the plugging direction S, S′, in particular formed substantially in parallel opposite to the plugging direction. In other words, the form-fit may in particular block a movement substantially in parallel to the plugging direction S, S′. Alternatively or additionally, the form-fit may be formed substantially in the height direction H.

As a result, for example, even a coupling that is not secured by the securing element 5 can advantageously already define a predetermined detaching force to detach the coupling between the flat plug connector 10 and the complementary flat plug connector 50 or between the coupling portion 14 and the complementary coupling portion 54. In the non-secured coupling, the securing element 5 is not arranged in the securing position. For example, the securing element 5 may be arranged in the non-securing position.

The non-securing position of the securing element 5, as shown for example in FIGS. 2a, 3a, 3b, 6a, 9a, 9b, 10a, 10b, 11a, 11b, 12a, 12b, 17a, 18a, 18b, 21a, 24a, 24b, 25a, 25b, 26a, 26b and 27a, is in particular a position in which the securing element 5 is arranged at least in sections at the receptacle 12.

In the non-securing position, an actuating portion 84 of the securing element 5 may project from the receptacle 12, in particular opposite to the plugging direction S (see especially FIGS. 3a, 3b, 9a, 9b and 10a for the first embodiment of the flat plug connector system 1).

In the non-securing position, a front side, in the plugging direction S, of the actuating portion 84 of the securing element 5 may in particular not abut against an upper wall 44 of the flat plug connector 10 or not be directly adjacent thereto.

It is to be understood that the non-securing position of the securing element 5 may also be a position of the securing element 5 remote from the receptacle 12, in which the securing element 5 does not secure the coupling between the flat plug connector 10 and the complementary flat plug connector 50.

In the coupled state, in particular one or more rear-engageable portions 8 may be engaged with one or more restorably rear-engaging elements 7, in particular engaged in a form-fit manner. The form-fit may in particular be formed substantially in parallel to the plugging direction S, S′, in particular substantially in parallel opposite to the plugging direction. Alternatively or additionally, the form-fit may be formed substantially in the height direction H.

The coupled state of the flat plug connector system 1 is in particular a state in which the coupling portion 14 and the complementary coupling portion 54 are coupled or engage with each other, or in other words rear-engage each other, and both the coupling portion 14 and the complementary coupling portion 54 have substantially no or no elastic deformation. Possible elastic deformations which are produced due to contact with the securing element 5, which in particular lead to elastic deformation of the securing element 5, are not taken into account here. For this purpose, the coupling portion 14 and/or the complementary coupling portion 54 may in particular be configured to be comparatively rigid relative to the one or more restorable, in particular elastically restorable prongs 85, 86 of the securing element 5.

As shown in particular by FIGS. 2b, 3a, 3b, 17b, 18a and 18b, the plug connector housing 11 of the flat plug connector 10 and the plug connector housing 51 of the complementary flat plug connector 50 may in particular be configured in a poka-yoke shape with respect to each other.

In particular, the plug connector housing 11 of the flat plug connector 10 and the plug connector housing 51 of the complementary flat plug connector 50 may be configured to be complementary to each other such that coupling of the flat plug connector 10 to the complementary flat plug connector 50 is blocked or, in other words, is not allowed when one of the two plug connector housings 11, 51 is rotated about the plugging direction S, S′, in particular by 180°.

As shown by the figures of the first and second embodiments of the flat plug connector system 1 with regard to the coupled state, one of the coupling portion 14 and the complementary coupling portion 54 may have one or more rear-engageable portions 8, and the other one of the coupling portion 14 and the complementary coupling portion 54 may have one or more restorably rear-engaging elements 7. Here, a restorably rear-engaging element 7 may in particular be configured to rear-engage one or more rear-engageable portions 8 in the coupled state. A rear-engageable portion 8 may in particular be configured to be rear-engaged by one or more restorably rear-engaging elements 7 in the coupled state. A rear-engageable portion 8 of the one or more rear-engageable portions 8 may in particular be configured to be comparatively rigid as compared to a restorably rear-engaging element 7 of the one or more restorably rear-engaging elements 7.

The rear engagement, or also the engagement, between the coupling portion 14 and the complementary coupling portion 54 comprises in particular an engagement substantially perpendicular to the plugging direction S, S′.

As shown in the figures of the first and second embodiments of the flat plug connector system 1 with regard to the coupled state, and illustrated therein in particular in FIGS. 11a, 13a, 26a and 27b, the rear-engageable portion 8 and/or the restorably rear-engaging element 7 may, at least in sections, extend substantially in the height direction.

As a result, a reliable and securable form-fit coupling relative to the plugging direction S, S′ can advantageously be ensured.

If the securing element 5 is arranged at the receptacle 12, for example by a step of arranging the securing element 5 at the receptacle 12, which can be carried out in particular as part of a pre-assembly of the flat plug connector system 1, the securing element 5 may either be arranged in the securing position or in the non-securing position.

If the securing element 5 is arranged at the receptacle 12 and the flat plug connector system 1 is in the coupled state, as shown for example in FIGS. 1, 2a, 13a, 13b, 14a, 14b, 16, 18a, 18b, 21a, 24a, 24b, 25a, 27b, 28a, 28b and 29, the securing element 5 is in particular transferable between the securing position and the non-securing position, in particular transferable in a non-destructive manner.

If the securing element 5 is arranged at the receptacle 12 and the flat plug connector system 1 is in the decoupled state or non-coupled state, as shown for example in FIGS. 3a, 3b, 6a, 6b, 9a, 9b, 10a, 18a, 18b, 21a, 21b, 24a, 24b and 25a, the securing element 5 is retained in particular in the non-securing position. The non-securing position may in particular be characterized by one or more form-fits in parallel to the plugging direction S, S′. In exemplary embodiments, the one or more form-fits, in particular of the securing element 5 relative to the receptacle 12, may in particular define a position or arrangement in or from which the securing element 5 is not transferable into the securing position in a non-destructive manner.

As a result, a simple assembly of the flat plug connector system 1 can be advantageously provided, in which the securing element 5 can be pre-assembled to the receptacle 12, for example, without the securing element 5 impairing the coupling between the flat plug connector 10 and the complementary flat plug connector 50.

As shown in the figures of the first and second embodiments of the flat plug connector system 1, the flat plug connector system 1 has in particular a first flat plug connector 10 and a second flat plug connector 50 complementary to the first flat plug connector 10.

The flat plug connector 10 and the complementary flat plug connector 50 are couplable to each other. The flat plug connector 10 and the complementary flat plug connector 50 are in particular electrically conductively connectable to each other.

For example, one of the flat plug connector 10 and the complementary flat plug connector 50 may have one or more electrically conductive conductor portions 30 and the other one of the flat plug connector 10 and the complementary flat plug connector 50 may have one or more electrically conductive contacts 70. The one or more electrically conductive conductor portions 30 are in particular electrically conductively connectable to one or more electrically conductive contacts 70.

In exemplary embodiments, a contact 70 of the one or more electrically conductive contacts 70 may be configured to be restorable, in particular elastically restorable, to be able to contact the one or more conductor portions 30, in particular with a bias.

In exemplary embodiments, a contact 70 of the one or more electrically conductive contacts 70 can contact the one or more conductor portions 30 when the flat plug connector system 10 is in the coupled state, in particular exclusively when the flat plug connector system 10 is in the coupled state.

As a result, reliable electrically conductive contacting between the flat plug connectors 10, 50 can advantageously be ensured.

A contact 70 of the one or more contacts 70 is connectable to an electronic component (not shown in the figures) such as a printed circuit board, in particular a PCB, for example, in particular by means of a terminal portion 71. A contact 70 may be connectable to the electrical component by means of soldering, in particular by means of reflow soldering, for example. The contact 70 may in particular be configured to be solderable, in particular reflow solderable. Alternatively or additionally, in particular a plug connector housing 51 of the complementary flat plug connector 50 may be configured to be solderable, in particular reflow solderable.

The plug connector housing 51, as shown by way of example in particular in FIGS. 7a, 7b, 22a and 22b, may in particular be an injection-molded component. In particular, the plug connector housing 51 may comprise or consist of a polymer material. For example, but not limited thereto, the plug connector housing 51 may comprise or consist of polyamide (PA), partially aromatized polyamide, for example PA66, PA6t, and/or PA9T, polyphenyl sulfones (PPSE), polyether sulfones (PES), polyether imides (PEI), polyphenylene sulfides (PPS), liquid crystal polymers (LCP), polyethylene (PE), polyether ether ketone (PEEK), and/or polypropylene (PP).

Preferably, the plug connector housing 51 comprises a polymer material which is reflow solderable, i.e. which is configured to withstand in particular temperatures which occur during reflow soldering in a dimensionally stable manner. The plug connector housing 51 may therefore preferably in particular comprise or consist of polyamide (PA) and/or PEEK.

In exemplary embodiments, the plug connector housing 51 may in particular be formed in one piece.

In alternative embodiments, the plug connector housing 51 may in particular be formed in multiple pieces. For example, the plug connector housing 51 may be a multi-component injection molded component.

As a result, the plug connector housing 51 can be advantageously formed in an inexpensive, dimensionally stable and electrically insulating manner and with repeat accuracy.

The complementary flat plug connector 50 or the plug connector housing 51 thereof has in particular a contact holder 60 at which the plurality of contacts 70 is arranged. The contact holder 60 may have a plurality of contact receptacles 56.

The plug connector housing 51 has in particular a number of contact receptacles 56 corresponding to the number of contacts 70 to be received. The plug connector housing 51 may in particular be configured to receive 24, 32, 64 or 96 contacts 70 or more. The contact receptacles 56 may in particular be configured as section-wise hollow molds, in particular as hollow molds that are substantially separated from each other in the width direction B.

The plug connector housing 51 may in particular have openings, on a rear side in the plugging direction S′, i.e. on a side facing away from the flat plug connector 10 during coupling, which open in particular into the contact receptacles 56. The rear side of the plug connector housing 51 may be closed, in particular aside from the openings and aside from receptacles which are in particular configured to receive elements of the flat plug connector 10. The openings may in particular have a width in the width direction B which substantially corresponds to the width in the width direction B of the contacts 70. The contacts 70 may in particular be fixable to the plug connector housing 51 from the rear side of the plug connector housing 51 in the assembly direction M′, in particular through the openings that open into the contact receptacles 56. The assembly direction M′ of the contacts 70 at the plug connector housing 51 of the complementary flat plug connector 50 may substantially correspond to the plugging direction S′ of the complementary flat plug connector 50.

The contact receptacles 56 may be separated from each other in the width direction B in particular by support walls 63. In other words, the contact receptacles 56 may in particular be substantially limited in the width direction B by support walls 63.

The support walls 63 may have an extension which is in particular substantially parallel to the height direction H and/or substantially parallel to the longitudinal direction L.

The support walls 63 may in particular have an extension which is shorter, i.e. in particular projects less far (upwards) in the height direction H than an extension of the contacts 70 arranged between the support walls 63. For example, the support walls 63 may have such an extension that at least or exclusively the bent contact regions 76 of the contacts 70 arranged between the support walls 63 are exposed, i.e. are not delimited by the support walls 63 in the width direction B.

The support walls 63 advantageously allow to guide the contacts 70 into the plug connector housing 51 during assembly. In particular, the contacts 70 may be advantageously guided into the predetermined contact receptacles 56 by the support walls 63, even in the case of assembly deviating from the assembly direction M′. Furthermore, the support walls 63 advantageously allow to guide the contacts 70, in particular in the case of a restorable deformation of the contacts 70, for example in the case of coupling to the flat plug connector 10. By the extension of the support walls 63, in particular in the height direction H, the contacts 70 may be advantageously protected, while at the same time contacting with contacts 34 or conductor elements 34 complementary to the contacts 70 with a predetermined contact force can be ensured. Thus, reliable electrically conductive contacting and at the same time a long service life of the contacts 70 can be advantageously ensured.

The plug connector housing 51 of the complementary flat plug connector 50 may in particular have a lower wall 52, a front wall 61, an upper wall 65, and/or one or more side walls 67. By the one or more walls 52, 61, 65, 67 protection for the contacts 70, in particular both before coupling to the flat plug connector 10 and during coupling to the flat plug connector 10, can advantageously be provided.

The front wall 61 limits the contact receptacles 56 in particular towards the front in the plugging direction S′ of the complementary flat plug connector 50. The front wall 61 may in particular be formed in one piece with the support walls 63, in particular such that the front wall 61 forms a front portion, in the plugging direction S′, of the support walls 63.

The front wall 61 may have an extension which is shorter, i.e. in particular projects less far (upwards) in the height direction H, than an extension of the contacts 70 arranged between the support walls 63 or in the contact receptacles 56. For example, the front wall 61 may have such an extension that at least or exclusively the bent contact regions 76 of the contacts 70 arranged between the support walls 63 are exposed, i.e. are not delimited by the front support wall 61 along the plugging direction S′. The front wall 61 may in particular have such an extension that at least the bent portions 74 of the contacts 76 are (being) delimited by the front wall 61 along the plugging direction S′, as illustrated by way of example by FIGS. 8b, 10a, 11a, 11b, 12a, 12b, 14a, 14b, 23b and 29.

The front wall 61 may have in particular a chamfer or insertion slope at an upper end in the height direction H and/or at a lower end in the height direction H.

The front wall 61 advantageously allows to protect the contacts 70 both before and during coupling, in particular in the plugging direction S, S′ or in the longitudinal direction L, and to facilitate the coupling. As a result, advantageously both assembly can be facilitated and the service life of the contacts 70 and the flat plug connector system 1 can be improved.

The plug connector housing 51 of the complementary flat plug connector 50 may in particular have a lower wall 52. The lower wall 52 may in particular be formed in one piece with the support walls 63 and/or the front wall 61, in particular such that the front wall 61 forms a front portion, in the plugging direction S′, of the lower wall 52.

The lower wall 52 may in particular form a rest for the contacts 70. In other exemplary embodiments, the contacts 70, in particular with the retaining portion 73, may be guided in grooves which may in particular be arranged in the support walls 63.

The lower wall 52 advantageously allows to protect the contacts 70 both before and during coupling, in particular in the height direction. Furthermore, the lower wall 52 advantageously provides a reliable counterhold for the retaining portions 73 of the contacts 70, in the case of restorable contacting of the contacts 70 by the conductor elements 34, wherein the support portion 78 of the contact 70 is supported against the retaining portion 73. As a result, in turn, a predetermined contact force, and correspondingly reliable electrically conductive contacting, can advantageously be ensured with repeat accuracy.

The plug connector housing 51 of the complementary flat plug connector 50 may in particular have an upper wall 65. The upper wall 65 may in particular be formed in one piece with the support walls 63, the front wall 61 and/or the lower wall. The upper wall 65 may be spaced apart from the lower wall 52 and/or the front wall 61, in particular in the height direction H, to enable insertion and/or reception of a conductor portion 30 of the flat plug connector 10 in the plugging direction S, S′.

An opening of the plug connector housing 51 towards the front in the plugging direction S′, between the upper wall 65 and the front wall 61, or between the upper wall 65 and the support walls 63, in particular substantially in the height direction H, is in particular less than about 2 mm, in particular less than about 1.8 mm, in particular about 1.5 mm.

The contact holder 60 may in particular comprise or consist of the support walls 63, the lower wall 52, and/or the front wall 61. In other words, the contact holder 60 in particular comprises or consists of those portions of the plug connector housing 51 which are directly adjacent to the contacts 70 in the operating state of the complementary plug connector 50, or in still other words are configured to support or hold the contacts 70 in the operating state.

The contact holder 60 is in particular configured to be (completely) received between the lower plug connector housing part 20 and the upper plug connector housing part 40, in particular in a coupled state of the flat plug connector system 1, or to be received in particular when coupling the flat plug connector 10 to the complementary flat plug connector 50.

As a result, an efficient touch protection can advantageously be provided.

The upper wall 65 may have in particular a chamfer or insertion slope at an upper end, in the height direction H, and/or at a lower end, in the height direction H, of the front end, in the plugging direction S′, of the upper wall 65. The upper wall may extend in particular further in the plugging direction S′ or opposite to the longitudinal direction L than the contacts 70 received underneath.

The upper wall 65 advantageously allows to protect the contacts 70 both before and during coupling, in particular in the height direction H.

The plug connector housing 51 of the complementary flat plug connector 50 may in particular comprise one or more side walls 67, in particular a pair of side walls 67 substantially opposite each other in the width direction B. The one or more side walls may in particular be formed in one piece with the upper wall 65, the support walls 63, the front wall 61, and/or the lower wall.

The one or more side walls 67 advantageously allow to protect the contacts 70 both before and during coupling, in particular in the width direction B.

The plug connector housing 51 of the complementary flat plug connector 50 may have openings and receptacles through the walls, in particular open exclusively substantially in the plugging direction S, S′.

At the plug connector housing 51, a coupling portion 54 may in particular be arranged. The coupling portion 54 may in particular be formed in one piece with the plug connector housing 51.

The coupling portion 54 may, without being limited thereto, and as shown by way of example with reference to the figures of the first embodiment of the flat plug connector system 1, be arranged at a front end, in the plugging direction S′, of the upper wall 65, for example. The coupling portion 54 may, for example, extend substantially in the plugging direction S′ or substantially opposite to the longitudinal direction L from the plug connector housing 51, in particular towards the flat plug connector 10 to be coupled. The coupling portion 54 may in particular extend further in the plugging direction S′ or further opposite to the longitudinal direction L than the remaining plug connector housing 51.

As further shown by way of example with reference to the figures of the second embodiment of the flat plug connector system 1, the coupling portion 54, without being limited thereto, may be arranged at the lower wall 52, for example arranged at the lower wall 52 centrally in the longitudinal direction L.

At the plug connector housing 51, a release element 55 may in particular be arranged. The release element 55 may in particular be formed in one piece with the plug connector housing 51.

The release element 55, without being limited thereto, and as shown by way of example with reference to the figures of the first embodiment of the flat plug connector system 1, may be arranged, at a front end, in the plugging direction S′, of the upper wall 65, for example. The release element 55 may, for example, extend substantially in the plugging direction S′ or substantially opposite to the longitudinal direction L from the plug connector housing 51, in particular towards the flat plug connector 10 to be coupled. The release element 55 may extend in particular further in the plugging direction S′ or further opposite to the longitudinal direction L than the remaining plug connector housing 51. In exemplary embodiments, the release element 55 may extend approximately as far from the plug connector housing 51 as the coupling portion 54.

As further shown by way of example with reference to the figures of the second embodiment of the flat plug connector system 1, the release element 55, without being limited thereto, may be arranged at the upper wall 65, for example arranged at the upper wall 65 centrally in the longitudinal direction L.

As shown by way of example with reference to the figures of the first embodiment of the flat plug connector system 1, the plug connector housing 51 of the complementary flat plug connector 50 may be configured to receive all contacts 70 with a substantially constant spacing between the contacts 70 in the width direction B. As a result, a complementary flat plug connector 50 that is not only flat, but in particular narrower in the width direction B can advantageously be provided.

As further shown by way of example with reference to the figures of the second embodiment of the flat plug connector system 1, the plug connector housing 51 of the complementary flat plug connector 50 may be configured to receive two or more groups of contacts 70, wherein the contacts 70 of the respective group have a different spacing from one another in the width direction B than the groups have from one another.

In other words, in exemplary embodiments, the plug connector housing 51 may have a first group of contact receptacles 56, have the coupling portion 54, and have a second group of contact receptacles 56 in succession in the width direction B in this order. In the respective contact receptacles 56, in particular the contacts 70 may be arranged.

In still other words, and as shown by way of example with reference to the figures of the second embodiment of the flat plug connector system 1, the coupling portion 54 of the complementary flat plug connector 50 may in particular be arranged substantially in the width direction B between a first group of contacts 70 or a first group of contact receptacles 56 and a second group of contacts 70 or a second group of contact receptacles 56.

As a result, the complementary flat plug connector 50 and the flat plug connector system 1 may be advantageously configured to be particularly flat. As a result, in turn, the integration of the flat plug connector system 1 in systems with limited installation space, in particular with limited installation space in the height direction H, such as in motor vehicles, for example cars, can advantageously be improved.

In exemplary embodiments, the plug connector housing 51 of the complementary flat plug connector 50 may have one or more fixing portions 58. The one or more fixing portions 58 may, for example, be configured for receiving one or more fixing means 59, in particular be configured for receiving one or more fixing means 59 in a form-fit manner. The one or more fixing portions 58 may be arranged at an outer side of the plug connector housing 51 in the width direction B, in particular arranged at the plug connector housing 51 in pairs substantially opposite one another in the width direction B.

By virtue of the fixing portions 58, the integration of the complementary flat plug connector 50 and the flat plug connector system 1, and furthermore in particular the pre-assembly capability of the complementary flat plug connector 50 can advantageously be improved.

As shown by the figures relating to the first and second embodiments of the flat plug connector system 1, and illustrated in particular by FIGS. 4a, 4b, 5a, 5b, 19a, 19b, 20a and 20b, the flat plug connector 10, which has the conductor portion 30, may in particular be configured in multiple pieces, at least in two pieces. In other words, in particular the plug connector housing 11 of the flat plug connector 10, which has the conductor portion 30, may be configured in multiple pieces, in particular be configured at least in two parts or two pieces. The plug connector housing 11 is thus in particular configured as a two-part plug connector housing 11.

The flat plug connector 10, and in particular the plug connector housing 11 thereof, may in particular comprise or consist of a lower plug connector housing part 20 and an upper plug connector housing part 40.

The lower and upper plug connector housing parts 20, 40 may comprise, at least in sections, a separating line or a separating plane which extends substantially planarly, in particular complementary to the conductor portion 30.

As a result, the conductor portion 30 may advantageously be and/or become arranged between the lower plug connector housing part 20 and the upper plug connector housing part 40. For example, the conductor portion 30 may be and/or become arranged in a sandwich-like manner, at least in sections, between the lower plug connector housing part 20 and the upper plug connector housing part 40.

The flat plug connector 10 may in particular be manufactured by stacking step-by-step. First, the conductor portion 30 may be arranged, or in other words laid, on or in one of the lower plug connector housing part 20 and the upper plug connector housing part 40. Subsequently, the other one of the lower plug connector housing part 20 and the upper plug connector housing part 40 may be arranged or laid on or in the one of the lower plug connector housing part 20 and the upper plug connector housing part 40 at which the conductor portion 30 is arranged. Thereafter, the lower plug connector housing part 20 and the upper plug connector housing part 40 may be fastened relative to each other.

The step-by-step stacking described above may in particular be arranged or laid substantially in parallel to the height direction H. In exemplary embodiments, the step-by-step stacking described above may be arranged or laid in particular substantially in the assembly direction M. The assembly direction M shown in the figures describes, by way of example, the sequence according to which the upper plug connector housing part 40 is arranged, or in other words laid, on or in the lower plug connector housing part 20. It is to be understood that the flat plug connector 10 may also be manufactured by means of an assembly direction which is substantially opposite to the assembly direction M shown in the figures, according to which the lower plug connector housing part 20 is arranged, or in other words laid, on or in the upper plug connector housing part 40.

By arranging or laying substantially in parallel to the height direction H, kinking or deformation of the conductor portion 30 and/or the flexible flat conductor 110, which is connected to the conductor portion 30, can advantageously be avoided.

Conventionally, the conductor portion and/or the flexible flat conductor, which is connected to the conductor portion, is plugged into a plug connector housing, for example in the longitudinal direction, and subsequently fixed to the plug connector housing at fixing portions projecting in the width direction, for example by soldering, welding, screwing or clamping. Although this allows the conductor portion with the flexible flat conductor to be securely assembled to the plug connector housing, a part of the conductor portion and/or a part of the flexible flat conductor usually kinks when inserted, which may lead in particular to damage to the conductor portion and/or the flexible flat conductor, which is not clearly visible and is often only noticeable in a comparatively short service life of the flat plug connector system.

In the present manufacture of the flat plug connector 10, in particular kinking of the conductor portion 30 and the flexible flat conductor 110 can be avoided by arranging or laying them substantially in parallel to the height direction H. As a result, in turn, the service life of the conductor portion 30 and/or the flexible flat conductor 110, as well as the flat plug connector system 1 can advantageously be improved.

The conductor portion 30 may in particular comprise one or more conductor elements 34 and/or comprise a portion supporting the one or more conductor elements 34. The conductor elements 34 are in particular configured to be electrically conductive. The conductor elements 34 may comprise or consist of exposed conductor elements 34 of the flexible flat conductor 110.

The flexible flat conductor 110 may in particular comprise or consist of a ribbon or a flexible printed circuit board.

In preferred embodiments, the spacing of a center of the outermost conductor element 34 in the width direction B to the edge of the conductor portion 30 adjacent in the width direction B may be in the range from about 0.7 mm to about 1.2 mm. In particular, the spacing between a center of the outermost conductor element 34 in the width direction B and the edge of the conductor portion 30 adjacent in the width direction B may be at least about 0.9 mm or at least about 1.0 mm, in particular about 1 mm.

As a result, the conductor portion 30 is advantageously configured to be compatible with both a ribbon and a flexible printed circuit board, and furthermore advantageously enables modular manufacture of the flat plug connector system 1.

The lower plug connector housing part 20 has in particular a main body 23. The main body 23 has a main extension which is substantially parallel to the longitudinal direction L and the width direction B.

As a result, the main body 23 may advantageously be or be brought into contact with the conductor portion 30 and/or with the flat flexible conductor 110 in a planar manner.

As illustrated in particular by FIGS. 4a, 4b, 19a and 19b of the first and second embodiments of the flat plug connector system 1, the main body 23 may extend in particular in steps. The main body 23 may in particular have an upper step in the height direction H and at least one lower step in the height direction H, or, for example, have exclusively the upper step and the lower step.

The upper step in the height direction H has in particular a main extension which is substantially parallel to the longitudinal direction L and the width direction B.

Additionally or alternatively, the at least one or exclusively other lower step in the height direction H may have a main extension which is substantially parallel to the longitudinal direction and the width direction. The upper and lower steps may in particular be substantially parallel to each other.

The upper step, in the height direction H, of the main body 23 may in particular be a step of the main body 23 facing the conductor portion 30 and/or the flexible flat conductor 110. The upper step, in the height direction H, of the main body 23 may provide a rest for the conductor portion 30 and/or the flexible flat conductor 110, in particular in the assembled state of the flat plug connector 10 or already during the manufacture of the flat plug connector 10.

The lower step, in the height direction H, of the main body 23 may in particular be a step of the main body 23 facing away from the conductor portion 30 and/or the flexible flat conductor 110. The lower step, in the height direction H, of the main body 23 may provide a spacing with respect to the conductor portion 30 and/or the flexible flat conductor 110, in particular a spacing substantially in the height direction H, in particular in the assembled state of the flat plug connector 10 or already during the manufacture of the flat plug connector 10.

The lower step in the height direction H may in particular comprise or consist of a lower wall 24 of the lower plug connector housing part 20.

In the assembled state of the flat plug connector 10, the lower wall 24 extends in particular with a spacing in the height direction H with respect to the conductor portion 30 and/or the flexible flat conductor 110.

The lower wall 24 has in particular a main extension which is parallel to the longitudinal direction L and the width direction B. The lower wall 24 may in particular extend, or in other words be arranged, at a lower end, in the height direction H, of the lower plug connector housing part 20.

The lower wall 24 may in particular extend further in the longitudinal direction L or in the plugging direction S than the conductor elements 34 arranged at the flat plug connector 10.

The lower wall 24 advantageously provides protection for the conductor portion 30 and/or the flexible flat conductor 110, in particular in the height direction H.

The lower wall 24 may in particular have a chamfer or insertion slope at a distal end, or in other words at a front end in the plugging direction S of the flat plug connector 10. The chamfer or insertion slope may in particular be formed on an upper side, in the height direction H, of the lower wall 24.

As a result, the lower wall 24 of the lower plug connector housing part 20 can advantageously be simply assembled in the plugging direction S, S′ with the plug connector housing 51 of the complementary flat plug connector 50, and in particular simply adjacent to the lower wall 52 of the complementary flat plug connector 50.

The lower plug connector housing part 20 has in particular one or more fastening means 26 for fastening the lower plug connector housing part 20 to the upper plug connector housing part 40. The upper plug connector housing part 40 may have one or more fastening means 46 for fastening the lower plug connector housing part 20 to the upper plug connector housing part 40, which are in particular complementary to the one or more fastening means 26 of the lower plug connector housing part 20.

As shown by way of example in particular in FIGS. 4a, 4b, 19a and 19b, the fastening means 26 of the lower plug connector housing part 26 has, by way of example, a protrusion, in particular an arm having a protrusion. The fastening means 26 may comprise or consist of a restorable, in particular elastically restorable clip. As shown by way of example in particular in FIGS. 5a, 5b, 20a and 20b, the fastening means 46 of the upper plug connector housing part 40 has or may consist of a fastening receptacle 46. In further exemplary embodiments, the fastening means 46 of the upper plug connector housing part 40 may comprise or consist of a protrusion and in particular a clip, and the fastening means 26 of the lower plug connector housing part 20 may comprise or consist of a receptacle. In still further exemplary embodiments, both the lower and the upper plug connector housing parts 20, 40 may comprise a protrusion and in particular a clip, as well as a receptacle as fastening means.

It is to be understood that in other exemplary embodiments, other fastening means than those shown in the figures may be used, in particular to connect the lower plug connector housing part 20 to the upper plug connector housing part 40. Other exemplary fastening means of the lower plug connector housing part 20 and/or the upper plug connector housing part 40 may comprise, but are not limited to, pins, fitting pins, openings, fitting openings, grooves, groove blocks, fir-tree shaped clips and/or screws.

For example, the lower plug connector housing part 20 may have fastening means 26 substantially opposite each other in the width direction B. The fastening means 26 may in particular each be arranged or formed at an end, in the width direction B, of the lower plug connector housing part 20.

The fastening means 26 may in particular comprise an elastically restorable clip arm which extends substantially in the height direction H. The clip arm may have a protrusion which may in particular protrude substantially in the width direction B from the clip arm. On a side of the clip arm opposite the protrusion, the clip arm may in particular have one or more grooves which may preferably extend substantially along the height direction H. In a cross-section of the clip arm, with a sectional plane which extends substantially in the longitudinal direction and in the width direction, the clip arm may, at least in sections, be formed approximately in a W-shape.

As a result, the clip arm can advantageously be stiffened in the width direction B. Furthermore, by avoiding material accumulations in the cross-section of the clip arm, the clip arm may advantageously be formed precisely, and in particular substantially without distortion, for example by injection molding. The clip arm of the fastening means 26 may in particular be manufactured in one piece with the lower plug connector housing part 20, for example by injection molding.

As a result, assembly of the flat plug connector 10 with repeat accuracy can advantageously be ensured, and in particular assembly of the multi-piece flat plug connector 10 can advantageously be ensured.

In preferred embodiments, the lower plug connector housing part 20 may have a recess 22 adjacent to the fastening means 26. As shown by way of example by FIGS. 4a, 4b, 19a and 19b, the recess 22 may in particular be adjacent to the fastening means 26 from the direction in which the protrusion of the clip arm extends from the clip arm. In other words, as shown by FIGS. 4a, 4b, 19a and 19b, the recess 22 may in particular be adjacent to the fastening means 26 in the direction in which the protrusion of the clip arm extends from the clip arm.

In the figures, the clip arm is shown by way of example with a protrusion extending substantially in parallel to the width direction B inwardly of the plug connector housing part 20, so that the recess 22 is arranged or formed at the plug connector housing part 20 in particular in parallel to the width direction B and inwardly of the plug connector housing part 20.

The recess 22 may have approximately the same extension in the longitudinal direction L as the fastening means 26, or preferably be larger than the extension of the fastening means 26 in the longitudinal direction L.

As a result, the flexibility of the fastening means 26 of the lower plug connector housing part 20 can advantageously be improved. Furthermore, in particular fatigue or damage at a root of the fastening means 26, in other words at a proximal end of the fastening means 26, can advantageously be prevented or reduced, whereby, in turn, the service life of the flat plug connector 10 and the flat plug connector system 1 can advantageously be improved.

The one or more fastening means 26 may in particular be arranged or formed at the upper step, in the height direction H, of the lower plug connector housing 20.

As a result, particularly firm fastening of the lower plug connector housing 20 to the upper plug connector housing 40 can advantageously be provided in a region in which the conductor portion 30 and/or the flat flexible conductor 110 is arranged between the lower and upper plug connector housings 20, 40. Furthermore, this can provide a particularly firm and secure clamping, in particular friction-fit clamping of the conductor portion 30 and/or the flat flexible conductor 110 between the lower and upper plug connector housings 20, 40, whereby, in turn, a good connection security for an electrically conductive connection of the flat plug connector system 1 can advantageously be ensured.

Additionally or alternatively, the one or more fastening means 26, which are arranged or formed in particular at the upper step, in the height direction H, of the lower plug connector housing, may advantageously provide a form-fit substantially opposite to the plugging direction S with a fixing portion 32 of the conductor portion 30 and/or the flat flexible conductor 110.

As a result, secure, in particular loss-proof, fastening of the conductor portion 30 and/or the flat flexible conductor 110 to the lower plug connector housing 20, as well as, for example, between the lower and the upper plug connector housings 20, 40 can further advantageously be provided.

As shown by way of example in FIGS. 4a and 19a, the step of the plug connector housing 11 spaced apart from the conductor portion 30, i.e. the upper plug connector housing part 40 or the lower plug connector housing part 20, and in particular on a side facing the conductor portion 30, may have one or more first stiffening ribs 25.

In particular, the lower plug connector housing part 20 may have one or more first stiffening ribs 25, in particular at the lower wall 24 thereof.

The one or more first stiffening ribs 25 may have a main extension which is substantially parallel to the longitudinal direction L and the height direction H.

The one or more first stiffening ribs 25 may in particular be arranged at an interface, or in other words at a transition, between the upper step, in the height direction H, and the lower step, in the height direction H, of the lower plug connector housing part 20.

The one or more first stiffening ribs 25 may in particular extend on an upper side, in the height direction H, of the lower step or the lower wall 24.

The one or more first stiffening ribs 25 may in particular extend along only a part of the lower wall 24 of the lower plug connector housing part 20. In other words, the one or more first stiffening ribs 25 may extend adjacent to or starting from the upper step in the height direction H, in particular only partially in the longitudinal direction L along the lower wall 24.

By virtue of the first stiffening ribs 25, a material accumulation in the lower plug connector housing part 20 can advantageously be avoided. Furthermore, in particular a stiffener supporting the lower wall 24 may be provided, which improves the protection of the conductor portion 30 and/or the flat flexible conductor 110, in particular from below in the height direction H, while a coupling with the lower wall 52 of the complementary flat plug 50 is not impaired.

Alternatively or additionally, and as shown by way of example in FIGS. 6b and 21b, the lower plug connector housing part 20 may have one or more second stiffening ribs 27. The one or more second stiffening ribs 27 may have a main extension which is substantially parallel to the longitudinal direction L and the height direction H.

The one or more second stiffening ribs 27 may in particular be arranged at an interface, or in other words at a transition, between the upper step, in the height direction H, and the lower step, in the height direction H, of the lower plug connector housing part 20, but in particular substantially opposite the first one or more stiffening ribs 25. The one or more second stiffening ribs 27 may in particular extend on a lower side, in the height direction H, of the upper step.

The one or more second stiffening ribs 27 may in particular extend along the lower side, in the height direction H, of the upper step, in the height direction, of the lower plug connector housing part 20. In particular, the one or more second stiffening ribs 27 may extend substantially completely in the longitudinal direction L along the upper step in the height direction.

By virtue of the second stiffening ribs 27, a material accumulation in the lower plug connector housing part 20 can advantageously be prevented. Furthermore, in particular a stiffener supporting the lower wall 24 and the upper step in the height direction H may be provided, which improves the protection of the conductor portion 30 and/or the flat flexible conductor 110, in particular from below in the height direction H.

As illustrated by a comparison of FIG. 4a relating to the first embodiment of the flat plug connector system 1 with FIG. 19a relating to the second embodiment of the flat plug connector system 1, the lower plug connector housing 20 may be configured differently depending on the embodiment.

As shown by way of example with reference to the figures of the first embodiment of the flat plug connector system 1, the lower plug connector housing 20 may in particular be configured with a substantially continuous upper step in the height direction H.

As a result, simple assembly with the conductor portion 30 and/or the flat flexible conductor 110 is advantageously enabled, and in particular a rest that supports in a planar manner for the conductor portion 30 and/or the flat flexible conductor 110 is provided.

As shown by way of example with reference to the figures of the second embodiment of the flat plug connector system 1, the lower plug connector housing 20 may in particular be configured with an upper step that is substantially discontinuous in the height direction H. For example, the upper step in the height direction H may have at least a first portion and a second portion which are interrupted, at least in sections, along the extension of the lower plug connector housing 20 along the width direction B. For example, the first and second portions of the upper step in the height direction H may be interrupted, at least in sections, by a lower step in the height direction H. The lower step in the height direction H may in particular be the lower step which is (approximately) at a level in the height direction H with the lower wall 24 of the lower plug connector housing part 20.

In other words, the upper step, in the height direction H, of the lower plug connector housing part 20, along the extension of the plug connector housing part 20 in the width direction B, may in particular comprise an interruption in the height direction H. The interruption in the height direction H may in particular comprise a level lower in the height direction than the upper step in the height direction H. The interruption in the height direction H may in particular be arranged or formed centrally in the width direction B at the upper step in the height direction H.

As further shown with reference to the figures of the second embodiment of the flat plug connector system 1, the lower plug connector housing 20 may in particular be formed with a lower step interrupted at least in sections or a lower wall 24 interrupted at least in sections in the height direction H. For example, the lower wall 24 may have at least a first portion and a second portion which are interrupted, at least in sections, along the extension of the lower plug connector housing 20 along the width direction B. For example, the first and second portions of the lower wall 24 may be interrupted at least in sections, for example by an opening. The opening or interruption of the lower wall 24 may be arranged or formed in particular at a front end, in the plugging direction S of the flat plug connector 10, of the lower plug connector housing 20. The opening or interruption of the lower wall 24 may in particular be arranged or formed at the lower wall 24 centrally in the width direction B.

The lower plug connector housing part 20, as shown by way of example with reference to the figures of the second embodiment of the flat plug connector system 1, and as illustrated in particular by FIGS. 19a, 24a, 24b and 25a, advantageously allows to receive the coupling portion 14, which is arranged or formed at the upper plug connector housing part 40, at least in sections by the upper step in the height direction H formed in sections in the width direction B, and/or by the lower wall 24 formed in sections.

The lower plug connector housing part 20 may in particular be formed in one piece.

As a result, it is advantageously made possible to provide a particularly flat and (installation) space-saving flat plug connector system 1 which is in particular dimensionally stable and manufacturable with repeat accuracy and is in particular suitable for use in motor vehicles, such as cars, for example.

The upper plug connector housing part 40 of the flat plug connector 10, as shown in particular in FIGS. 5a, 5b, 20a and 20b, has in particular a coupling portion 14 which is configured for coupling to a complementary coupling portion 54 of the complementary flat plug connector 50 of the plug connector system 1, as shown in the other figures.

The form-fit of the coupling portion 14 with the complementary coupling portion 54, that is in principle in particular configured to be detachable, may be configured as a form-fit that is non-detachable, in particular not detachable in a non-destructive manner, in particular by a securing position of the securing element 5.

Furthermore, the form-fit of the coupling portion 14 with the complementary coupling portion 54, which is in principle in particular configured to be detachable, may be configured as a form-fit that is detachable, in particular detachable in a non-destructive manner, in particular by a non-securing position of the securing element 5.

One of the coupling portion 14 and the complementary coupling portion 54 may be configured to be substantially rigid with respect to the coupling part. The other one of the coupling portion 14 and the complementary coupling portion 54 may be configured to be substantially restorable, in particular elastically restorable, with respect to the part complementary to the coupling part. In other words, the coupling portion 14 and the complementary coupling portion 54 may in particular be configured such that substantially only one of the coupling portion 14 and the complementary coupling portion 54 is deformed or is being deformed in a restorable manner during coupling.

At least one of the coupling portion 14 and the complementary coupling portion 54 may have one or more rear-engageable portions 8. Furthermore, at least one of the coupling portion 14 and the complementary coupling portion 54 may have one or more restorably rear-engaging elements 7, in particular one or more elastically restorably rear-engaging elements 7. A restorably rear-engaging element 7 of the one or more restorably rear-engaging elements 7 is in particular complementary to one or more of the one or more rear-engageable portions 8. For example, a restorably rear-engaging element 7 and a complementary rear-engageable portion 8 each have a protrusion to form a form-fit, in particular in the plugging direction S, S′, in the coupled state of the flat plug connector system 1.

As shown by way of example by the figures of the first embodiment of the flat plug connector system 1, the flat plug connector 10 may, for example, have one or more substantially rigid rear-engageable portions 8, and the complementary flat plug connector 50 may correspondingly have one or more substantially elastically restorable rear-engaging elements 7 which are couplable to the rear-engageable portion(s) 8.

As shown by way of example by the figures of the second embodiment of the flat plug connector system 1, the flat plug connector 10 may, for example, have one or more substantially elastically restorable rear-engaging elements 7, and the complementary flat plug connector 50 may correspondingly have one or more substantially rigid rear-engageable portions 8 which are couplable to the restorably rear-engaging element(s) 7.

This advantageously allows to ensure an assembly operation with repeat accuracy.

At least one of the flat plug connector 10 and the complementary flat plug connector 50 may have a receptacle 12 for the securing element 5, for securing the coupled state of the flat plug connector system 1.

As shown by way of example by the figures of the first and second embodiments of the flat plug connector system 1, the receptacle 12 for the securing element 5 may be arranged in particular in the region of the coupling portion 14 or at the coupling portion 14.

The receptacle 12 is formed in particular by a region of the upper plug connector housing 40, and in particular by a region of the coupling portion 14. The receptacle 12 has in particular a guide for moving the securing element 5 between a non-securing position and a securing position. The guide for movement may in particular be a translational guide, i.e. a guide which substantially only allows a translational movement of the securing element 5 between the securing position and the non-securing position. For this purpose, the guide may, for example, form a form-fit transverse to the translational movement direction of the securing element 5.

The receptacle 12 may in particular be formed in one piece with the upper plug connector housing part 40.

The receptacle 12 has in particular one or more latches 45 which, in a non-coupled state of the flat plug connector system 1, i.e. in a state in which the coupling portion 14 and the complementary coupling portion 54 are not coupled to each other, may engage with one or more latch protrusions 82 of the securing element 5, in particular may engage in a form-fit manner.

The receptacle 12 may be configured to be rigid. The receptacle 12 may in particular be configured to be rigid such that the receptacle 12:
when arranging the securing element 5 at the receptacle 12,
when coupling the flat plug connector 10 to the complementary flat plug connector 50, in particular in a state in which the securing element 5 is arranged at the receptacle 12, and/or
when transferring the securing element 5 to the securing state, i.e. when the flat plug connector 10 and the complementary flat plug connector 50 are in particular already coupled to each other, does not deform.

As a result, the flat plug connector 10 and the complementary flat plug connector 50 may advantageously be configured to be rigid and durable, while the securing element 5, for example, may be configured as an easily replaceable element.

The one or more latches 45 may in particular be configured as openings or abutments which extend substantially in the width direction B and/or in the height direction H. The one or more latches 45 may thereby correspondingly provide an engagement or abutment for one or more latch protrusions 82 of the securing element 5, which in particular correspondingly extend substantially in the width direction B and/or in the height direction H.

In the coupled state of the flat plug connector system 1, i.e. in a state in which the coupling portion 14 and the complementary coupling portion 54 are coupled to each other, in particular are coupled to each other in a form-fit manner, one or more of the release elements 55 is configured to extend towards the one or more latch 45 such that the one or more latch protrusions 82 do not engage with the one or more latches 45.

A release element 55 of the one or more release elements 55 is in particular arranged or formed at that one of the coupling portion 14 and the complementary coupling portion 54 which does not have the receptacle 12.

The one or more release elements 55 may, for example, extend towards the one or more latches 45 such that an entry of the one or more latch protrusions 82 into the one or more latches 45 is blocked, and/or such that an engagement of the one or more latch protrusions 82 with the one or more latches 45 is detached.

Additionally or alternatively, the one or more release elements 55 may extend towards the one or more latches 45 such that the securing element 5, which is retained in the non-securing position, is (being) restorably deformed. In particular, a portion of the securing element 5 at which one or more of the latch protrusions 82 is arranged may be or become deformed restorably, in particular elastically restorably.

In exemplary embodiments, the one or more release elements 55 may be configured, in the coupled state, to be arranged between a portion of the receptacle 12 and a portion of the prong 86 in a manner elastically restorably deforming a prong 86 of the securing element 5.

In the coupled state of the flat plug connector system 1, in particular by means of the arrangement of the one or more release elements 55 in the coupled state, the securing element 5 is configured to be transferable from a non-securing position into a securing position. In particular, in the coupled state and by means of the arrangement of the one or more release elements 55, the securing element 5 is configured to be transferable between a non-securing position and the securing position of the securing element 5, in particular to be reversibly transferable in a non-destructive manner between a non-securing position and the securing position of the securing element 5. In other words, in the coupled state, the securing element 5 is in particular no longer retained in the non-securing position.

By virtue of the complementary configuration of the securing element 5 and the coupling portions 14, 54 of the flat plug connector 10 and the complementary flat plug connector 50, it can advantageously be ensured that the securing element 5 is retained in the non-securing position in the decoupled state and is transferable into the securing position only in the coupled state.

The receptacle 12 may have one or more counterhold abutments 48. A counterhold abutment 48 of the one or more counterhold abutments 48 is in particular configured to engage with a counterhold 88 of one or more counterholds 88 of the securing element 5. As illustrated in particular by FIG. 5a, the counterhold abutments 48 may be formed, for example, as webs or pillars of the receptacle 12, which extend, for example, at least in sections substantially in the height direction H. As illustrated in particular by FIG. 20a, the counterhold abutments 48 may be configured, for example, as protrusions of the receptacle 12, which extend, for example, at least in sections substantially in the width direction B. The one or more counterhold abutments 48 may, for example, have a face or a setback against or into which one or counterholds 88 of the securing element 5 may abut or engage. The face may, for example, extend substantially in parallel to the height direction H and/or in the width direction. The setback may in particular be a setback substantially in the height direction H or in the width direction B.

A counterhold 88 of the one or more counterholds 88 of the securing element 5 may in particular be configured as a protrusion which protrudes substantially in the height direction H and/or in the width direction B from the securing element 5. The counterhold 88 may in particular protrude in a direction which does not correspond to the direction in which the one or more latch protrusions 45 protrude.

A counterhold abutment 48 of the one or more counterhold abutments 48 may form a form-fit, for example a stop or an engagement, with one or more of the one or more counterholds 88, which prevents the securing element 5 from being detached from the receptacle 12, in particular substantially opposite to the plugging direction S. The counterhold abutments 48 may, for example, be configured as webs or pillars of the receptacle 12.

The one or more counterhold abutments 48 in cooperation with the one or more counterholds 88, together with the one or more latch 45 in cooperation with the one or more latch protrusions 82, may advantageously ensure the retention of the securing element 5 to the receptacle in the non-securing position. As a result, the securing element 5 can advantageously be pre-assembled to the receptacle 12, and the assembly of the flat plug connector system 1 can be simplified.

The receptacle 12 may advantageously provide a form-fit receptacle for the securing element 5, to which the securing element 5 is retained in a form-fit manner, in particular in a form-fit manner in the decoupled state of the flat plug connector system 1. The securing element 5 may in particular be received and retained in the receptacle 12 in a form-fit manner at least in sections, in particular in the non-securing position.

The upper plug connector housing part 40 has in particular fastening receptacles 46 complementary to the fastening means 26 of the lower plug connector housing part 20. As illustrated by way of example in FIGS. 5a, 5b, 20a and 20b, the fastening receptacles 46 may in particular be configured as a groove or recess at the upper plug connector housing part 40, for example as a groove or recess having a setback. The fastening receptacles 46 may in particular be arranged substantially opposite one another in the width direction B at the upper plug connector housing part 40. The fastening receptacles 46 may in particular be arranged or formed at ends of the upper plug connector housing part 40 substantially opposite one another in the width direction B.

The fastening receptacles 46 may in particular be arranged or formed at a rear portion, in the plugging direction S, of the upper plug connector housing part 40.

As a result, fastening of the lower plug connector housing part 20 to the upper plug connector housing part 40 can advantageously be provided, which does not impair the coupling of the flat plug connector 10 to the complementary flat plug connector 50, and in particular does not detach, in particular does not detach in a non-destructive manner, even upon applying a load directed in or opposite to the plugging direction S.

The fastening receptacles 46, in particular in cooperation with the fastening means 26, which may also be arranged or formed at the respective other one of the lower and upper plug connector housing parts 20, 40, enable an advantageously secure, simple and protective sandwich-like reception of the conductor portion 30 and/or the flexible flat conductor 110 between the lower and upper plug connector housing parts 20, 40. In particular, clamping can be advantageously improved in a region in which the lower plug connector housing part 20, the conductor portion 30 and/or the flexible flat conductor 110, as well as the upper plug connector housing part 40, are directly adjacent to one another in the assembled state of the flat plug connector 10. Here, the aforementioned elements may in particular be adjacent to one another in the following order in a sandwich-like manner: lower plug connector housing part 20, conductor portion 30 and/or flexible flat conductor 110, and upper plug connector housing part 40.

The conductor portion 30 and/or the flexible flat conductor 110 may be received at least in a form-fit manner between the lower and upper plug connector housing parts 20, 40, in particular such that the conductor portion 30 and/or the flexible flat conductor 110 are prevented from being pulled out substantially in and/or opposite to the longitudinal direction or substantially in and/or opposite to the plugging direction S of the flat plug connector 10.

Alternatively or additionally, the conductor portion 30 and/or the flexible flat conductor 110 may be connected to the lower and/or the upper plug connector housing part 20, 40 in a material-fit manner, for example by means of an adhesive.

Further alternatively or additionally, the conductor portion 30 and/or the flexible flat conductor 110 may be connected to the lower and/or the upper plug connector housing part 20, 40 in a friction-fit manner, for example by clamping the conductor portion 30 and/or the flexible flat conductor 110 between the lower plug connector housing part 20 and the upper plug connector housing part 40.

In exemplary embodiments, the fastening means 26 may provide a fastening biased in the height direction H with the fastening receptacles 46.

As a result, a particularly friction-fit connection of the conductor portion 30 and/or the flexible flat conductor 110 with the lower and upper plug connector housing parts 20, 40 can advantageously be improved.

Or the setback of the counterhold abutment 48 may The engagement between as are configured in particular with The counterholds and/or the counterhold abutments 48 may be configured, for example, as webs or pillars of the receptacle 12.

As illustrated in particular by FIGS. 4a to 6b and 19a to 21b, the upper plug connector housing part 40 may have a side wall 42, in particular an angled side wall 42, in particular at opposite ends in the width direction B, respectively. The respective side wall 42 is in particular configured so as to provide protection for the conductor portion 30 and/or the flexible flat conductor 110 towards the outside in the width direction B. The respective angled side wall 42 is in particular angled so as to be angled inwardly in the width direction B at a front end, in the longitudinal direction L or in the plugging direction S, of the side wall 42.

The side wall 42 may in particular extend downwards substantially along the height direction H from an upper wall 44 of the plug connector housing 11. The side wall 42 may in particular be configured to delimit the lower plug connector housing part 20, at least in sections, outwardly in the width direction B.

The side wall 42 advantageously improves protection of the conductor portion 30 and/or the flexible flat conductor 110 in the width direction B. Furthermore, the side wall 42 advantageously allows, in particular by means of the angled portion, to improve a form-fit reception of the conductor portion 30 and/or the flexible flat conductor 110 at the plug connector housing 11, as well as to protect the conductor portion 30 and/or the flexible flat conductor 110 in the plugging direction S or in the longitudinal direction L from the front. Furthermore, the side wall 42, in particular by virtue of the angled portion, allows to facilitate assembly with the lower plug connector housing part 20, for example by the side wall 42 providing a guide for laying the upper plug connector housing part 40 onto the lower plug connector housing part 20, and vice versa.

The upper plug connector housing 40 may in particular have one or more guide elements 43, in particular one or more elastically restorable guide elements 43.

The plug connector housing 40 may in particular have at least one guide element 43 at opposite ends in the width direction B, respectively.

A guide element 43 of the one or more guide elements 43 may in particular have a main extension substantially in the longitudinal direction L or in the plugging direction S. A guide element 43 of the one or more guide elements 43 may in particular have a protrusion at a front end in the longitudinal direction L or in the plugging direction S, which in particular protrudes substantially perpendicular to the longitudinal direction L or the plugging direction S.

The one or more guide elements 43 are in particular configured to touch the complementary flat plug connector 50 when coupling the flat plug connector 10 to the complementary flat plug connector 50, in particular under an elastically restorable deformation of the one or more guide elements 43.

The complementary flat plug connector 50 or the plug connector housing 51 of the complementary flat plug connector 50 may, for example, each have an abutment, in particular an abutment groove and/or a guide receptacle 53 for at least one of the one or more guide elements 43. The abutment, in particular the abutment groove and/or guide receptacle 53 of the complementary flat plug connector 50 may in particular be arranged or formed outside the contact receptacles 56 in the width direction B.

As shown by way of example in FIGS. 7b, 22a and 25b, the abutment or the abutment groove and/or the guide receptacle 53 may in particular have a protrusion and/or setback with which a guide element 43 of the one or more guide elements 43 can engage, in particular engage in a form-fit manner.

The one or more abutment or abutment groove and/or guide receptacle 53 of the plug connector housing 51 of the complementary flat plug connector 50, together with the one or more guide elements 43, may in particular form a first biasing contact of the flat plug connector 10 with the complementary flat plug connector 50 when plugging or coupling along the plugging direction S, S′. This first biasing contact of course refers to a mutually complementary orientation of the flat plug connector 10 relative to the complementary flat plug connector 50, in which the flat plug connector 10 and the complementary flat plug connector 50 are pluggable or couplable to provide an electrically conductive connection, in the sense of a usual state of use of a flat plug connector system 1.

The one or more guide elements 43 may in particular each be arranged or formed at a front end, in the longitudinal direction L or in the plugging direction S, of the side wall 42.

The guide elements 43 thus advantageously simplify the assembly of the flat plug connector system 1. Furthermore, the guide elements 43 in particular integrally additionally allow to provide protection of the conductor portion 30 and/or the flexible flat conductor 110 in the width direction B, in particular on both sides in the width direction B.

As illustrated by way of example in particular by FIGS. 5b and 20b, the upper plug connector housing part 40 may have one or more collars 49, in particular at an underside of the upper wall 44 in the height direction H. The collar 49 of the one or more collars 49 protrudes substantially downwardly along the height direction H, in particular at an underside of the upper wall 44. A collar 49 of the one or more collars 49 may in particular be arranged or formed at a position corresponding to the fastening receptacle 46. In other words, the collar 49 may in particular provide or form an extension of the fastening receptacle 46 along the height direction H, beyond an underside of the upper wall 44.

In exemplary embodiments, the protrusion or extension beyond the underside of the upper wall 44 formed by the collar 49 may be smaller than a thickness of the conductor portion 30 and/or the flexible flat conductor 110 in the height direction H. As a result, a predetermined clamping force connecting the conductor portion 30 and/or the flexible flat conductor 110 to the plug connector housing 11 in a friction-fit manner can advantageously be ensured.

In other exemplary embodiments, the collar 49 may form a protrusion or extension beyond the underside of the upper wall 44, which substantially corresponds to the thickness of the conductor portion 30 and/or the flexible flat conductor 110, or which is greater than a thickness of the conductor portion 30 and/or the flexible flat conductor 110. As a result, a clamping force that may deform or damage the conductors of the conductor portion 30 and/or the flexible flat conductor 110 can advantageously be avoided. Furthermore, a defined stop between the lower and upper plug connector housing parts 20, 40 can advantageously be ensured. This, in turn, allows to ensure a predetermined overall height of the flat plug connector 10, for example for coupling to the complementary flat plug connector 50.

The collar 49 is in particular configured to provide an edge of the fixing portion 32 of the conductor portion 30 and/or the flexible flat conductor 110, in particular opposite to the plugging direction S or opposite to the longitudinal direction L.

The collar 49 therefore advantageously enables, in particular together with the side wall 42, a form-fit arrangement or reception of the conductor portion 30 and/or the flexible flat conductor 110, in particular of the fixing portion 32, in particular both in the plugging direction S or in the longitudinal direction L, and opposite to the plugging direction S or the longitudinal direction L.

The collar 49 therefore advantageously improves the assembly capability of the flat plug connector 10, for example by facilitating laying of the upper plug connector housing part 40 onto the conductor portion 30 and/or the flexible flat conductor or vice versa. In order to lay the upper plug connector housing part 40 onto the conductor portion 30 and/or the flexible flat conductor 110, or vice versa, the conductor portion 30 and/or the flexible flat conductor 110 may already be laid onto or into the lower plug connector housing part 20. In further exemplary embodiments, however, the conductor portion 30 and/or the flexible flat conductor 110 may also be laid first onto or into the upper plug connector housing part 40, and then, in particular immediately thereafter, the lower plug connector housing part 20 may be laid onto or into the upper plug connector housing part 40 to fix the conductor portion 30 and/or the flexible flat conductor 110 in a sandwich-like manner.

As illustrated in particular by FIGS. 5a, 5b, 20a and 20b, the upper wall 44 may be contoured on the upper side thereof in the height direction H, for example be configured to be step-shaped at least in sections, and/or be substantially planar on the underside thereof in the height direction H, in particular aside from the ends in the width direction B.

As a result, on the one hand, good protection and good abutment of the conductor portion 30 and/or the flexible flat conductor 110 from above in the height direction H can advantageously be provided, and on the other hand, a stiffness of the upper plug connector housing part 40 can be improved.

As shown in particular by FIGS. 5a and 5b, in the first embodiment of the flat plug connector system 1, the upper wall 44 may in particular be formed continuously, without a separation of the abutment surface for the conductor portion 30 and/or the flexible flat conductor 110 in the width direction B. As a result, a flat plug connector system 1 with a comparatively small overall width in the width direction B can advantageously be provided, which also enables simple assembly of the conductor portion 30 and/or the flexible flat conductor 110.

As shown in contrast, in particular by FIGS. 20a and 20b, in the second embodiment of the flat plug connector system 1, the upper wall 44 may be formed in particular in sections, with at least one separation of the abutment surfaces for the conductor portion 30 and/or the flexible flat conductor 110 in the width direction B. As a result, a coupling portion 14 can advantageously be provided in the region of the separation of the abutment surfaces for the conductor portion 30 and/or the flexible flat conductor 110, whereby a flat plug connector system 1 with a particularly low overall height in the height direction H can be provided.

The upper wall 44 and the lower wall 24 of the plug connector housing 11 of the flat plug connector 10 advantageously provide protection for the conductor portion 30 and/or the flexible flat conductor 110 in the height direction H. An opening, formed at a front side in the plugging direction S, between the upper wall 44 and the lower wall 24 may in particular have a height of less than about 5 mm, in particular in the range from about 2.5 mm to about 4.5 mm, for example of about 4 mm.

As a result, efficient touch protection for the conductor portion 30 and the conductor elements 34 thereof can advantageously be provided.

The upper plug connector housing part 40 may in particular be formed in one piece. The plug connector housing 11 of the flat plug connector 10 may be formed in multiple pieces, in particular in two pieces, i.e. from the lower plug connector housing part 20 and the upper plug connector housing part 40. As a result, simple manufacture and assembly of the plug connector housing 11 can advantageously be ensured.

As soon as the conductor portion 30 and/or the flexible flat conductor 110 is placed or inserted on or in the lower plug connector housing part 20 or on the upper plug connector housing part 40, the conductor portion 30 and/or the flexible flat conductor 110 is advantageously supported by the respective one of the lower or upper plug connector housing part 20, 40 abutting, and protected at least on one side in the height direction H. Furthermore, this advantageously further enables assembly with the lower or upper plug connector housing part 20, 40 not yet abutting.

As soon as the conductor portion 30 and/or the flexible flat conductor 110 is arranged or inserted, at least in sections, between the lower and upper plug connector housing parts 20, 40, the conductor portion 30 and/or the flexible flat conductor 110 can advantageously be supported and protected at least on both sides in the height direction H.

If the lower and upper plug connector housing parts 20, 40 are fastened to each other and in particular the conductor portion 30 and/or the flexible flat conductor 110 is arranged therebetween, the flat plug connector 10 is in particular in an assembled state.

In the assembled state of the flat plug connector 10, the conductor portion 30 and/or the flexible flat conductor 110 abuts against a lower side, in the height direction H, of the upper wall 44, in particular in a flush manner.

Additionally or alternatively, in the assembled state of the flat plug connector 10, the conductor portion 30 and/or the flexible flat conductor 110 abuts against the main body 23 of the lower plug connector housing part 20, in particular against an upper side, in the height direction H, of the upper step of the plug connector housing part 20, in particular in a flush manner.

Further additionally or alternatively, in the assembled state of the flat plug connector 10, the conductor portion 30 and/or the flexible flat conductor 110 is in particular spaced apart from the lower wall 24 of the plug connector housing 11 of the flat plug connector 10, in particular spaced apart substantially in the height direction H.

By arranging the conductor portion 30 and/or the flexible flat conductor 110 at the flat plug connector 10 as described herein, the conductor portion 30 and/or the flexible flat conductor 110 can advantageously be protected at least on both sides in the height direction H. Furthermore, in particular the conductor portion 30 and the conductor elements 34 thereof can be supported upon contacting with the contacts 70 of the complementary flat plug connector 50, wherein the contacts 70 are in particular elastically restorably deformed at least in sections, in particular elastically restorably deformed substantially in the height direction H.

In FIGS. 2b and 15a and FIGS. 17b, 30a and 30b, an exemplary securing element 5 is shown, respectively. The securing element 5 shown as an example in FIGS. 2b and 15a is configured in particular for the first embodiment of the plug connector system 1. The securing element 5 shown as an example in FIGS. 17b, 30a and 30b is configured in particular for the second embodiment of the plug connector system 1.

As illustrated in particular by FIGS. 2b, 15a, 17b, 30a and 30b, as well as the other figures in which the securing element 5 is shown at least in sections, the securing element 5 may in particular have one or more latch protrusions 82 which are configured to engage with or abut against one or more latches 45 of the flat plug connector 10 at which the receptacle 12 is formed. As a result, the securing element 5 can be retained to the receptacle 12, in particular in the non-securing position. In particular, the securing element 5 can be retained to the receptacle 12 substantially in the plugging direction S or in the longitudinal direction L when the flat plug connector system 1 is in the non-coupled or decoupled state.

Additionally or alternatively, the securing element 5 may in particular have one or more counterholds 88 which are configured to engage with or abut against one or more counterhold abutments 48 of the flat plug connector 10 at which the receptacle 12 is formed. As a result, the securing element 5 can be retained to the receptacle, in particular in the non-securing position. In particular, the securing element 5 can be retained to the receptacle 12 substantially opposite to the plugging direction S or the longitudinal direction L, in particular regardless of whether the flat plug connector system 1 is in the coupled or non-coupled state.

The latch protrusion(s) 82 and/or the counterhold(s) 88 may each be configured in particular as a protrusion, in particular as a protrusion which protrudes from a prong 86 of the securing element 5 extending substantially in the plugging direction S or in the longitudinal direction L.

A latch protrusion 82 of the one or more latch protrusions 82 may in particular protrude in a different direction than a counterhold 88 of the one or more counterholds 88. The one or more latch protrusions 82 may, for example, protrude substantially in the height direction H. The one or more counterholds 88 may protrude substantially in the width direction B, for example.

In alternative embodiments, the latch protrusions 82 may protrude substantially in the width direction B, for example, and/or the counterholds 88 may protrude substantially in the height direction H, for example.

By virtue of the latch protrusions 82 and counterholds 88, that in particular extend in different ways, the securing element 5 is advantageously retainable to the receptacle 12, in particular retainable on both sides along the plugging direction S or the longitudinal direction L. In addition, the respective retentions in a predetermined direction, which secure the securing element 5 in each case with a predetermined retention force, can advantageously be defined independently of one another.

The securing element 5 has in particular multiple prongs 85, 86, wherein each of the prongs 85, 86 may in particular have a main extension substantially in the plugging direction S or in the longitudinal direction L. The prongs 85, 86 each extend from the same main body of the securing element 5, and may accordingly be formed in particular in one piece with the other prongs 85, 86. The prongs 85, 86 are separated from one another, in particular substantially in the width direction B, or in other words are spaced apart substantially in the width direction B.

As a result, the securing element 5 advantageously ensures a functional separation of the prongs 85, 86 from one another, which in turn advantageously prevents undesirable fatigue and/or damage to the securing element 5 and the prongs 85, 86 thereof. As a result, a reversible transfer, in particular with repeat accuracy, of the securing element 5 to the various positions and states, such as, in particular, the securing position and non-securing position, can furthermore advantageously be ensured.

Between a first prong 86 of the securing element 5 and a second prong 86 of the securing element 5, at each of which in particular a latch protrusion 45 and a counterhold 88 may be arranged or formed, in particular a securing prong 85 may be arranged or formed.

The securing prong 85 has in particular a protrusion 87 which can engage with a securing protrusion 47, 57 of the flat plug connector 10 or the complementary flat plug connector 50. The protrusion 87 of the securing prong 85 may, without being limited thereto, in particular protrude substantially in the height direction H from the securing prong 85.

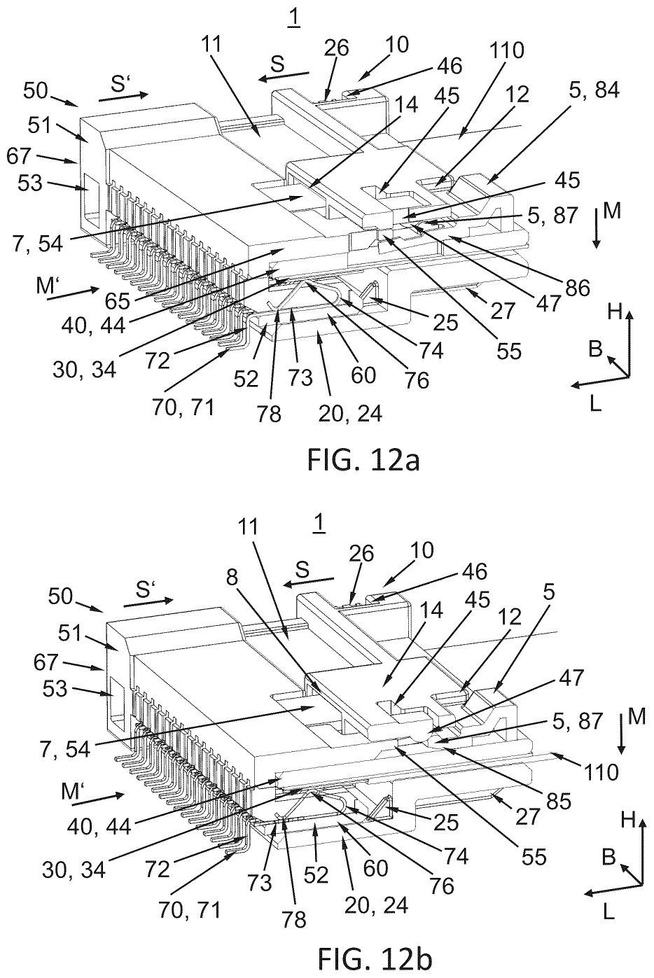

As illustrated by way of example by FIGS. 12b, 14b, 26a and 27b, the protrusion 87, in cooperation with the securing protrusion 47, 57, may in particular define a securing force for transferring the securing element 5 from the non-securing position into the securing position and/or a detaching force for transferring the securing element 5 from the securing position into the non-securing position.

The protrusion 87 of the securing prong 85 of the securing element 5 may in particular be formed along the plugging direction S or along the longitudinal direction L with a section-wise contour, in particular with a sectionally different contour facing the complementary securing protrusion 47, 57.

As illustrated by way of example in particular by FIGS. 15a, 30a and 30b, the protrusion 87 may, without being limited thereto, be formed in particular in an arcuate or semi-circular shape, wherein the arcuate shape or semi-circular shape extends at least partially constantly in the width direction B along the securing prong 85. In alternative embodiments, the protrusion 87 may be spherically shaped, for example, or shaped with a section-wise ramp shape or chamfer, for example.

The section-wise contour of the protrusion 87, in cooperation with the securing protrusion 47, 57, advantageously allows to define a securing force and a detaching force which are independent of one another.

If the protrusion 87, as shown by way of example in particular in FIGS. 15a, 30a and 30b, has a first contour portion with increasing extension in the height direction H, opposite to the plugging direction S or opposite to the longitudinal direction L, a transfer into the securing position can advantageously be defined with an increasing securing force and with a maximum securing force. As a result, an unintentional transfer of the securing element 5 into the securing position can furthermore advantageously be impeded or prevented.

If the protrusion 87, as shown by way of example in particular in FIGS. 15a, 30a and 30b, has a second contour portion with decreasing extension in the height direction H, in particular following the first contour portion opposite to the plugging direction S or opposite to the longitudinal direction L, a transfer into the securing position can advantageously be defined with a decreasing securing force from the point at which the maximum securing force is exceeded. The decreasing securing force may, for example, also be a securing force which is less than zero, so that the securing element 5 passively comes into the securing position after overcoming the maximum securing force.

By virtue of the securing operation described herein, in particular with a section-wise contour of the protrusion 87, haptic feedback when transferring the securing element 5 into the securing position and into the non-securing position can advantageously be improved.

Alternatively or additionally, the securing protrusion 47, 57 of the flat plug connector 10 or the complementary flat plug connector 50, as shown by way of example in FIGS. 12a, 12b, 14a, 14b, 23a, 24a, 26a and 27b, may have a first contour portion which has an increasing extension along the height direction H in the plugging direction S or in the longitudinal direction L.

Further alternatively or additionally, the securing protrusion 47, 57 of the flat plug connector 10 or the complementary flat plug connector 50, as shown by way of example in FIGS. 12a, 12b, 14a, 14b, 23a, 24a, 26a and 27b, may have a second contour portion which has a decreasing extension along the height direction H in the plugging direction S or in the longitudinal direction L, in particular following the first contour portion.

The first contour portion of the securing protrusion 47, 57 advantageously allows to apply a predetermined, in particular elastically restorable deformation to the securing element 5, in particular the elastically restorable securing prong 85 of the securing element 5. The second contour portion of the securing protrusion 47, 57 advantageously allows to reduce the restorable deformation in a predetermined manner, in particular such that the securing element 5 passively reaches the securing position, substantially in the plugging direction S, without further application of a force to the securing element 5.

As a result, haptic and/or visual feedback when transferring the securing element 5 into the securing position and/or back into the non-securing position can be improved.

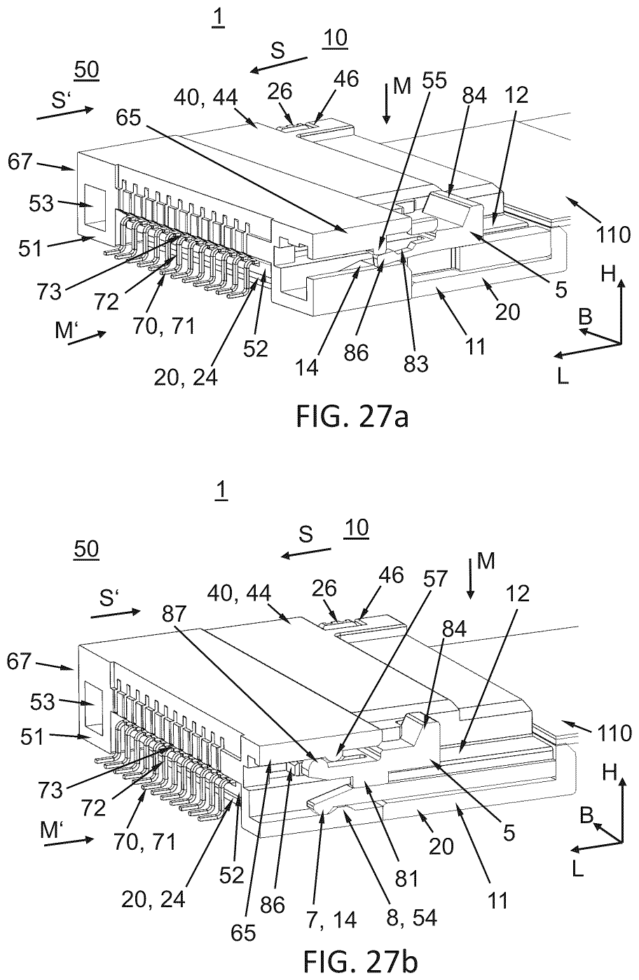

As illustrated in particular by FIG. 27b, in the second embodiment of the flat plug connector system 1, wherein the securing protrusion 57 is arranged or formed at the complementary flat plug connector 50, an increasing bias may advantageously be applied to the securing element 5 during a detaching relative movement of the flat plug connector 10 and the complementary flat plug connector 50, in particular opposite to the plugging direction S, S′. By virtue of the abutment against the restorably rear-engaging element 7, the securing element 5 is configured to hold the restorably rear-engaging element with a correspondingly increasing bias in the engagement at the rear-engageable portion 8.

As a result, an increasing force directed against detachment from the secured state can advantageously be passively provided, which in turn advantageously ensures a high connection security.

The securing element 5 may in particular have an actuating portion 84 at a rear end in the longitudinal direction L or in the plugging direction S. The actuating portion 84 may in particular be configured as a rear protrusion in the longitudinal direction L or in the plugging direction S, which protrudes substantially in the height direction H. The actuating portion 84 may in particular have a chamfer on a front side in the longitudinal direction L or in the plugging direction S, and/or in particular have a flat stop on a rear side in the longitudinal direction L or in the plugging direction S.

The actuating portion 84 advantageously enables simple actuation of the securing element 5, i.e. in particular simple application of a force to the securing element 5 in the plugging direction S, as well as simple gripping of the securing element 5 to move it opposite to the plugging direction S.

The securing element 5 may have a groove 83, in particular at a respective prong 86 at which at least one of the latch protrusion 45 and the counterhold 88 is also arranged.

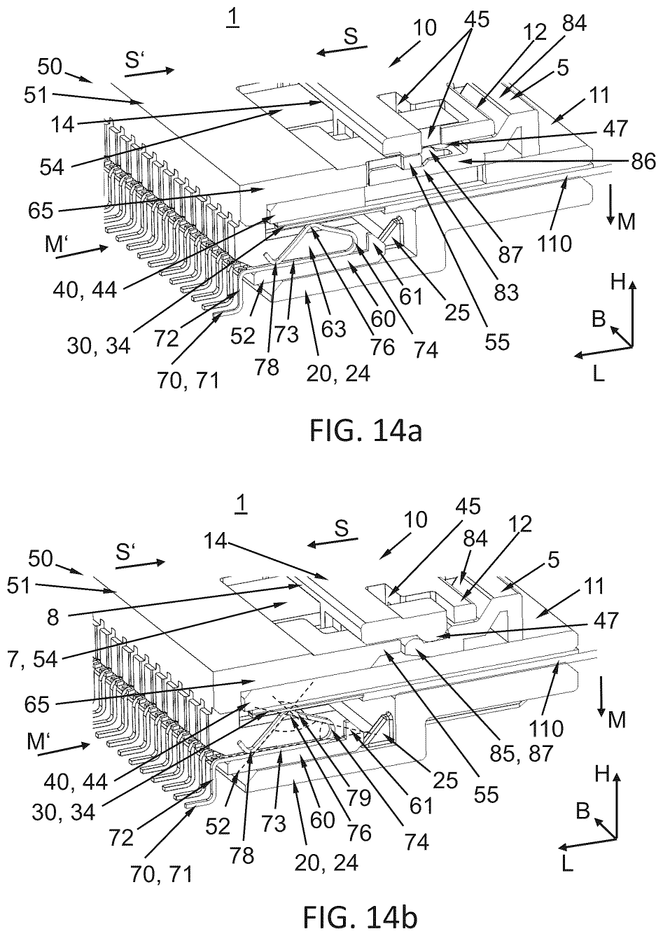

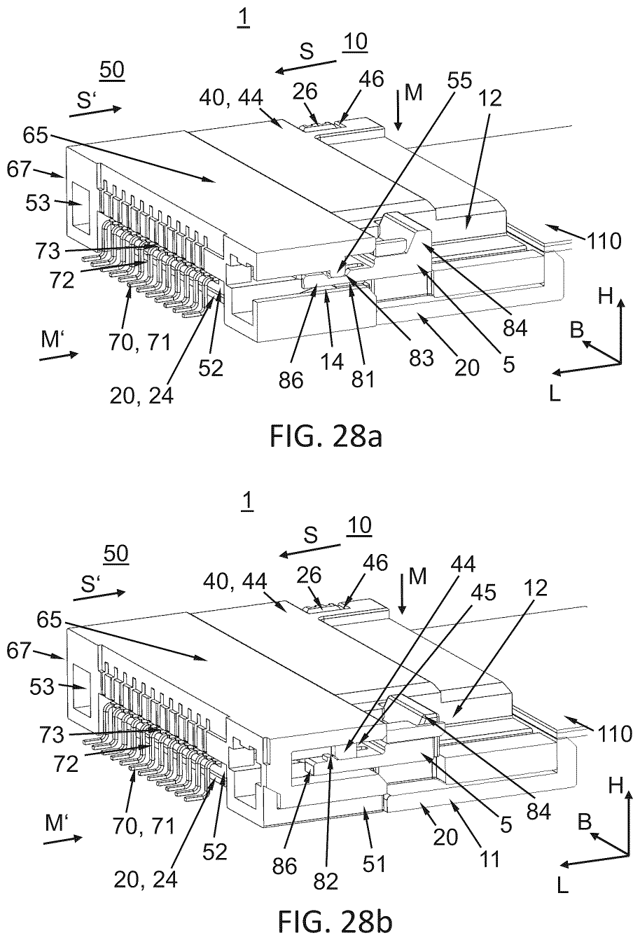

The groove 83 may in particular be configured to engage with one or more release elements 55 of the complementary flat plug connector 50 in a securing position of the securing element 5, as shown by way of example in particular in FIGS. 14a and 28a.

As a result, a deformation of the prongs 86, in particular one that is elastically restorable, can advantageously be reduced.

In exemplary embodiments, the groove 83 may have a section-wise contour along the longitudinal direction L or along the plugging direction S. The one or more grooves 83 may in particular cooperate with the one or more release elements 55 in such a way, in particular by a section-wise contour, as described analogously for the protrusion 87 and the complementary securing protrusion 47, 57.

The securing element 5 has in particular one or more securing surfaces 81, wherein the securing surfaces 81 are each configured, in the securing position, to bear against a restorably rear-engaging element 7 such that a restorable deformation of the restorably rear-engaging element 7 is impeded or blocked.

By means of the securing surfaces 81, the securing element 5 ensures in particular a non-detachable securing of a coupling between coupling portion 14 and complementary coupling portion 54, in particular a securing not detachable in a non-destructive manner.

As a result, the flat plug connector system 1 can advantageously be secured against detachment, while at the same time advantageously facilitating assembly of the flat plug connector system 1.

As illustrated in particular by FIG. 15a, the securing surface 81 may in particular have a main extension substantially in the plugging direction S or substantially in the longitudinal direction L, for example with an inclination with respect to the plugging direction S or the longitudinal direction L. The inclination may, for example, be in the range from about 5° to about 30°, in particular in the range from about 5° to about 20°. The inclination is in particular the angle which the securing surface 81 encloses with an imaginary line which substantially extends in the longitudinal direction L or in the plugging direction S, as viewed along the width direction B or in a sectional plane perpendicular to the width direction.

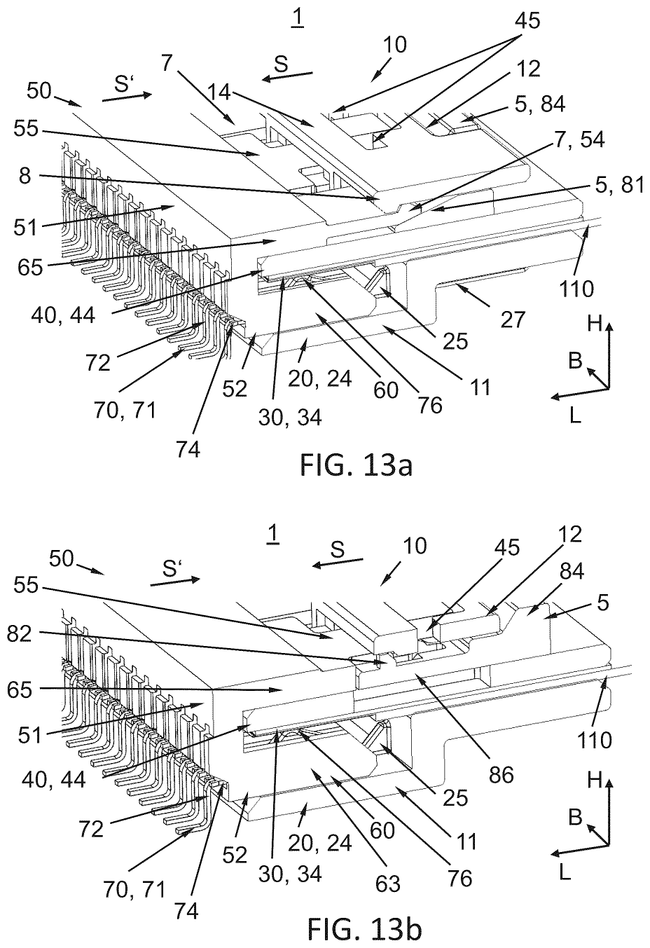

The inclination of the securing surface 81 advantageously enables, as illustrated by way of example by FIG. 13a, that a load distribution parallel to the height direction H and to the longitudinal direction L is ensured when the coupling portion 14 and the complementary coupling portion 54 attempt to detach from each other when the securing element 5 is in the securing position. As a result, a load can be advantageously distributed in a predetermined manner during detaching attempts in the secured state and in particular an improved service life of the flat plug connector system 1 can be ensured.

As illustrated in particular by FIG. 30b, the securing surface 81 may in particular have a main extension substantially in the plugging direction S or substantially in the longitudinal direction L, and may in particular be arranged or formed as a protrusion extending substantially in parallel to the height direction H on a lower side, in the height direction H, of the securing element 5.

The securing surface 81 thus advantageously enables a transfer guided in a rail-like manner, in particular translational transfer, between the non-securing and the securing position of the securing element 5. Integrally, the securing surface 81 allows to provide securing against a restorable deformation of the restorably rear-engaging element 7.

In FIGS. 15b and 15c and FIG. 30c, an exemplary contact 70 is shown, respectively.

The contact 70 shown as an example in FIGS. 15b and 15c is configured in particular for the first embodiment of the plug connector system 1.

The contact 70 shown in FIG. 15b represents in particular a contact 70 in an undeflected posture or in an undeflected state. The contact 70 shown in FIG. 15b may therefore correspond in particular to the contact 70 as shown in FIG. 8b. Moreover, the contact 70 as shown in FIG. 15b may in particular also correspond to the respective contact 70 as shown in the other figures relating to the first embodiment of the flat plug connector system 1, in particular the figures which show a non-coupled state of the flat plug connector system 1.

The contact 70 shown in FIG. 15c represents in particular a contact 70 in a deflected posture or in a deflected state. The contact 70 shown in FIG. 15c may therefore correspond in particular to the contact 70 as shown in FIG. 14b. Moreover, the contact 70 as shown in FIG. 15c may in particular also correspond to the respective contact 70 as shown in the other figures relating to the first embodiment of the flat plug connector system 1, in particular the figures which show a coupled state of the flat plug connector system 1.

The contact 70 shown in FIG. 15c represents in particular a deflected state 70 of the contact 70 shown in FIG. 15b.

The contact 70 shown as an example in FIG. 30c is configured in particular for the second embodiment of the plug connector system 1. The contact 70 shown in FIG. 30c is shown in particular in the undeflected posture or in the undeflected state. The contact 70 shown in FIG. 30c may therefore correspond in particular to the contact 70 as shown in FIG. 23b. Moreover, the contact 70 as shown in FIG. 30c may in particular also correspond to the respective contact 70 as shown in the other figures relating to the second embodiment of the flat plug connector system 1, in particular the figures which show a non-coupled state of the flat plug connector system 1.

Even when the contact 70 in the figures relating to the second embodiment of the flat plug connector system 1 is not deflected or compressed in the height direction H in the coupled state of the flat plug connector system 1, it is to be understood that the contact 70 may in particular have a restoring deflection, in particular substantially analogous to the contact 70 of the first embodiment of the flat plug connector system 1.

As illustrated by way of example in particular by FIGS. 3b, 8b, 14b, 15b, 15c, 18b, 23b, 29 and 30c, as well as the other figures in which the contact 70 is shown at least in sections, the contact 70 has in particular a terminal portion 71.

In the assembled state of the complementary flat plug connector 50, the terminal portion 71 may in particular extend away from the plug connector housing 51 of the complementary flat plug connector 50, for example substantially in the longitudinal direction L and/or in the height direction H. The terminal portion 71 may in particular be a solderable portion. The terminal portion 71 is in particular configured to form an electrically conductive terminal to a printed circuit board (not shown) and/or to an electrical component (not shown).

The terminal portion 71 may, for example, have an extension in the range from about 0.5 mm to about 1.5 mm. The terminal portion 71 may in particular form a first end of the contact 70.

The contact 70 may further in particular have a retaining portion 73 which is configured, for example, for form-fit, friction-fit and/or material-fit retention to a contact receptacle 56 of the plug connector housing 51. The retaining portion 73 may, for example, have one or more protrusions which, for example, protrude substantially in the width direction B and/or in the height direction H from the contact 70.

The retaining portion 73 may, for example, be pushed, or in other words pressed, into the contact receptacle 56. In other words, in exemplary embodiments, the retaining portion 73 and the contact receptacle 56 may form a press-fit or an interference fit.

Alternatively or additionally, the contact receptacle 56 may have one or more recesses complementary to the protrusions of the retaining portion 73.

The retaining portion 73 may in particular have an increased width in the width direction B and/or an increased thickness in the height direction H with respect to the remaining contact 70. The retaining portion 73 may, for example, have a width in the width direction B in the range from about 0.35 mm to about 0.7 mm at least in sections, and in particular may have a width in the width direction B in the range from about 0.5 mm to about 0.6 mm at least in sections. In contrast, in exemplary embodiments, the contact 70 may, for example, have a width in the width direction B in the range from about 0.2 mm to about 0.3 mm. The contact 70 may in particular have a thickness in the range from about 0.1 mm to about 0.2 mm.

A contact receptacle 56 of the multiple contact receptacles 56 of the plug connector housing 51 may, for example, substantially have a width in the width direction B in the range from about 0.25 mm to about 0.4 mm, in particular in the range from about 0.3 mm to about 0.35 mm.

The retaining portion 73 may in particular have a main extension which is substantially parallel to the plugging direction S′ of the complementary flat plug connector 50.

The retaining portion 73 advantageously enables a firm retention to the plug connector housing 51 of the complementary flat plug connector 50, and in particular to a contact receptacle 56 of the plug connector housing 51.

At a front end of the contact 70 in the plugging direction S′ of the complementary flat plug connector 50 or at an end of the contact 70 opposite the longitudinal direction L, the contact 70 has in particular a bent portion 74.

The bent portion 74 extends in particular between the retaining portion 73 and a bent contact region 76 of the contact 70, wherein the bent contact region 76 is in particular configured to electrically conductively contact a conductor element 34 of the conductor portion 30, in particular in the coupled state of the flat plug connector system 1.

The angles of the respective portions of the contact 70 described herein and in particular below are illustrated by way of example by the dashed lines in FIGS. 8b, 14b, 15b, 15c, 23b, 29 and 30c, which in bent form represent the respective angle of the respective portion of the contact 70, and in rectilinear form represent in each case the edges of the contact 70 adjacent to the respective angle.

The bent portion 74 encloses in particular an acute angle, i.e. an angle of less than 90°. The bent portion 74 may in particular form a foremost portion, in the plugging direction S′, of the contact 70. As a result, the contact 70 can be advantageously configured to be elastically restorable, wherein in particular the bent portion 74 deforms towards a smaller angle, i.e. an even more acute angle, than in an uncoupled state of the flat plug connector system 1 upon electrically conductive contacting with a conductor element 34. The bent portion 74 may, in particular on a side facing away from the plugging direction S′, in particular form a smaller angle in a deflected posture than in an undeflected posture.

In an undeflected posture, i.e. in an uncoupled state of the flat plug connector system 1, the bent portion 74 may, for example, enclose an angle in the range from about 10° to about 30°, in particular enclose an angle in the range from about 13° to about 27°.

In a deflected posture, i.e. in a coupled state of the flat plug connector system 1, the bent portion 74 may, for example, enclose an angle in the range from about 5° to about 25°, in particular enclose an angle in the range from about 8° to about 22°.

The bent contact region 76 may in particular form an uppermost portion, in the height direction H, of the contact 70. The bent contact region 76 may in particular be a portion of the contact 70 that is exposed in the height direction H. The bent contact region 76 may in particular be exposed upwards in the height direction H relative to a first portion 75 adjacent at the front in the plugging direction S′, and/or relative to a second portion 77 adjacent to the bent contact region 76 at the rear in the plugging direction S′.

The bent contact region 76 can advantageously reliably ensure electrically conductive contacting with a conductor element 34, wherein the contact is made in particular in a soft, restoring manner. As a result, in turn, the service life of the conductor elements 34 and the contacts 70 can advantageously be improved.

The bent contact region 76 may have an obtuse angle, i.e. an angle of more than 90°, in particular on a side which faces the retaining portion 73 of the contact 70. In a deflected posture, the bent contact region 76 may, in particular on a side facing the retaining portion 73, in particular enclose a larger angle than in an undeflected posture.

In an undeflected posture, i.e. in an uncoupled state of the flat plug connector system 1, the bent contact region 76 may, for example, enclose an angle in the range from about 95° to about 135°, in particular enclose an angle in the range from about 100° to about 130°.

In a deflected posture, i.e. in a coupled state of the flat plug connector system 1, the bent contact region 76 may, for example, enclose an angle in the range from about 110° to about 145°, in particular enclose an angle in the range from about 115° to about 140°.

The bent contact region 76 advantageously enables safe and at the same time electrically conductive contacting that is gentle on both the contact 70 and the conductor element 34, whereby the respective service life and that of the flat plug connector system 1 is advantageously improved.

On a side of the bent contact region 76 which faces away from the bent portion 74 the contact 70 has in particular a support portion 78.

The support portion 78 may be arranged or formed at a substantially second end of the contact 70. The support portion 78 may in particular be bent, in particular such that the support portion 78 is substantially concave in shape on a side facing the retaining portion 73 in the height direction H.

In an undeflected posture, i.e. in an uncoupled state of the flat plug connector system 1, the support portion 78 may, for example, have a spacing, in particular substantially in the height direction H, with respect to the retaining portion 73, which is, for example, in the range from about 0.05 mm to about 0.15 mm, in particular in the range from about 0.08 mm to about 0.12 mm, in particular a spacing of about 0.1 mm.

The support portion 78 may have a greater spacing from the bent portion 74 than the bent contact region 76 has from the bent portion 74, in particular in the longitudinal direction L and/or in the plugging direction S of the flat plug connector system 1.

In a deflected posture, i.e. in a coupled state of the flat plug connector system 1, the support portion 78 may in particular be configured to contact the retaining portion 73, or in other words to be supported at the retaining portion 73.

The support portion 78 advantageously allows to ensure a predetermined contact force between the bent contact region 76 and the conductor element 34.

In conventional flat plug connectors, the contacts are in particular made of gold or gold-plated in particular, whereby sufficient electrically conductive contacting is ensured even with low contact forces.

In contrast, the present contact 70 advantageously enables a predetermined contact force to be ensured between the bent contact region 76 and the conductor element 34 by virtue of the elastically restorable deformation of the contact 70, wherein the support portion 78 adjacent to the bent contact region 76 is supported against the retaining portion 73.

This further makes it possible, for example, for the contact 70 to be tinned, i.e. in particular to be non-gold-plated or be configured without gold, without impairing the electrically conductive contacting. As a result, the contact 70 can, in turn, be advantageously manufactured inexpensively and can also be advantageously configured to be easily connectable to a printed circuit board and/or an electrical device, for example by means of soldering.

As shown by way of example in FIGS. 15b, 15c and 30c, a substantially rectilinearly extending or linearly extending second portion 77 may be formed between the bent contact region 76 and the support portion 78.

As a result, support of the bent contact region 76 by the support portion 78 can advantageously be stiffened, whereby a predetermined contact force can advantageously be ensured.

Alternatively or additionally, a substantially rectilinearly extending first portion 75 may be formed between the bent contact region 76 and the bent portion 74. The first portion 75 may in particular have a kink 79, wherein the tip of the kink 79 points in the height direction H towards the retaining portion 73. In other words, the first portion 75 may in particular have a kink 79 formed on a lower side, in the height direction H, of the first portion 75. The kink 79 may in particular enclose an obtuse angle, i.e. an angle of more than 90°, on an upper side in the height direction H. The kink 79 may in particular enclose an angle of more than about 100°, for example a value of about 105°, or in particular a value of more than about 105°, for example a value of about 108°, on an upper side in the height direction H.

The kink 79 may preferably be adjacent to the bent contact region 76.

The kink 79 advantageously allows to stiffen the bent contact region 76 and the bend thereof. As a result, a deflection of the contact 70 can advantageously be concentrated at the bent portion 74.

As a result, support of the bent contact region 76 by the support portion 78 can advantageously be stiffened, whereby a predetermined contact force can advantageously be ensured.

In particular, the bent contact region 76, the first portion 75 and the second portion 77 may form a contact portion of the contact 70 or be encompassed by it. The contact portion is in particular restorably deflectable. In the coupled state, the contact portion, and in particular the bent contact region 76 thereof, is in electrically conductive contact with the conductor portion 30, in particular with a conductor element 34 of the conductor portion 30, and optionally additionally, in particular physically, in direct contact.

In exemplary embodiments, the contact 70 may have a thickness build-up portion 72, in particular between the terminal portion 71 and the retaining portion 73. The thickness build-up portion 72 may in particular have a main extension which is substantially parallel to the height direction H.

The thickness build-up portion 72 in particular allows to form the terminal portion 71 at a level which substantially corresponds to a lowest level, in the height direction H, of the flat plug connector system 1. As a result, the terminal portion 71 of the contact 70 can be advantageously relieved when being attached to a printed circuit board and/or to an electrical device. As a result, in turn, the service life of the contacts 70, and accordingly the service life of the flat plug connector system 1, can advantageously be improved.

A contact 70 may in particular be formed in one piece, for example as a bending part. As a result, the contact 70 is advantageously manufacturable inexpensively.

The contact 70 may comprise or consist of, for example, copper, a copper alloy, in particular bronze, nickel, nickel coated with gold, phosphorus nickel coated with gold flash, nickel coated with silver, nickel coated with tin, steel or another conductive material, without being limited thereto. Additionally or alternatively, the contact 70 may in particular be tinned. Further additionally or alternatively, the contact 70 may in particular be non-gold-plated or have no gold.

The plug connector housing 51 of the complementary flat plug connector 50 may, for example, comprise or consist of a polymer, in particular comprise or consist of a reflow solderable polymer. For example, the plug connector housing 51 may comprise or consist of polyether ether ketone (PEEK) and/or polyamide (PA). As a result, the plug connector housing 51 is advantageously manufacturable true to shape and, furthermore, the complementary flat plug connector 50 equipped with the assembled contacts 70 is connectable to a printed circuit board and/or an electrical device, in particular in a simple and reliable manner.

Starting from the non-coupled state, as illustrated for example by FIGS. 9a, 9b, 10a, 24a, 24b and 25a, the one or more latch protrusions 82 are engaged with or strike against the one or more latches 45. Furthermore, in particular the one or more counterholds 88 may be engaged with the counterhold abutments 48, or may be limited in a movement opposite to the plugging direction S.

During the coupling operation, in which the coupling portion 14 and the complementary coupling portion 54 come into mutual engagement, as illustrated by FIGS. 11a, 11b, 12a, 12b, 26a, 26b and 27a, the securing element 5 is deformed at least in sections, in particular such that the one or more latch protrusions 82 are no longer engaged with or strike against the one or more latches 45.

In particular, the one or more release elements 55 of the complementary flat plug connector 50 deflect at least one of the receptacle 12 and the securing element 5 accordingly, in particular in an elastically restorable manner.

Furthermore, as illustrated by FIGS. 12b and 26a, in particular a first contour portion of the protrusion 87 of the securing element 5 comes into contact with a first contour portion of the securing protrusion 47, 57, or to an adjacent position.

When securing, i.e. when transferring the securing element 5 into the securing position, wherein FIGS. 14a, 14b, 27b, 28a, 28b and 29 in particular represent the secured state, i.e. the securing position of the securing element 5, the elastic restoring of the securing element 5 is at least partially or completely reduced.

In particular, the securing element 5 is elastically restorably deformed in the region of the protrusion 87 when the first contour portions of the protrusion 87 and the securing protrusion 47, 57 slide off one another while applying the securing force. After overcoming a maximum deflection of the securing element 5 in the region of the protrusion 87 and/or the respective plug connector housing 11, 51 in the region of the securing protrusion 47, 57, further passing to the securing position may take place substantially passively, in particular by restoring the elastic deformations of the securing element 5.

In the secured state of the flat plug connector system 1, in particular the second contour portion of the securing protrusion 47, 57 and the second contour portion of the protrusion 87 of the securing element 5 face each other or are adjacent to one another. Additionally or alternatively, the one or more release elements 55 may be received, in particular at least in sections, in the grooves 83 of the securing element 5 such that the securing element 5 has in particular no or only a slight elastic deformation in the secured state.

As shown by way of example in FIGS. 13b and 28b, in the secured state, the one or more latch protrusions 82 may be arranged on a side of the receptacle 12 or the upper wall 44 facing away from the one or more latches 45. The surfaces of the latch protrusions 82 and the receptacle 12 or the upper wall 44 facing each other in the secured state may, for example, together with the securing protrusion 47, 57 and the protrusion 87 of the securing element 5, define an unsecuring force to transfer the securing element 5 from the securing position into the non-securing position.

As a result, a securing force can be further advantageously separated, in particular from a detaching force or unsecuring force, or in other words made independent.

The flowchart in FIG. 31 represents an exemplary method for securing a form-fit coupling between a flat plug connector 10 and a complementary flat plug connector 50. The method relates in particular to a flat plug connector 10 and/or a complementary flat plug connector 50, and in particular to a flat plug connector system 1, as shown in the other figures and described herein.

The flowchart in FIG. 31 describes in particular a method for securing a form-fit coupling between a flat plug connector 10 and a complementary flat plug connector 50, wherein the flat plug connector 10 has a coupling portion 14 and the complementary flat plug connector 50 has a complementary coupling portion 54 which is couplable to the coupling portion 14 in a form-fit manner.

The method comprises, but is not limited to, in particular the following steps, in particular in this order:
S10 arranging a securing element 5 at a receptacle 12 of one of the coupling portion 5 and the complementary coupling portion 54; and
S20 transferring the securing element 5 from a non-securing position towards a securing position at the receptacle 12, wherein the securing element 5 is configured to provide, in the securing position, a secured state of the coupling between the coupling portion 14 and the complementary coupling portion 54, in which detachment of the form-fit coupling between the coupling portion 14 and the complementary coupling portion 54 is prevented, wherein the coupling portion 14, the complementary coupling portion 54 and the securing element 5 are configured to be complementary to each other such that in a decoupled state in which the coupling portion 14 and the complementary coupling portion 54 are not coupled to each other, the securing element 5 is retained in the non-securing position.

The step S20 of transferring the securing element 5 into the securing position may in particular comprise applying a predetermined securing force, for example to transfer the securing element 5 into the securing position.

In exemplary embodiments, the receptacle 12 may comprise one or more latches 45 and/or the securing element 5 may comprise one or more latch protrusions 82 complementary to the one or more latches 45. The one or more latches 45 may in particular cooperate with the one or more latch protrusions 82 such that:
when a step of coupling the coupling portion 14 to the complementary coupling portion 54 in a form-fit manner is performed prior to transferring the securing element 5 into the securing position, the securing element 5 is transferable into the securing position, and
when a step of coupling the coupling portion 14 to the complementary coupling portion 54 in a form-fit manner is not performed prior to transferring the securing element 5 into the securing position, the one or more latch protrusions 82 are (being) engaged with the one or more latches 45 such that the securing element 5 is (being) retained in the non-securing position.

In exemplary embodiments, the step S20 of transferring the securing element 5 into the securing position may comprise moving the securing element 5 substantially in the plugging direction S.

In further exemplary embodiments, one of the coupling portion 14 and the complementary coupling portion 54 may comprise a securing protrusion 47, 57, and the securing element 5 comprises a protrusion 87 complementary to the securing protrusion 47, 57, wherein the securing protrusion 47, 57 and the complementary protrusion 87 of the securing element 5 in the secured state define a predetermined detaching force to be applied to transfer the securing element 5 from the securing position into a non-securing position.

The flowchart in FIG. 32 represents an exemplary method for manufacturing a flat plug connector 10. The method relates in particular to a flat plug connector 10, and in particular to a flat plug connector system 1, as shown in the other figures and described herein.

The flowchart in FIG. 32 describes in particular a method for manufacturing a flat plug connector 10.

The method comprises, but is not limited to, in particular the following steps, in particular in this order:
S110 providing a first upper plug connector housing part 40;
S120 providing a second lower plug connector housing part 20;
S130 arranging a conductor portion 30 with a flexible flat conductor 110 on or in the second lower plug connector housing part 20;
S140 arranging the first upper plug connector housing part 40 on the conductor portion 30 which is arranged on or in the second lower plug connector housing part 20; and
S150 fixing the first upper plug connector housing part 40 and the second upper plug connector housing part 20 to each other.

The method for manufacturing a flat plug connector 10 may further comprise in particular a step of providing a conductor portion 30 with a flexible flat conductor 110. This step is executable in particular prior to steps S130, S130′.

Steps S130, S140 and S150 are in particular executable in this exact order.

In further exemplary embodiments, the method may comprise the following steps, in particular in this order, in particular after steps S110 and S120:
S130′ arranging a conductor portion 30 with a flexible flat conductor 110 on or in one of the first upper plug connector housing part 40 and the second lower plug connector housing part 20;
S140′ arranging the other one of the first upper plug connector housing part 40 and the second lower plug connector housing part 20 on the conductor portion 30 which is arranged on or in the one of the first plug connector housing part 40 and the second lower plug connector housing part 20; and
S150 fixing the first upper plug connector housing part 40 and the second upper plug connector housing part 20 to each other.

It is to be understood that the elements designated above with the term complementary may also be designated without the term complementary, and in particular the element not designated with the term complementary represents the element complementary thereto.

### LIST OF REFERENCE NUMERALS

1 Flat plug connector system
5 Securing element
7 Restorably rear-engaging element
8 rear-engageable portion
10 Flat plug connector
11 Plug connector housing
12 Receptacle
14 Coupling portion
20 Lower plug connector housing part
22 Recess
23 Main body
24 Lower wall
25 First stiffening ribs
26 Fastening means
27 Second stiffening ribs
30 Conductor portion
32 Fixing portion
34 Conductor element
40 Upper plug connector housing part
42 Side wall
43 Guide element
44 Upper wall
45 Latch
46 Fastening receptacle
47 Securing protrusion
48 Counterhold abutment
49 Collar
50 Complementary flat plug connector
51 Plug connector housing
52 Lower wall
53 Guide receptacle
54 Complementary coupling portion
55 Release element
56 Contact receptacle
57 Securing protrusion
58 Fixing portion
59 Fixing means
60 Contact holder
61 Front wall
63 Support wall
65 Upper wall
67 Side wall
70 Contact
71 Terminal portion
72 Thickness build-up portion
73 Retaining portion
74 Bent portion
75 First portion
76 Bent contact region
77 Second portion
78 Support portion
79 Kink
81 Securing surface
82 Latch protrusion
83 Groove
84 Actuating portion
85 Securing prong
86 Prong
87 Protrusion
88 Counterhold
110 Flexible flat conductor
B Width direction
H Height direction
L Longitudinal direction
M, M′ Assembly direction
S, S′ Plugging direction
S10 to S20 Steps of a method for performing form-fit coupling
S110 to S150 Steps of a method for manufacturing a flat plug connector

1.-13. (canceled)

14. A flat plug connector system comprising
a flat plug connector having a coupling portion,
a complementary flat plug connector having a coupling portion complementary to the coupling portion of the flat plug connector, and
a securing element,
wherein one of the coupling portion and the complementary coupling portion has a receptacle at which the securing element is arranged at least in sections,
wherein the coupling portion and the complementary coupling portion are couplable in a form-fit manner,
wherein the securing element prevents detachment of the form-fit coupling between the coupling portion and the complementary coupling portion in a secured state of the flat plug connector system,
wherein the securing element allows detachment of the form-fit coupling between the coupling portion and the complementary coupling portion in an unsecured state of the flat plug connector system,
wherein the securing element has a securing position in the secured state of the flat plug connector system, and has a non-securing position in the unsecured state, and
wherein the coupling portion, the complementary coupling portion and the securing element are configured to be complementary to each other such that in a decoupled state in which the coupling portion and the complementary coupling portion are not coupled to each other, the securing element is retained in the non-securing position.

15. The flat plug connector system according to claim 14, wherein the receptacle has a latch which interacts with a latch protrusion of the securing element such that in the decoupled state in which the coupling portion and the complementary coupling portion are not coupled to each other, the latch protrusion is engaged with the latch such that the securing element is retained in the non-securing position.

16. The flat plug connector system according to claim 14, wherein one of the coupling portion and the complementary coupling portion comprises a rear-engageable portion and the other one of the coupling portion and the complementary coupling portion comprises a restorably rear-engaging element which engages with the rear-engageable portion in the coupled state of the plug connector system,
wherein in the secured state of the flat plug connector system, the securing element hinders restoring of the restorably rear-engaging element such that the coupling portion and the complementary coupling portion are coupled to each other in a not non-destructively detachable manner.

17. The flat plug connector system according to claim 14, wherein the securing element has a securing surface which, in the secured state of the flat plug connector system, abuts against a side of the restorably rear-engaging element facing away from the rear-engageable portion.

18. The flat plug connector system according to claim 14, wherein the securing element is arrangeable at the receptacle in a form-fit manner such that the securing element is transferable between the securing position of the securing element and the non-securing position of the securing element without detaching the form-fit arrangement at the receptacle.

19. The flat plug connector system according to claim 14, wherein one of the coupling portion and the complementary coupling portion has a securing protrusion, wherein the securing element has a protrusion complementary to the securing protrusion, and
wherein the securing protrusion and the complementary protrusion of the securing element define a detaching force to transfer the securing element from the secured state of the flat plug connector system into the unsecured state of the flat plug connector system.

20. The flat plug connector system according to claim 14, wherein one of the coupling portion and the complementary coupling portion has a securing protrusion, and the securing element has a protrusion complementary to the securing protrusion, wherein the protrusion and the securing protrusion define a predetermined securing force for transferring the securing element from the non-securing position into the securing position.

21. A flat plug connector with a securing element, comprising
a coupling portion for form-fit coupling to a complementary coupling portion of a complementary flat plug connector, wherein the coupling portion has a receptacle at which the securing element is arranged at least in sections,
wherein the coupling portion and the securing element are configured to be complementary to each other such that in a decoupled state of the flat plug connector in which the coupling portion and the complementary coupling portion are not coupled to each other, the securing element is retained in the non-securing position.

22. A securing element for a flat plug connector system according to claim 14, comprising:
one or more protrusions for form-fit fastening of the securing element to a receptacle of the coupling portion or the complementary coupling portion of the flat plug connector system;
a securing portion which is configured to secure a form-fit coupling of the coupling portion and the complementary coupling portion; and
one or more latch protrusions which are configured to engage with a latch of the receptacle to block transfer of the securing element into a securing position at the receptacle.

23. A method for securing a form-fit coupling between a flat plug connector and a complementary flat plug connector, wherein the flat plug connector has a coupling portion and the complementary flat plug connector has a complementary coupling portion which is couplable to the coupling portion in a form-fit manner, wherein the method comprises the steps of:
arranging a securing element at a receptacle of one of the coupling portion and the complementary coupling portion; and
transferring the securing element from a non-securing position towards a securing position at the receptacle, wherein the securing element is configured, in the securing position, to provide a secured state of the coupling between the coupling portion and the complementary coupling portion, in which detachment of the form-fit coupling between the coupling portion and the complementary coupling portion is prevented,
wherein the coupling portion, the complementary coupling portion and the securing element are configured to be complementary to each other such that in a decoupled state in which the coupling portion and the complementary coupling portion are not coupled to each other, the securing element is retained in the non-securing position.

24. The method according to claim 23, wherein the step of arranging the securing element comprises arranging the securing element at the receptacle in a form-fit manner.

25. The method according to claim 23, wherein the step of transferring the securing element into the securing position comprises applying a predetermined securing force to transfer the securing element into the securing position.

26. The method according to claim 23, wherein the receptacle comprises a latch and the securing element comprises a latch protrusion,
wherein, when a step of coupling the coupling portion to the complementary coupling portion in a form-fit manner is performed prior to transferring the securing element into the securing position, the securing element is transferable into the securing position, and
when a step of coupling the coupling portion to the complementary coupling portion in a form-fit manner is not performed prior to transferring the securing element into the securing position, the latch protrusion is engaged with the latch such that the securing element is retained in the non-securing position.

27. The method according to claim 23, wherein the step of transferring the securing element into the securing position comprises moving the securing element substantially in a plugging direction.

28. The method according to claim 23, wherein one of the coupling portion and the complementary coupling portion comprises a securing protrusion and the securing element comprises a protrusion complementary to the securing protrusion, wherein the securing protrusion and the complementary protrusion of the securing element define a predetermined detaching force in the secured state, which is to be applied to transfer the securing element from the securing position into a non-securing position.
